(19) United States
(12) Patent Application Publication
(10) Pub. No.: US 2014/0288714 A1
(43) Pub. Date: Sep. 25, 2014

(54) INTELLIGENT ENERGY AND SPACE MANAGEMENT

(71) Applicant: Alain Poivet, Palo Alto, CA (US)

(72) Inventor: Alain Poivet, Palo Alto, CA (US)

(21) Appl. No.: 14/217,427

(22) Filed: Mar. 17, 2014

Related U.S. Application Data
(60) Provisional application No. 61/801,089, filed on Mar. 15, 2013.

(51) Int. Cl. G05B 15/02

(52) U.S. Cl. CPC G05B 15/02
USPC 700/275

(57) ABSTRACT

A computer system as a building is disclosed. The computer system as a building is able to respond to the animate and inanimate occupants of the building by interacting and communicating in real-time through movement, sound, lighting, visual effects, and environmental effects.

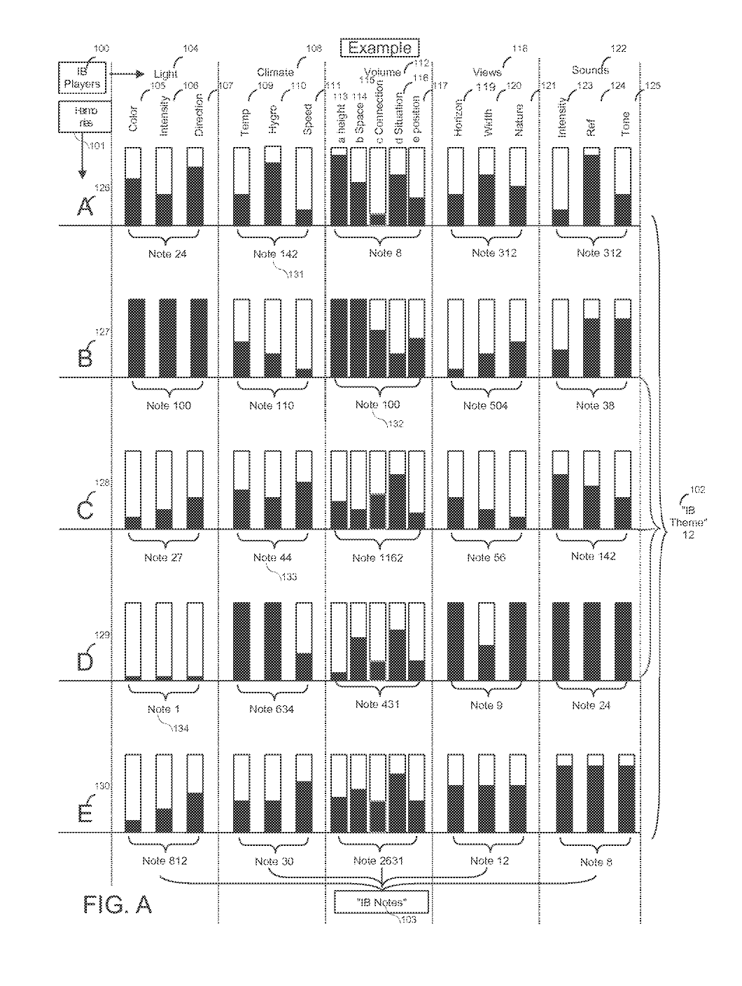

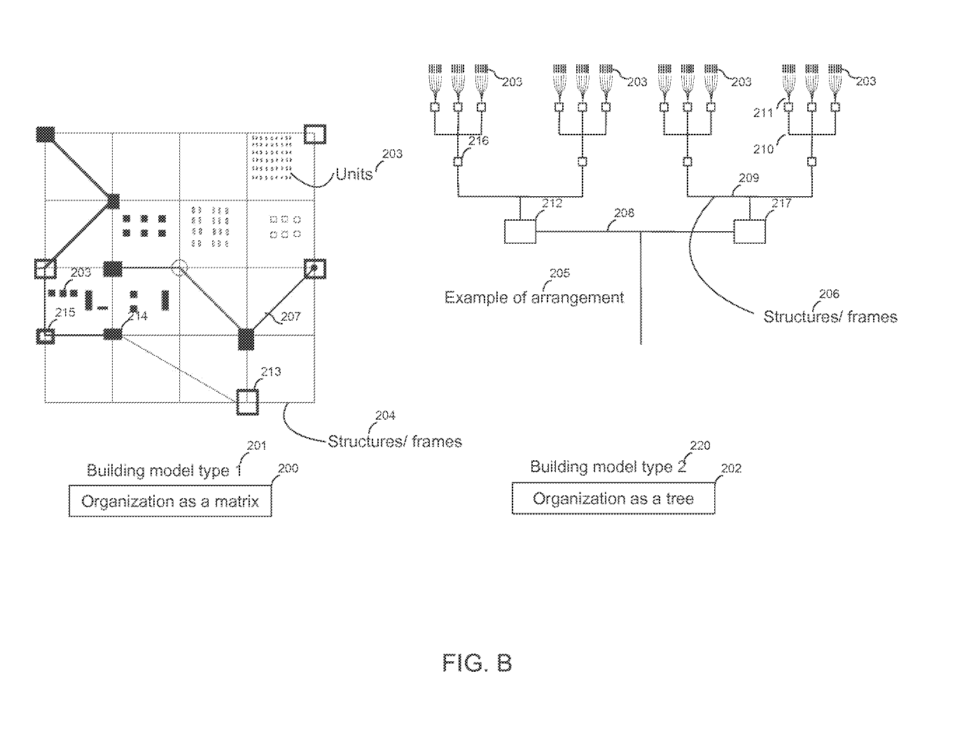

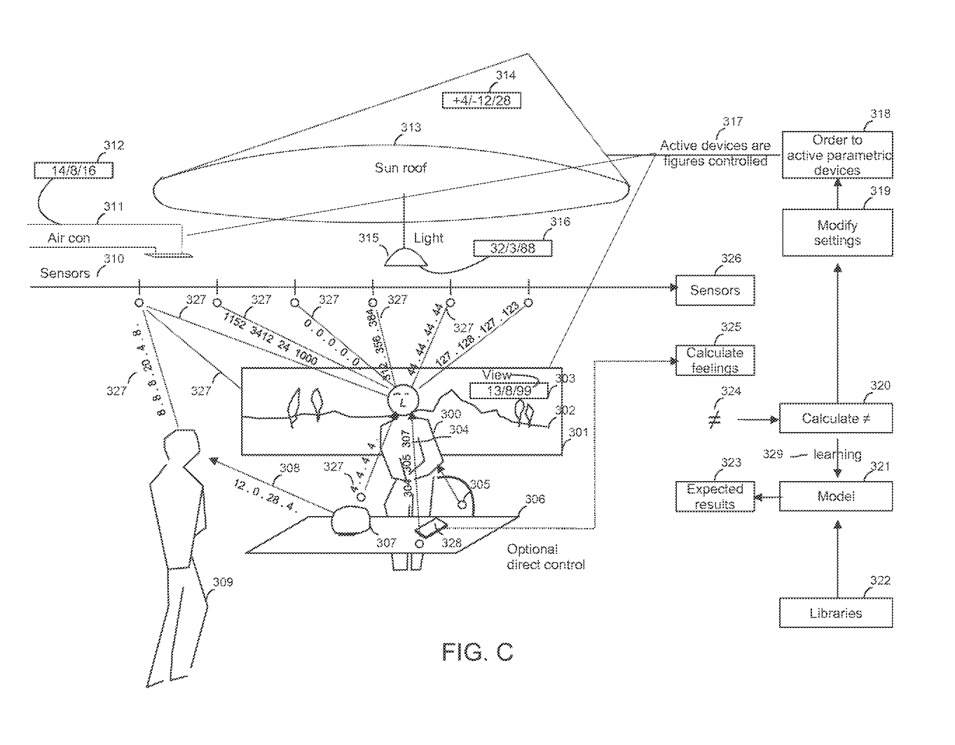

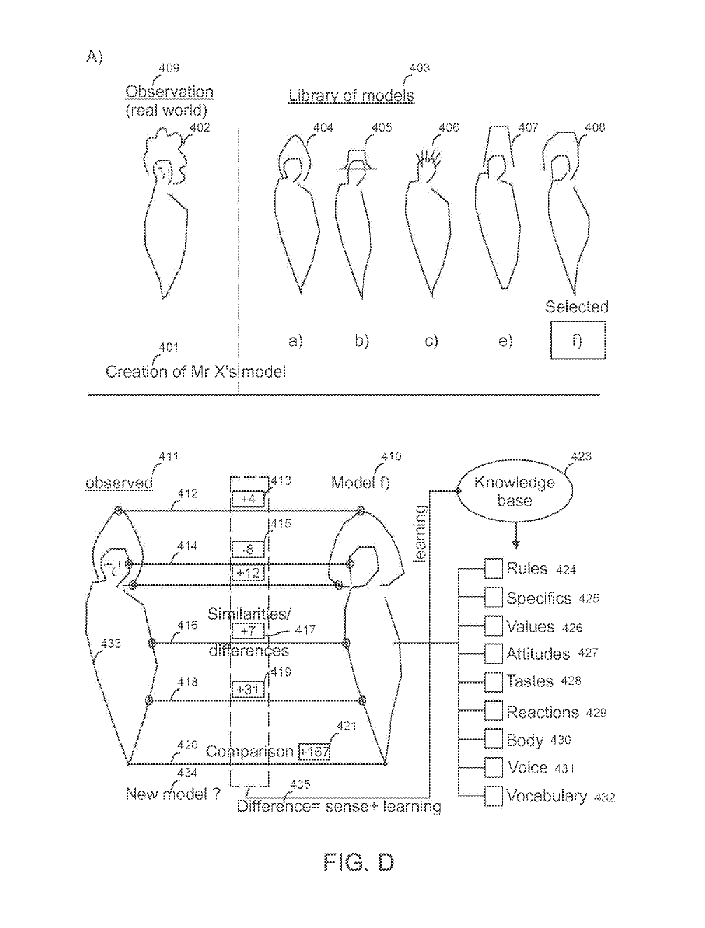

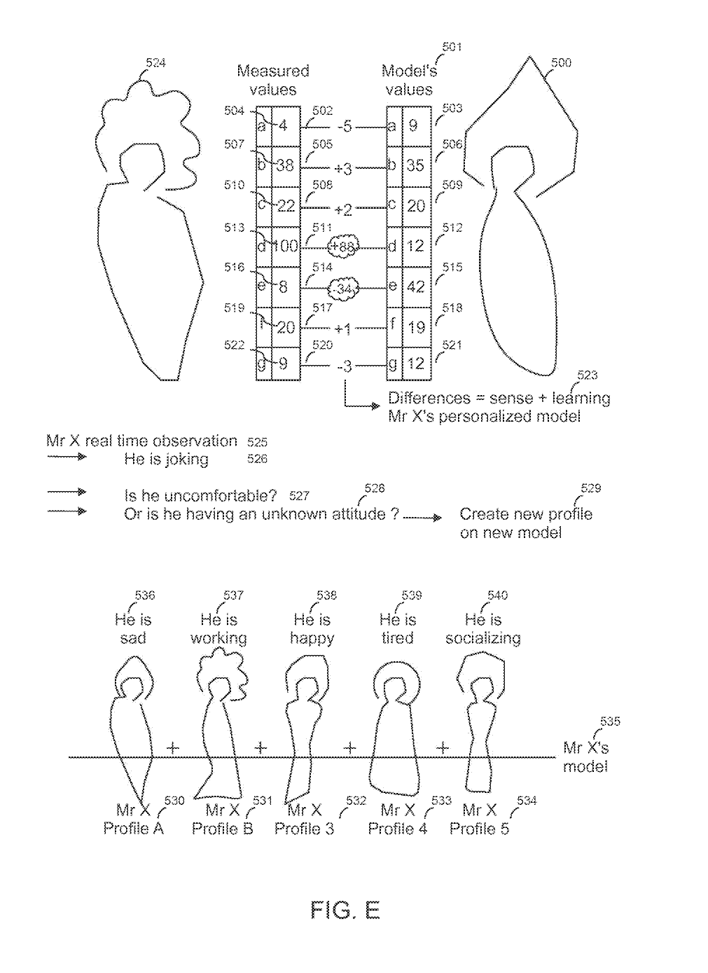

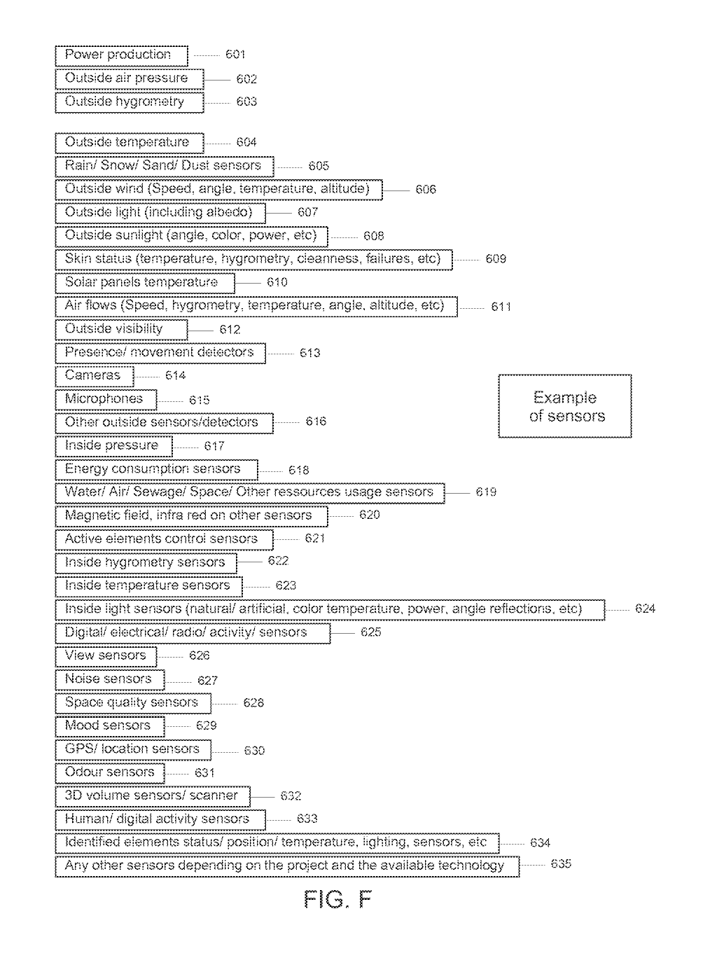

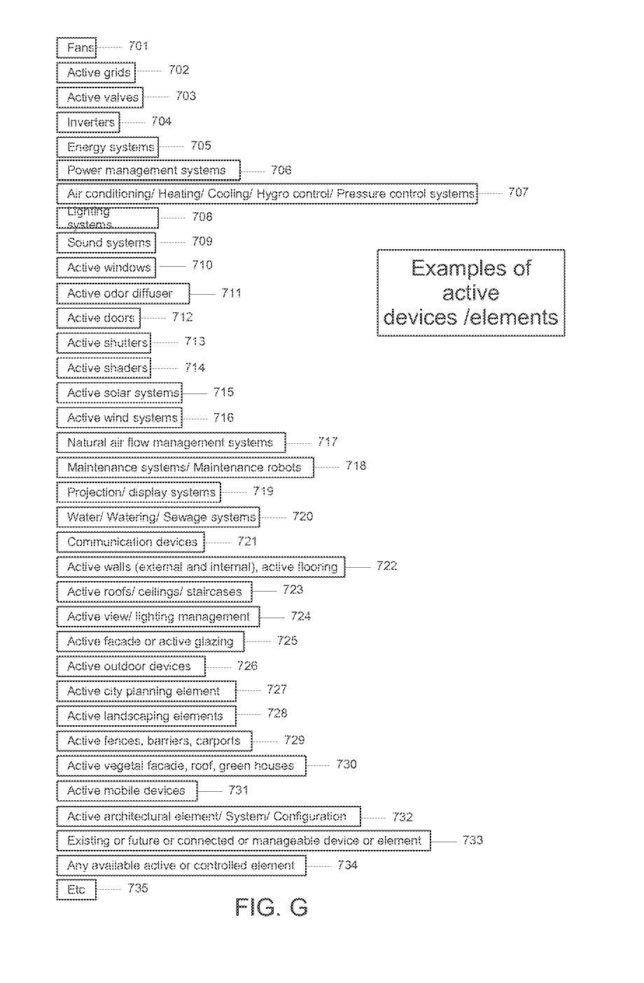

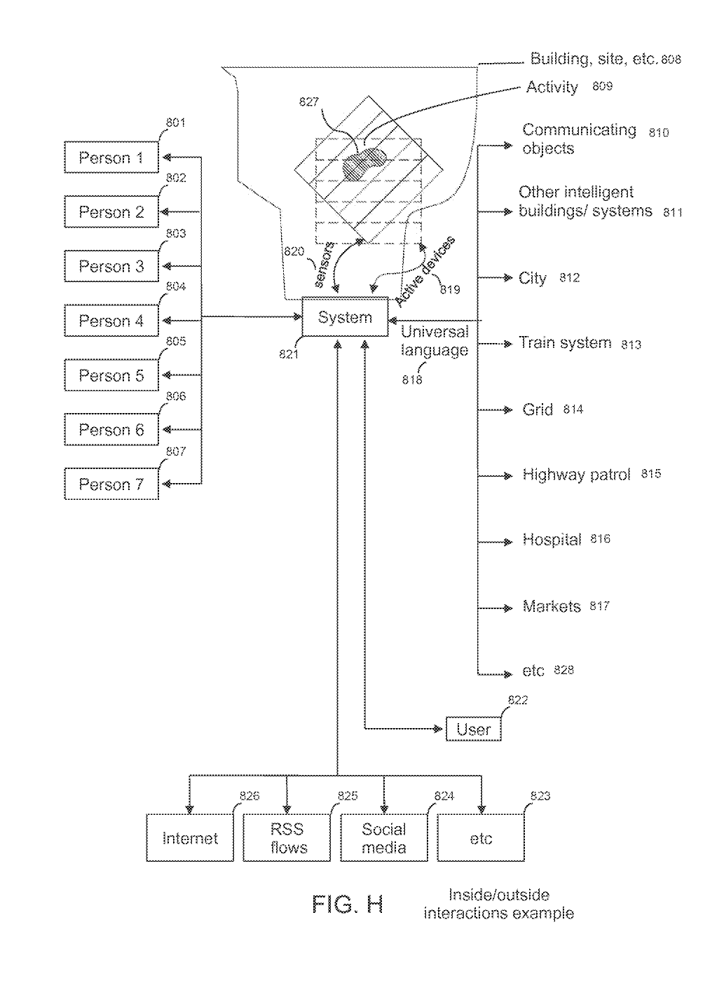

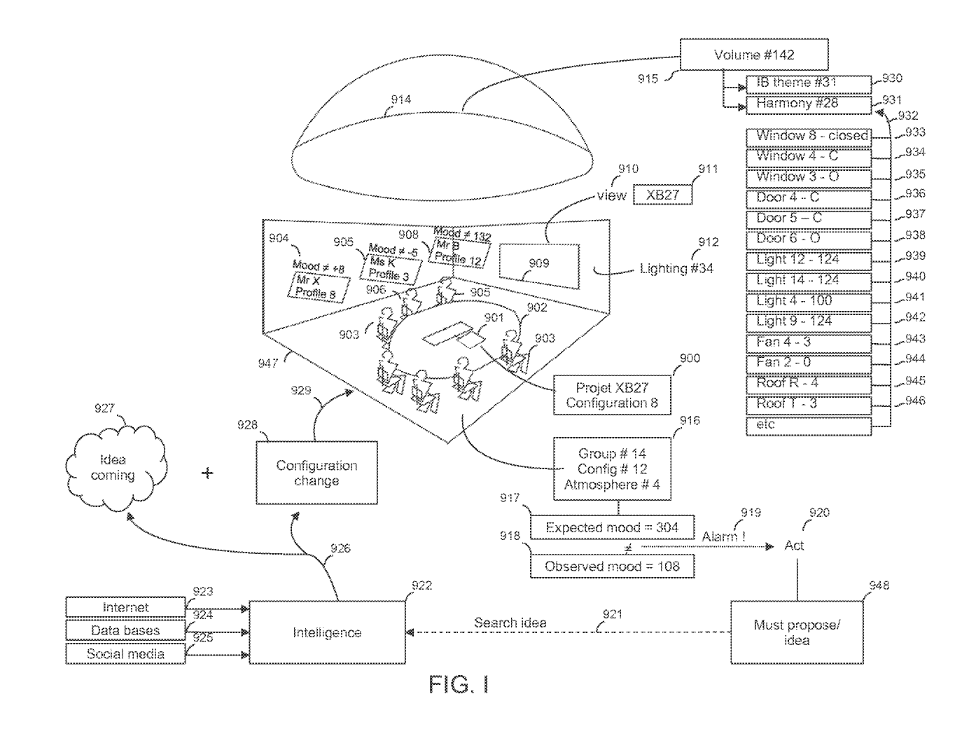

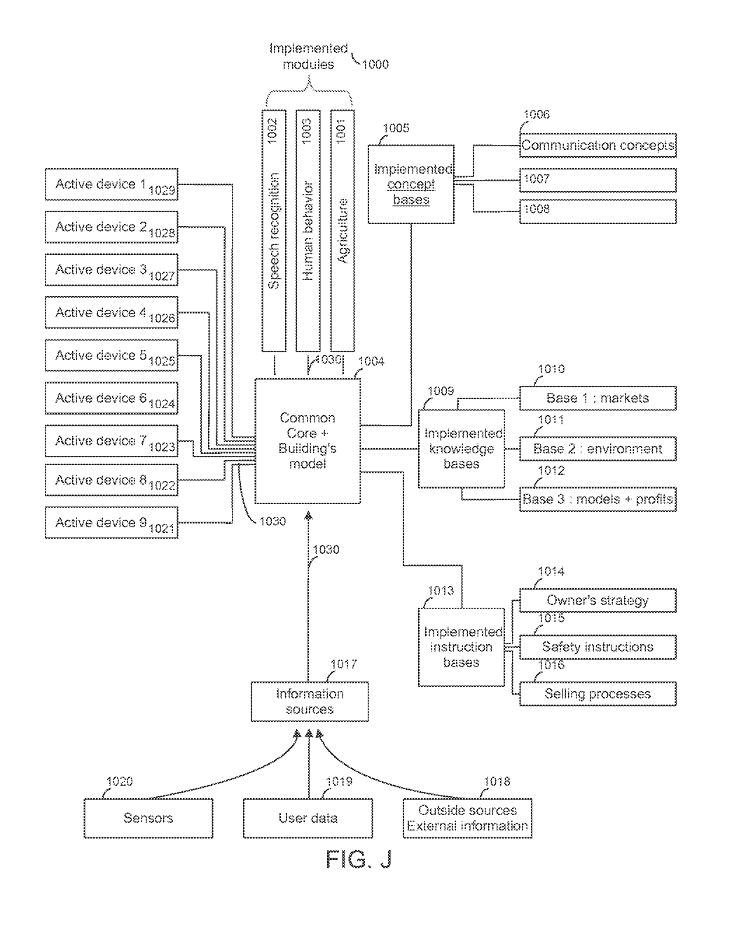

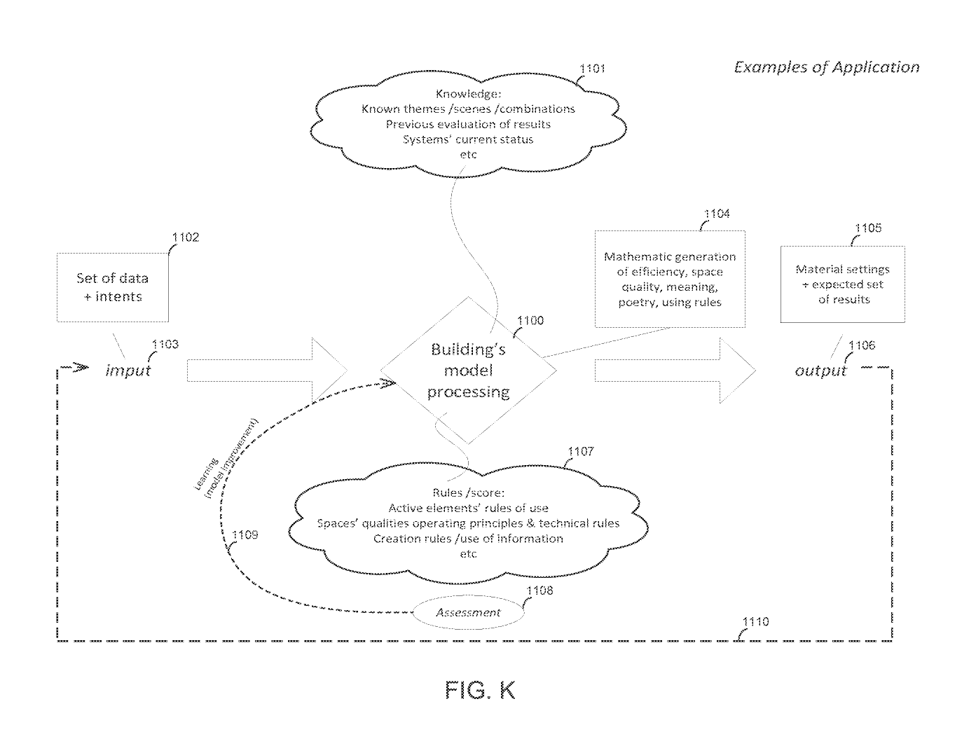

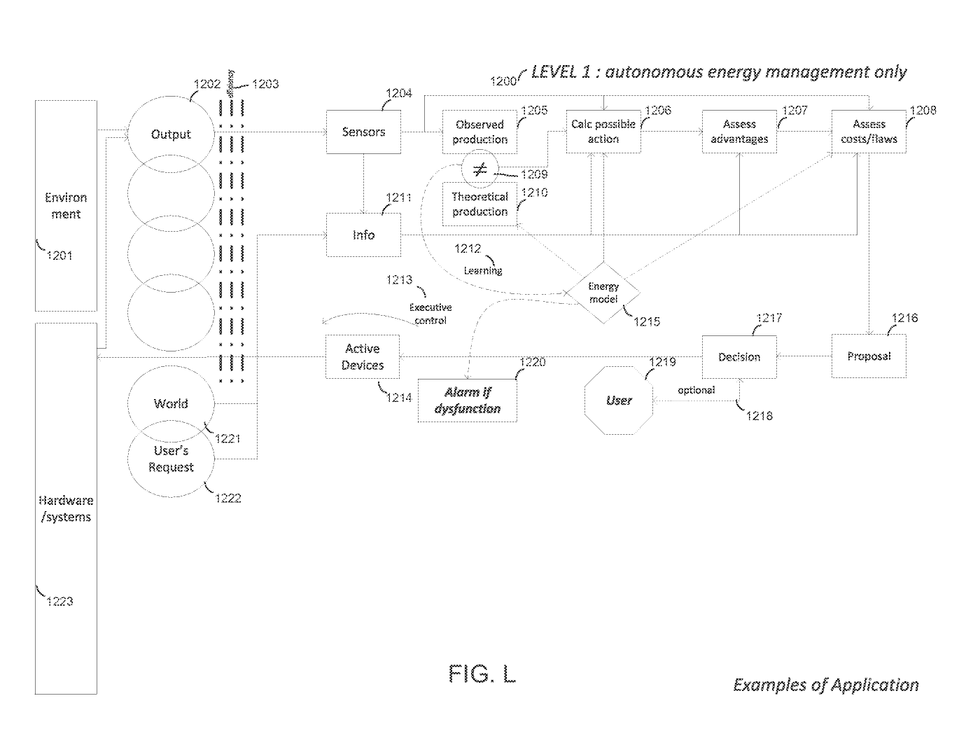

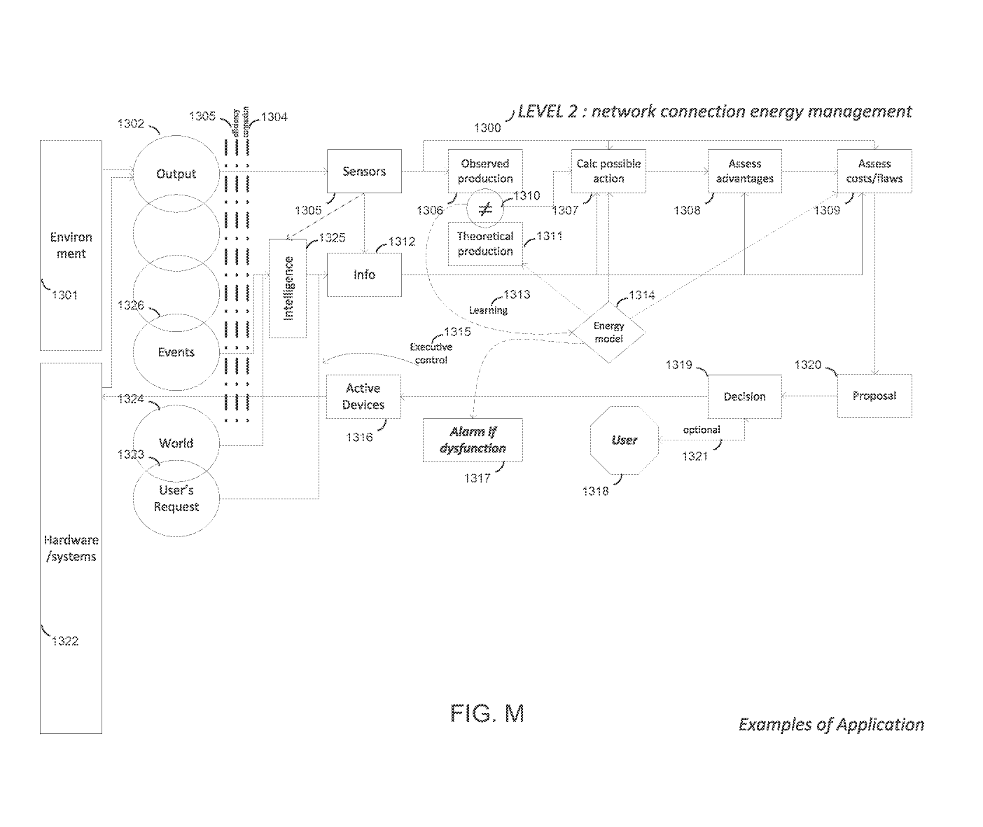

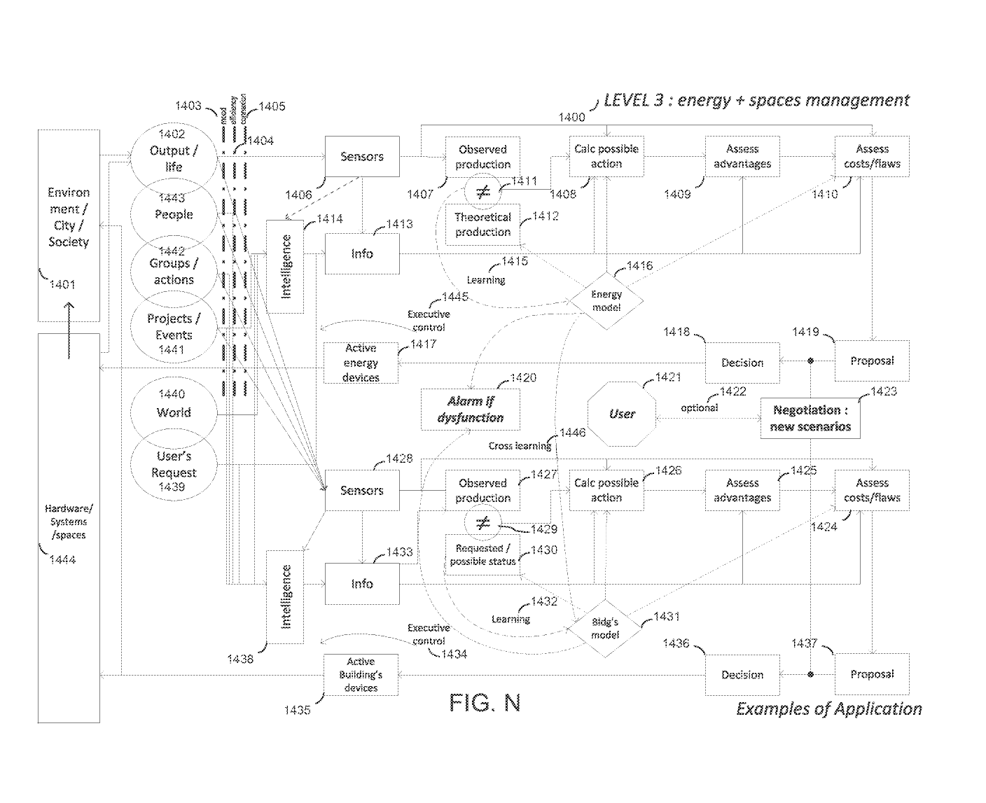

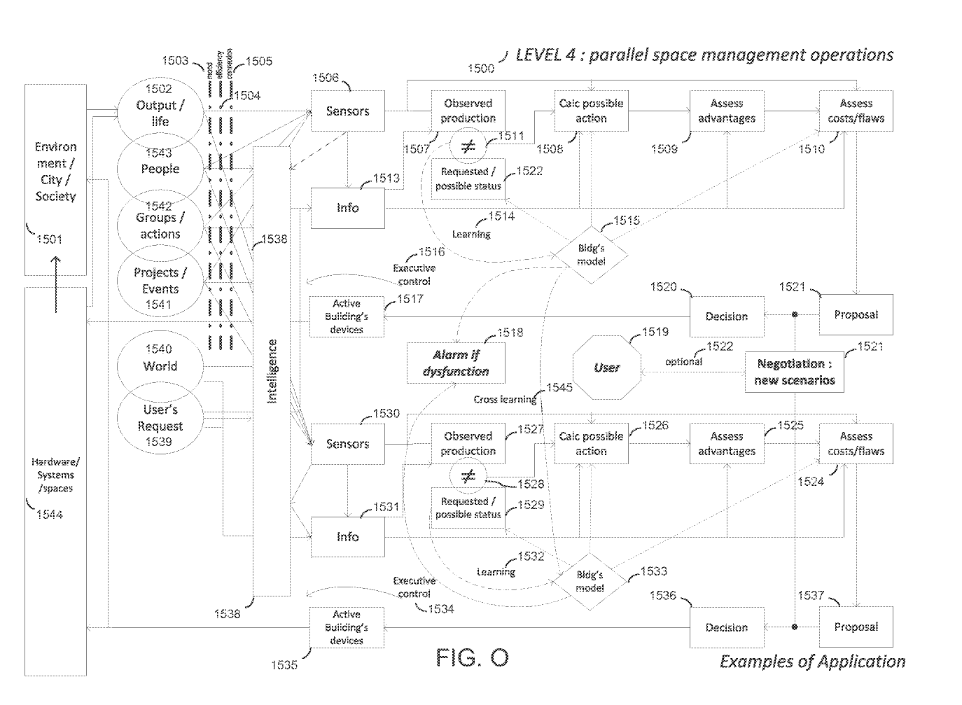

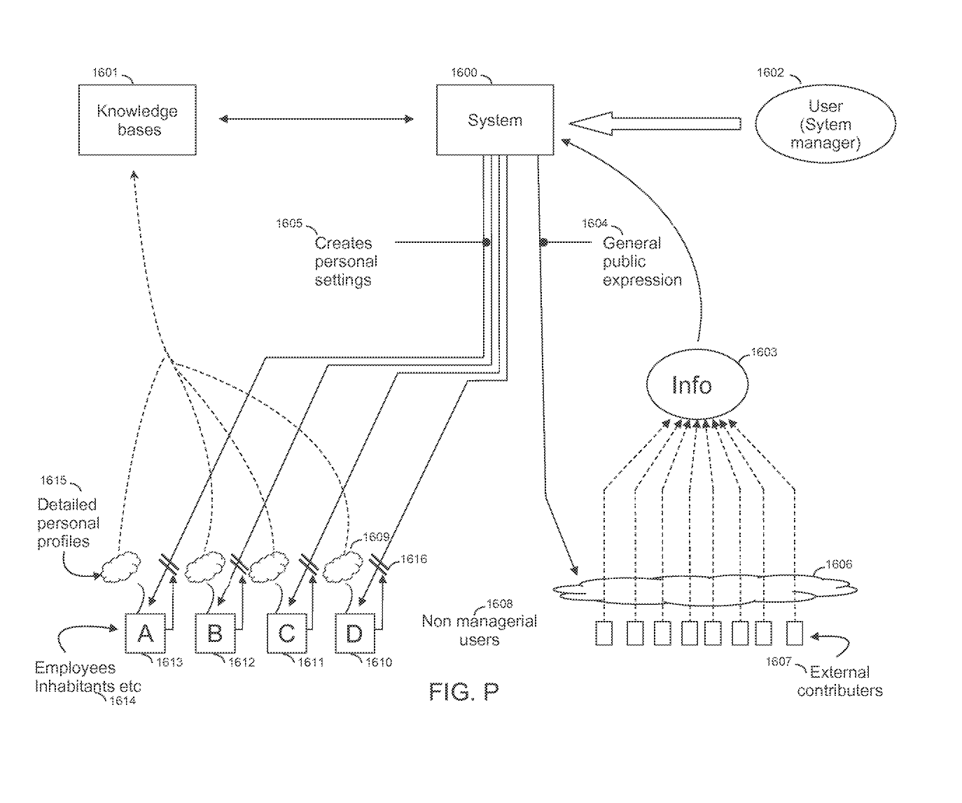

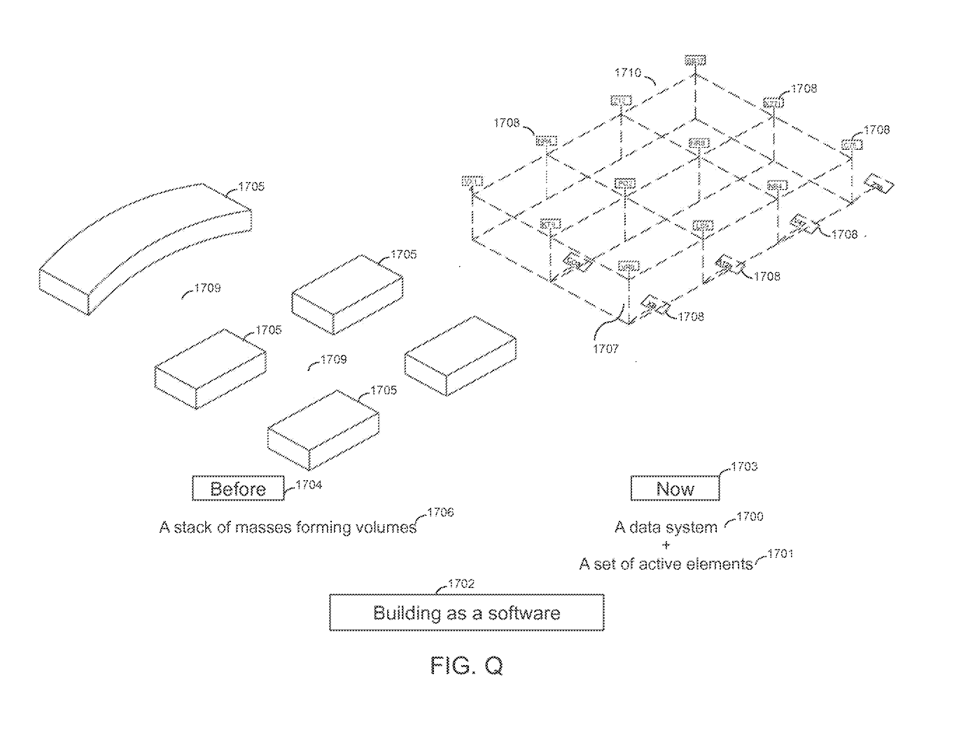

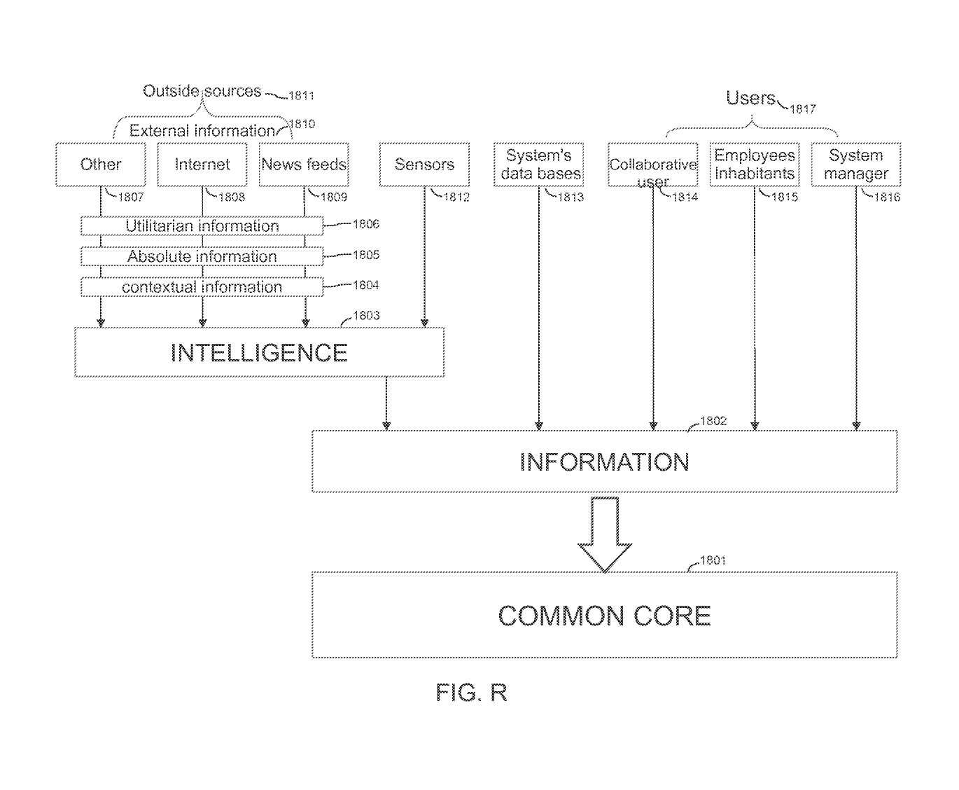

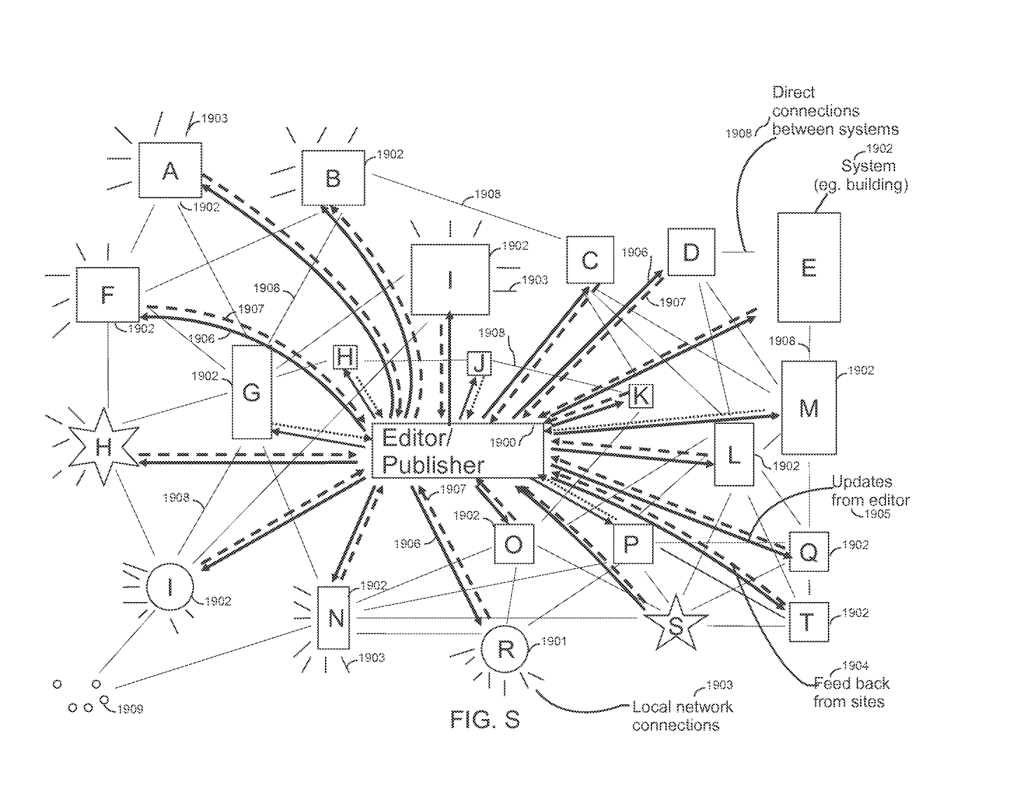

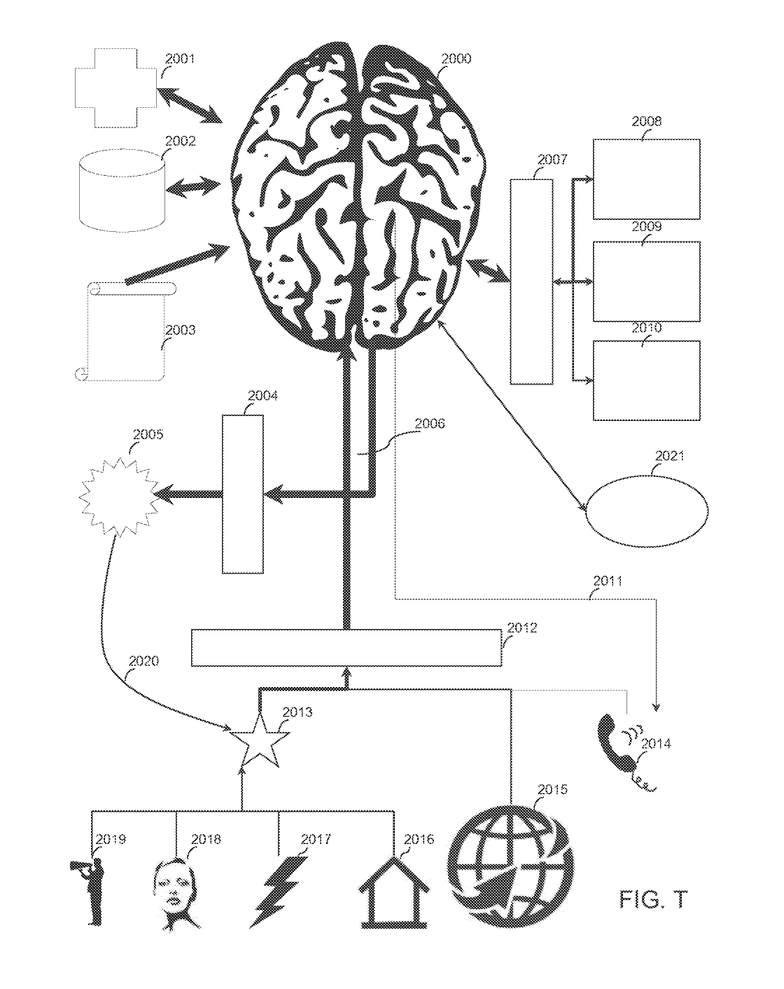

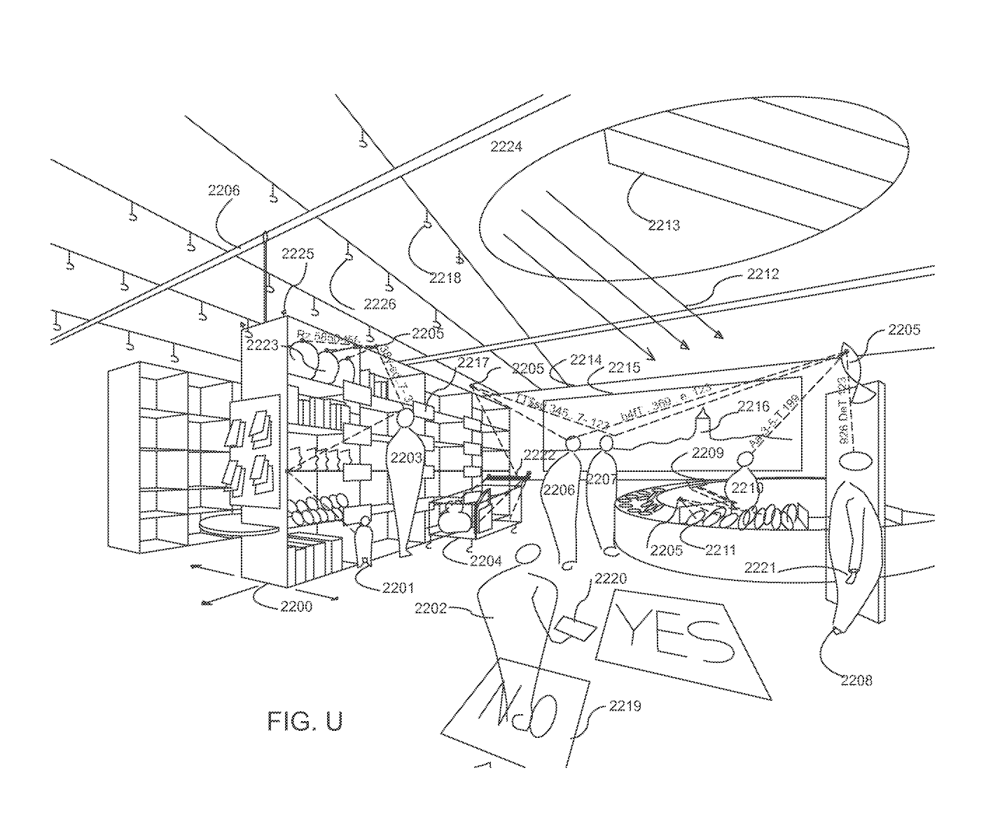

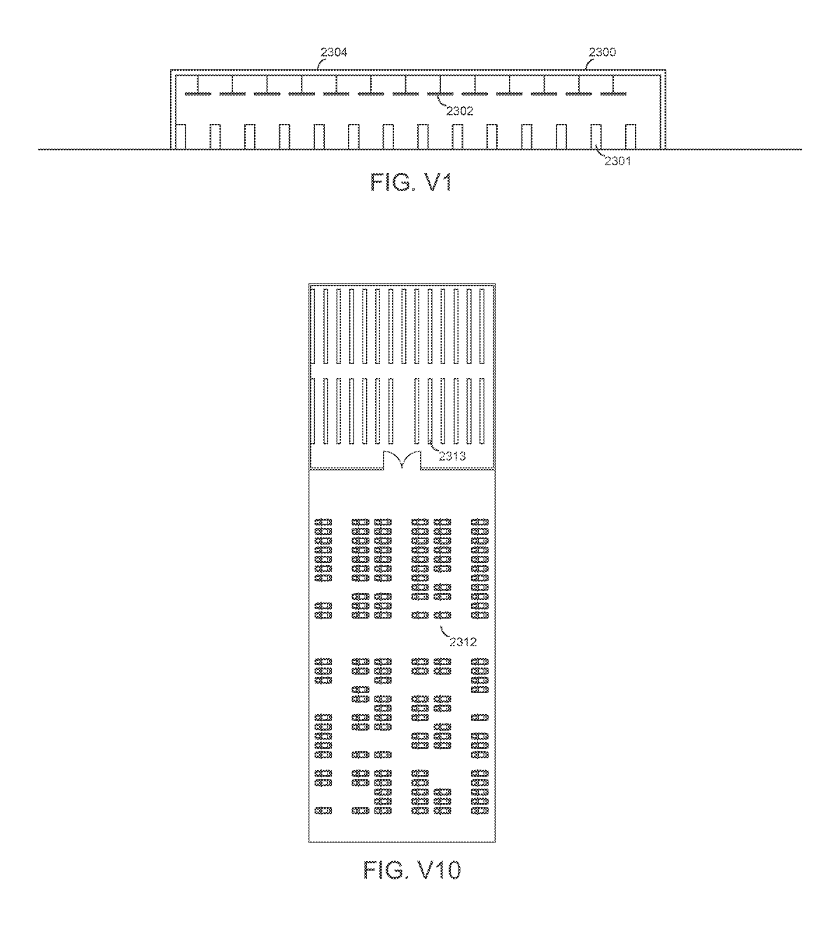

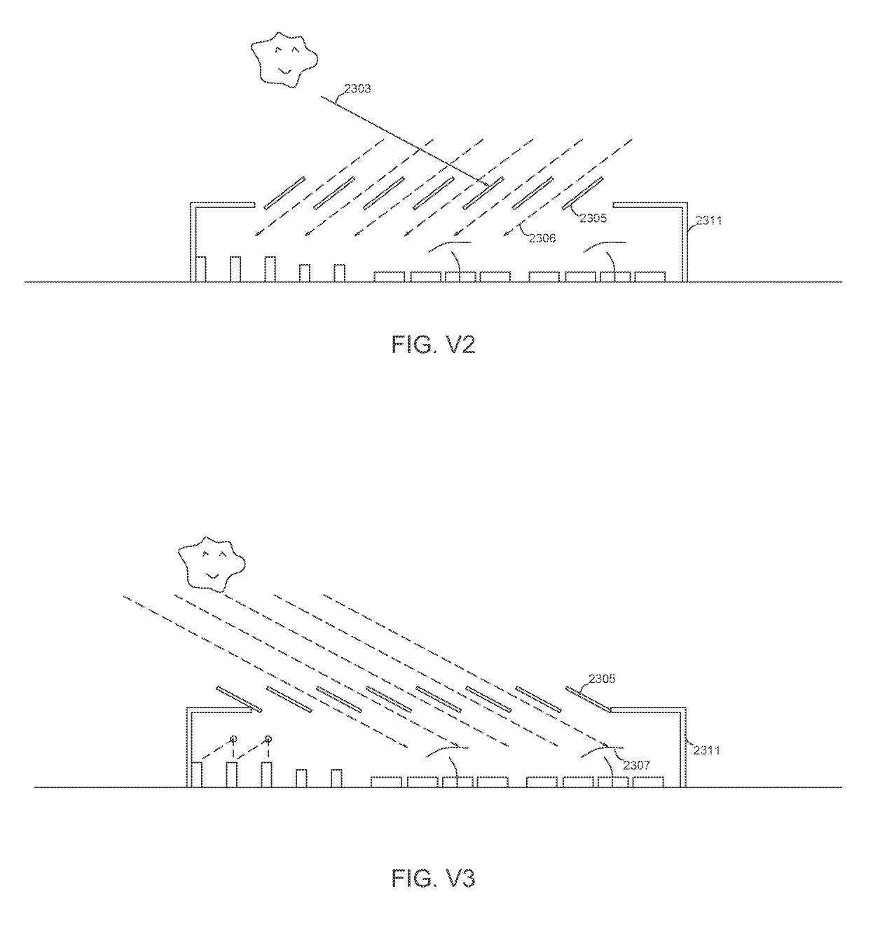

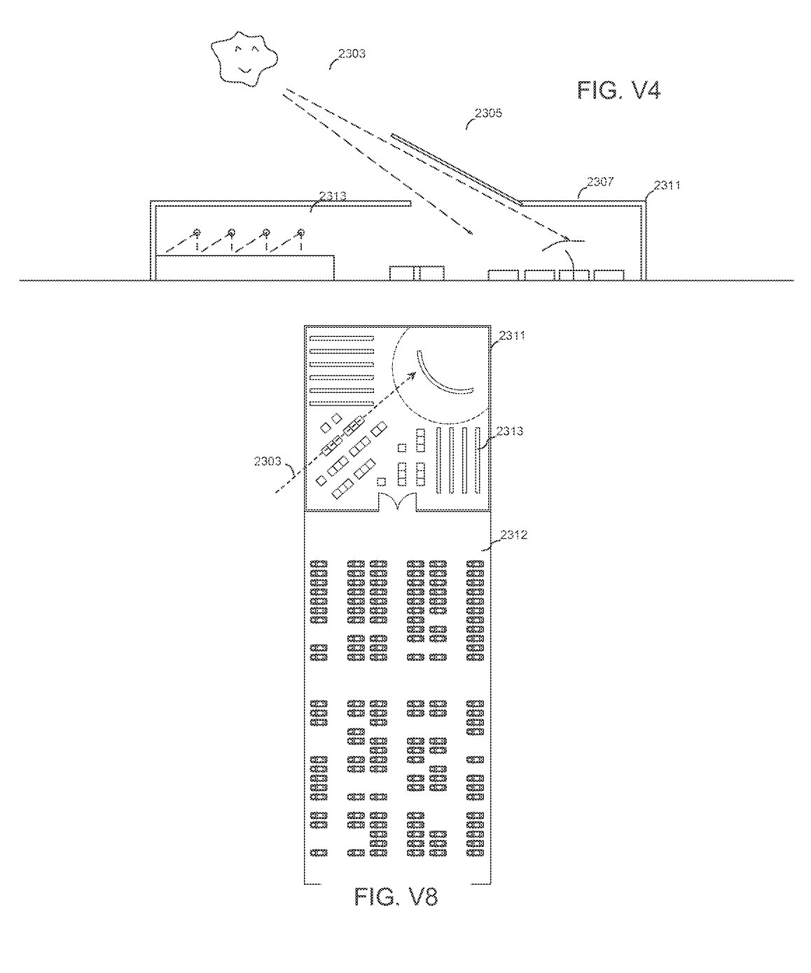

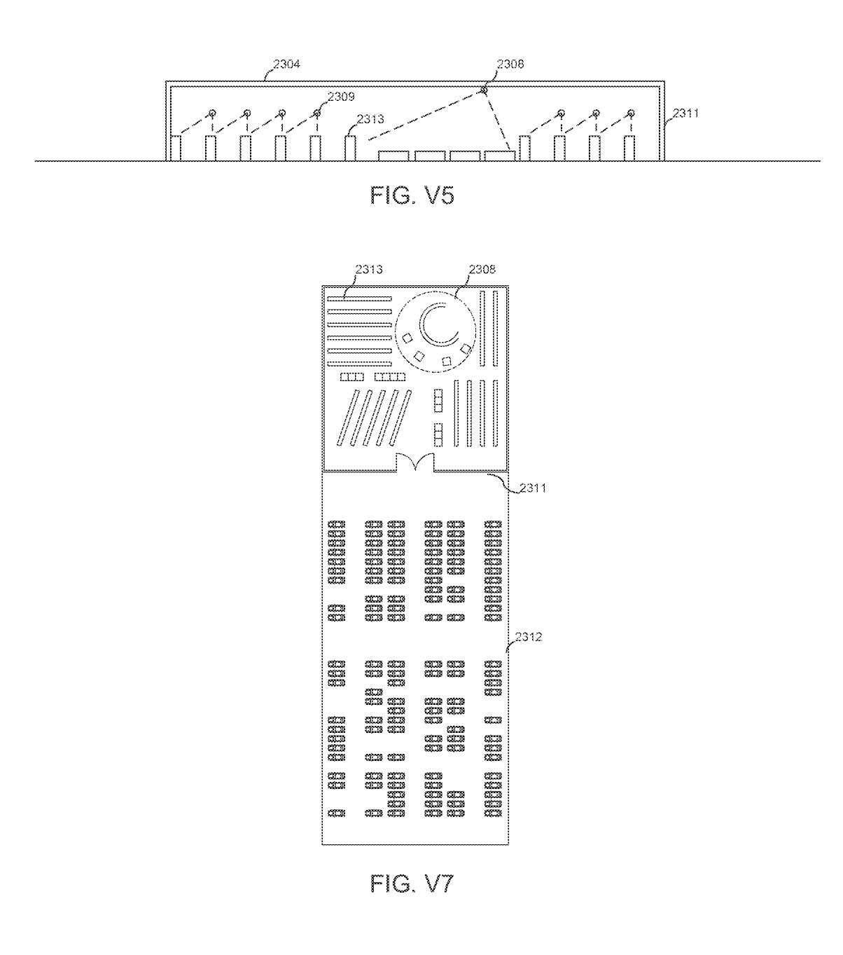

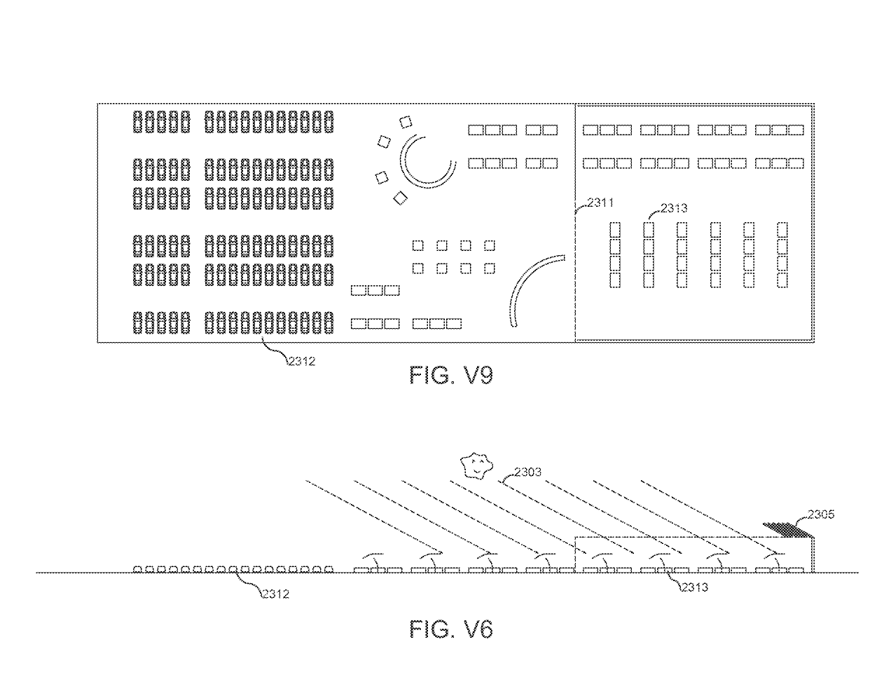

### CROSS REFERENCE TO RELATED APPLICATIONS

This application claims the benefit of U.S. Provisional Patent Application No. 61/801,089 filed Mar. 15, 2013, entitled, “Intelligent Energy and Space Management,” by Alain Poivet and which is hereby incorporated by reference in its entirety.

### BRIEF DESCRIPTION OF THE DRAWINGS

FIG. A illustrates how basic components are used to elaborate complex IB themes and how meaning can be constructed, according to certain embodiments.

FIG. B illustrates the impact of two different organization principles/schemes by showing both logical schemes at play and their associated results, according to certain embodiments.

FIG. C illustrates data collection and processing for a space, according to certain embodiments.

FIG. D illustrates how a model is created and how it is used, according to certain embodiments.

FIG. E illustrates how a model is used, according to certain embodiments.

FIG. F illustrates some non-limiting examples of sensors, according to certain embodiments.

FIG. G illustrates some examples of active devices or active elements, according to certain embodiments.

FIG. H illustrates an example of how the system communicates and interacts with the outside world, according to certain embodiments.

FIG. I illustrates the interactions between people or activities and buildings or sites, according to certain embodiments.

FIG. J illustrates, the manner in which the system works by using a software and/or hardware system, according to certain embodiments

FIG. K illustrates an example of building intelligence process and its learning process, according to certain embodiments.

FIG. L illustrates an example of a simple Level 1 management system, according to certain embodiments.

FIG. M illustrates an example of a Level 2 management system, according to certain embodiments.

FIG. N illustrates an example of Level 3 management system, according to certain embodiments.

FIG. O illustrates an example of a Level 4 management system, according to certain embodiments.

FIG. P illustrates an example of communication channels between the system and several categories of players, according to certain embodiments.

FIG. Q illustrates the difference between an example of traditional buildings or campus and a building designed as a set of data, according to certain embodiments.

FIG. R illustrates an example of the ways information may be transmitted to the system's core, according to certain embodiments.

FIG. S illustrates a network of systems, according to certain embodiments.

FIG. T illustrates a Building Operating System that enables a computer data system to control a building environment or any type of environment, according to certain embodiments.

FIG. U illustrates an example of a retail store or a supermarket that is an intelligent building, according to certain embodiments.

FIGS. V 1-10 show schematic plans and sections showing various examples of configurations of a retail store that is an intelligent building, according to certain embodiments.

### DESCRIPTION OF EMBODIMENTS

Methods, systems, user interfaces, and other aspects of the invention are described. Reference will be made to certain embodiments of the invention, examples of which are illustrated in the accompanying drawings. While the invention will be described in conjunction with the embodiments, it will be understood that it is not intended to limit the invention to these particular embodiments alone. On the contrary, the invention is intended to cover alternatives, modifications and equivalents that are within the spirit and scope of the invention. The specification and drawings are, accordingly, to be regarded in an illustrative rather than a restrictive sense.

Moreover, in the following description, numerous specific details are set forth to provide a thorough understanding of the present invention. However, it will be apparent to one of ordinary skill in the art that the invention may be practiced without these particular details. In other instances, methods, procedures, components, and networks that are well known to those of ordinary skill in the art are not described in detail to avoid obscuring aspects of the present invention. We will describe here a radical change relating to the entire field of construction, the city and the environment.

Certain embodiments will show how buildings, a city, or any construction, can be transformed from being mere spaces to intelligent spaces with data systems (FIG. J), a set of active elements and software structures that allow the intelligent spaces to interact with people and the environment.

Certain embodiments will convert structures that have been passive, inert and immobile into intelligent spaces. According to certain embodiments, such structures can autonomously transform physically, functionally and qualitatively in real time. Endowed with the ability to interact, such structures/spaces will play a real role in social life and become the partners of their users. This will transform the way we live.

According to certain embodiments, basic elements of construction become data, and become active.

According to certain embodiments, a computer system as a building comprises:
a plurality sensors for obtaining information on: characteristics of one or more animate and inanimate occupants of the building, activity in the building and physical and qualitative characteristics of the building;
one or more data analysis tools to analyze the obtained information;
one or more knowledge databases;
one or more models databases;
a plurality of active computerized parametric remote controlled components comprising at least one of the following:
   active computerized parametric remotely controlled wall;
   active computerized parametric remotely controlled ceiling;
   active computerized parametric remotely controlled floor;
   active computerized parametric remotely controlled piece of furniture;
   active computerized parametric remotely controlled window;
   active computerized parametric remotely controlled door;
   active computerized parametric remotely controlled sound system;
   active computerized parametric remotely controlled lighting system;
   active computerized robotic tools;
at least one logical tool to create harmonies between the active components settings;
a data spine for circulating information amongst the plurality of sensors in the building, the plurality of active components in the building, and the data analysis logical tools;
wherein the building interacts and communicates with the one or more animate or inanimate occupants in real-time, and wherein the plurality of active computerized parametric remote controlled components interact with each other in real-time; and
wherein space configuration and space qualities are controlled by settings applied to the plurality of active components.

According to certain embodiments, the associated software, controlling parameters data analysis, generate functional responses and quality spaces.

According to certain embodiments, the software analyzes its environment and human actions to interact with them (FIG. C). The software (artificial intelligence system) analyzes what is happening and proposes adequate responses.

References to “software” herein can mean hardware, software, middleware, or a combination thereof, as may be embodied in one or more computing systems including distributed computing systems, and may be implemented as SAS system (software-as-a-service).

Since almost every component of the building is customizable and the data considered is potentially very large, the software, according to certain embodiments, selects from a wide variety of number of possible combinations. Further, if most building components are customizable, the ability for constant adaptation not only affect technical or functional aspects, it becomes exciting when the building components and spaces change in appearance, volumes, or the mood of the place. According to certain embodiments, the software understands the circumstances and understands the values at stake and is able to produce quality responses.

According to certain embodiments, the software transforms the building to enable the building to interact with the environment or with humans and other living things, and offer creative solutions, thus developing a truly active partnership. The embodiments contribute to increased well-being, to increased equipment efficiency and performance, to increased human productivity, and to reduce foot print, and to open up new fields of cultural interaction.

Certain embodiments can apply to various types of facilities (e.g., hospitals, office building, convention facilities, hotels, assisted living facilities, schools, residential buildings) and can apply to whole towns and cities.

Certain embodiments enable a single building construction to have multiple identities, meanings or functions. Furthermore, since the state of the building/space can dynamically change very often and can affect a large number of parameters, the system records the history of the parameters associated with the state change, according to certain embodiments.

According to certain embodiments, the main structure—which defines the identity of the whole complex—is no longer the supporting structure, but is instead a structure that the software controls, coordinates and manage.

Thus, the embodiments as can referred to as “building as a software” (e.g., see FIG. Q).

According to certain embodiments, the building components, the environment internal and external can enter into communication, and co-management by using the software.

According to certain embodiments, the efficiency, quality of a space is generated by the software, its architecture, its rules and references in connection with human interaction.

According to certain embodiments, the building is a computer system comprising: active computerized movable and interactive components; rules engines; logical controllers; CPUs, and artificial intelligence, wherein the building changes in real-time its functional aspects, geometry, volume, shape, color, climate, ambiance, and lighting in response to the characteristics of the building's occupants, the activities of the occupants and communicates with the one or more occupants in real-time through movement, sound, lighting, visual effects, and environmental effects, and wherein the plurality of active computerized movable and interactive components interact with each other in real-time.

According to certain embodiments, the building is a computer system that is an intelligent partner to the building occupants. The building is a computer that provides a framework for its occupants to play the game of inventing new interactions. It is both a tool and a place where the miracle of space is achieved.

The space in the building is no longer immutable. It is assessed according to what it makes possible. The quality of the space is a temporary setting. The quality and characteristics of the space changes in real-time in response to activities, people,

The architect's job is no longer to set in stone nice or efficient spaces. The architect's job is to imagine structures than enable numerous transformations. The architect's job is to create logical schemes and interaction principles.

The embodiments described herein are not restricted to buildings or to the environment. They can be generalized to many interactive systems.

### Types of Active/Communicating Elements

An active element is defined by its changing status, either through its own resources or by responding to a command, or by undergoing the effects of another phenomenon, or reacting to it.

This ranges from a lamp being lit or the indicator changing color, to complex spatial transformations such as moving walls, facades that transform, roofs that rotate, offices that turn into gardens, changing urban logics, interactions, etc. Also, there are complex active elements that comprise active sub-elements.

Any component that can be driven by any one or more transformations can be considered as an active element. An element can be both active and communicative, e.g., the element can perform an action in response to a trigger phenomenon and, at the same time, provide information such as the control elements of its own action (e.g., movement, temperature, sound, etc.), and/or external pieces of information (e.g., brightness, humidity, acceleration).

For purposes of illustration, non-exhaustive lists of elements (some examples are on FIG. G) that can become active is described below (the lists will evolve with technical progress, when new items become active):

### Basic Elements:

According to certain embodiments, basic elements include lighting systems, sound or smell broadcasting systems, auto-opacifier glass, doors, windows, gates, automatic shutters, curtains, faucets, fountains, misters, sprinklers, fans, heaters, changing paints and glass, shelter and sun awnings, escalators, lifts, elevators, trolleys, bridge cranes, drawbridges, mobile ceilings, etc.

### Elements in Complex Systems:

According to certain embodiments, elements in complex include air conditioning systems (that can produce heat, cold, humidity or atmospheric pressure), projection or display systems, wave emission or radiation systems, production or energy management systems, active landscape systems, etc.

### Further Examples in Complex Systems:

According to certain embodiments, further examples in complex systems include mobile or active facades, mobile ceilings, mobile floors, mobile roofs, materials that can change state on command, robotized elements, robots, vibration systems, systems with varying pressure and voltage, materials that change phases, nature or function, deformable materials, transformable systems, flexible or expendable systems with varying density, opacity or geometry, artificial arms, articulated or flexible systems, organic systems, electrical, light, sound phenomena, sensors, etc.

### Robots:

According to certain embodiments, other types of active or communicating element include complex robots (e.g. service robots, humanoid robots) and as well as the elements on which robots can act.

### Other Examples of Elements

If robots can build, participate in the construction of buildings, in their maintenance, and disassemble/assemble the elements, the robots can render some elements active or capable of being activated.

Such robots can modify, disassemble/reassemble and reconfigure numerous elements. According to certain embodiments, there is a system that schedules changes. Human or robotic teams can perform these changes.

According to certain embodiments, buildings need to be designed and built in a completely different way, According to certain embodiments, building are designed so that: most aspects are modifiable/transformable (e.g., FIG. Q), and most of the supporting structures are modular and transformable. The design process is entirely new. The design process resembles a giant Lego game where many possible modification may be thought of in advance (FIG. B); and since there so many possibilities, one must predict the quality of the spaces to be designed, and set rules for their development and transformation. The embodiments control such constant transformation.

The new 3D printers make it possible to create the parts necessary to achieve completely new configurations as the design progresses, for example.

According to certain embodiments, the design becomes a type of matrix with multiple entries. According to certain embodiments, the core structure is no longer the supporting structure; it is the structure of the matrix, itself linked to the structure of the controlling software.

### Information

According to certain embodiments, the system is not only intelligent in its ability to change/modify elements described herein, it performs such modifications in an intelligent manner. The system understands its environment and its users, and interacts with them.

According to certain embodiments, the system uses the information that it has either deduced from its own observations, or that it gathered from the outside, or was given (e.g., FIG. R).

According to certain embodiments, the system uses any information that can help it to make decisions or propose actions. According to certain embodiments, the system uses, amongst others, these categories of data source:
“Computer databases regarding materials”: technical knowledge of the equipment installed and their status at each point in time (e.g. the database mentioned above, maintenance reports, etc.)
“Sensors”: the data transmitted by the sensors (e.g., FIG. F) and how this raw data is transformed into information
“User Information”: The information that the system is provided, e.g. by the user, in keeping with a voluntary and formalized procedure (e.g., FIG. R).
“External information”: the information the system gathers from the outside

Then, the system processes these raw data and turn it into information. This is described in greater detail in the “Intelligence” section below.

Data Sources that can be Exploited
Computer Database with Information on Materials, and Identification of Components

A building, structure, an outdoor area or even a city is created from thousands or hundreds of thousands of basic components (e.g., FIG. B).

For some of these components, it is useful to know precisely their identity, the history of their assembly, their maintenance history and their real time status.

According to certain embodiments, the system identifies by appropriate means a large number of construction components, whether they are basic components or more sophisticated components or equipment. These components can for example be fitted with an identification chip during their manufacture or assembly, which in some cases may also be capable of communication. If the identifying means is equipped with remote control communication, an appropriate receiving network can perform real-time tracking of the individual components. Alternatively, periodic readings may be performed.

According to certain embodiments, the system creates a computer database to track the life of each of these components from manufacture to the end of their use, including their assembly and maintenance. This database, in addition to ensuring efficient technical management, enables accurate management of an active building, according to certain embodiments. Thus, the building(s) becomes a gigantic data system.

This is particularly true for the active elements as discussed herein and that can, on command, change some of their parameters. To illustrate, a lamp can be controlled and its data collected by the system. It can be turned on or off, produce a low or a high-power light, emit a light of variable color, be positioned at variable heights, and have a variable temperature etc., (e.g., FIG. A).

This is also true of a number of components that are not necessarily controlled remotely but that can change state/status. The system can trace the history and collect data on such components. A simple door, for example, may be opened, ajar, closed, locked, moving, opaque, transparent, etc.

We may also mention the example of components that are not active but of which it may still be interesting to trace the complete history such as the precise “manufacturer reference”, its date of delivery, which tests it has undergone, its date of installation, the identity of the installer, the installation method used, the values used and all the maintenance operations.

As an example, consider a conventional building component such as a solar panel, an automatic door or a shutter.

Everything about its manufacture may be known: the manufacturer's name, the name of the model, specific references and year of manufacture, technical specifications, testing performed by the manufacturer. The system can store such information

Everything about its installation may be known: at least the date and time and the name of the installer, weather conditions or other contextual data. If the installation uses appropriate tools to measure, record and report the actions performed on each piece (e.g. torque, applied pressure etc.), this data can be stored and used.

If the installation is robotized, the information is even more accurate because the robot can keep a record of all the operations along with their parameters and their validation control. The system can store such information.

The system can store information on the tests performed after installation, and record the actions performed and under what conditions (e.g., the opening and shutting of doors, the weather conditions, accelerations and shocks it underwent etc. or even the functioning of a solar panel: production, temperature, initial performance, current performance etc.).

The system can store information on the history of all maintenance operations. If maintenance is automated or robotic, the data will be large and precise.

The identifying means can include a remote communication function so that a receiving network can perform real-time tracking of the individual components. Alternatively, periodic information can be collected.

This also allows for updating the information in real-time as the techniques evolve, the rules of usage change, or the material or dispositions change.

All modifications made by the active elements correspond to parameter changes. Their associated information can be obtained through surveys, measurements, observations, for example.

To summarize, computer database of certain embodiments regarding the materials includes at least information on:
the nature and the origin of the product/component
product/component mounting/installation
product/component maintenance
records on the product/component's states, and records relating to its operation
product/component's successive parameters

### Sensors

According to certain embodiments, the system uses sensors as an information source. This category includes all equipment that can report data: cameras, microphones, sensors, etc.

The construction process, the city, the environment are equipped with an increasing number of sensors of all kinds that report data. With technological advances, sensors will be more numerous, diverse and affordable. Some examples of the sensors are shown in FIG. F.

Sensors Fall into Different Categories:

### Sensors of Technical Elements

Technical equipment and devices may be equipped with multiple sensors that communicate/report their condition, status, consumption, and operating conditions. The system remotely tracks what is happening to each material/component.

For example the system tracks in real time the solar panel's exposure to sunshine, the tension and intensity, its production, outdoor temperature and wind conditions, the cell temperature, etc. In the case of a blowing machine, the system tracks: its operating periods, speed, humidity, temperature of the ambient air and blown air, the electrical voltage, engine temperature, etc.

The system diagnoses in this way almost every technical system, such motorized systems, lighting systems, air and water treatment systems, lift type equipment, shutters and curtains, electrical and computer networks. This also applies to the active elements described above, which, in addition to their active functions, may be equipped with sensors providing information on a variety of parameters.

### Environment Sensors

Whether indoors or outdoors, there may light sensors (power, direction, color temperature, reflection, etc.), air sensors (atmospheric pressure, temperature, humidity, movement speed and direction, etc.), sound sensors, radiation sensors, etc. that can provide information to the system, according to certain embodiments.

### Activity Sensors

The system tracks activity in building and the environment, for example. Solutions range from cameras to motion sensors, ground level sensors, sensors of chair occupancy or parking occupancy, sound and olfactory sensors, electrical radio or digital activity sensors, volume sensors, location sensors, wave sensors, maybe someday sensors of thought or mood, etc., in short any kind of sensors that provide information on what is happening. For example, all the furniture (e.g., chairs, tables, carpet), beds, plates or glasses, mobile or stationary equipment, accessories, professional equipment (e.g. computers, monitors, coffeemakers, etc.), technical equipment (e.g. kitchen equipment, televisions or bathrooms, elevators and garages), machinery (e.g. industrial machinery or farm equipment, tools or intelligent devices), decorative items, etc., in short, all that is necessary can be equipped with sensors.

### Personal Sensors

The system tracks information from sensors, identifiers and/or personal trackers associated with individuals (e.g. residents, employees, etc.), animals, plants or other autonomous entities (for example robots). These sensors transmit masses of information on the activities, attitudes, health, psychological state, behavior or instant status of the carriers of these sensors.

Treatment of this Data

According to certain embodiments, the data flow from the sensors is transformed into actionable information by the system. (An example of data collection and processing is given in FIG. C)

The following are only a few examples of the treatment of the data.

At the simplest level, sensors report basic technical data, such as temperature, sound, volume, position of objects, etc. This allows the system to calculate its level 1 regulation and to determine the position and status of the basic active elements. This ensures that the resulting instructions given to the active elements are well implemented, and enables the system to constantly recalculate the regulation. At this level of observation, the system can already recognize scenarios or calculate deviations from the models. The system can also perform tests or trigger maintenance operations if there is a deviation from the norm, according to certain embodiments.

At a higher level, the system, for example, identifies people, events, work subjects, travels, movements, moods, rhythms, scenarios, dynamics, etc. The system learns independently to recognize people, their habits, attitudes, etc., or connects with external information (e.g., to better understand who these people are). The system also analyzes the quality of environments, the configurations the system created or the action the system has performed and compared to its reference models.

At a higher level, the system describes and understands in real time what people are doing or saying, their attitudes and how they are feeling, even what they expecting or assuming through predictive analysis (e.g., FIG. C). The system also recognizes the logic of group dynamics and the development of situations. As a simple example, the system, as it recognizes the people who usually surround it, can analyze their behavior (attitude, position, movement, rhythm of speech, tone of voice, words, actions and interactions, etc.) or responses (e.g. reaction to a new information or to the arrival of a person etc.) in order to form an idea or a precise tracking/record (monitoring) of their mood, their health or form, or how they feel (it may then develop hypotheses about what they need or how they react to the current spatial configuration). This will enable the system to learn and revise its models.

At a higher level, the system can detect, identify and formalize previously unknown elements, such as people, groups, work topics, events, etc., or identify changes with respect to their previous states (e.g., FIG. D).

At a higher level, the system may also in some cases access the profiles of these people, events, topics, etc., that are available elsewhere (e.g., from other buildings, if available, or from the Internet or elsewhere) to form a more precise understanding (e.g., FIG. E). NB: the system may also operate in a “privacy” mode, and not identify people, topics, events etc.

How raw data, such as video streams, may be processed to generate relevant information is discussed in the “Intelligence” section below (e.g., is it windy, is the device working correctly, who are these people, what are they doing, what do they feel? Or, for example: how ‘good’ is the current theme—see below —, how involved are the participants, what is happening outside?).

To better understand/inform its observations, the system can, in some cases, draw on the information collected by other intelligent modules, especially those who are in contact with the outside world. This information will also help it determine whether an event/occurrence deserves to be taken into account by the system.

It is discussed below, how the system forms hypotheses on the basis of its observations, use or construct models, schemas of reference and/or ask other modules to search, amongst the flow of external sources or in their own databases and knowledge, information that may help the system understand what it perceives. Relevance depends on the context and the time frame.

### User Information

The user can directly enter useful information or instructions in the system (e.g., FIG. R, FIG. P). The procedures outlined here are only examples. Using the system will trigger the emergence of countless innovations or practices that are not listed here.

The term “User” can be understood on different levels as described below.

### System Manager

The system manager, who is in control (e.g., FIG. P, FIGS. L,M,N,O), may give instructions e.g., to change the programming parameters or the system objectives. The more knowledge/data the system has, the better understands and handles situations.

This task of providing the system with the necessary knowledge can be automated because it builds on the elements developed by the site's designers, by the group or business managers, the programmers, etc.

The system manager may also, under normal operating circumstances, occasionally provide information on the space usage schedule, events schedule, shifts from one mode to another, etc.

The system manager may experiment, either in real time or on a scheduled basis, with the system, its settings, its choices, parameters, programs.

### Non-Managerial Users

Let us imagine the employees working in a building controlled by the system (e.g., FIG. P). For example, the employees may use direct channels of communication to. request changes, give their opinion, in one way or another, through a voluntary and formalized process.

The employees can also use the configuration solutions to inform the system of their needs, so that this information will be taken into account by the decision making process. For example, they may inform the system of the launch of a new taskforce, or of a new lifestyle, a new trend, etc. The employees can also respond to the proposals or decisions of the system, which will enable it to make corrections and learn from its mistakes.

Among the “non-managerial users”, there are also “contributors”: those that choose to interact with the system in a collaborative way, like visitors of a public space would vote or act in a certain way to contribute to the emergence of a collective expression.

One must bear in mind that this section deals only with information voluntarily given in a formalized way: not formalized contributions that derive either from the observations made by the sensors or from external sources such as the internet or social media, are not covered here.

Information from Outside

The building, city or area managed by the system become active players. The system is connected and informed/knowledgeable. FIG. N shows how information is fed to the system)

The system's intelligence feeds on information through which it develops an understanding and weighs its decisions. The system uses many sources of external information, from the Internet or elsewhere. All available sources of information may be used. Below is a non-exhaustive list of examples:

### Simple Utilitarian Information

For example, the system subscribes to a number of information flows that enables the system to behave/pilot in a more accurate way (e.g., FIG. R).

For example, an energy production system knows the energy prices in real time, the network load and the foreseeable/likely demands, weather forecasts, or even the number of employees or visitors who are on their way to the building's parking lots with electric vehicles for recharging.

Similarly, the system for a site concerned with transport infrastructure knows the scheduled times of vehicles, the predicted passenger flows, the precise arrival time of approaching vehicles, the weather, any delays, prices, etc.

### Absolute Information

The system follows the news and may select information of interest and make use of it (e.g., FIG. R).

For example, on Christmas Day, or the day of a major sporting event, or on an election day, on the first day of spring, the system can change the building, cause it to, emanate a particular atmosphere, display messages, etc.

### Contextual Information

This deals with different types of external/outside information e.g. on people, topic or the environment. (e.g., FIG. R)

### Information on Topics, Events, Projects

According to certain embodiments, the system knows how important some topics are for the persons over whom it watches, their environment, the population of the city, etc. It gathers this information either because the system has been informed or because the system deduced the information from the user's activity. The system knows its environment, the projects on which people work, their interests etc. The system may therefore research information on these topics and incorporate such information into the process, and select the information that it will use.

### Cultural and Mood-Related Information

The system analyses information that enables it to understand the evolution of a cultural context, of trends help it to form an understanding of the mood of the time/age, of the public, the evolution of their feelings, etc.

### Information on People

The system can collect large amounts of information on the people who visit a particular site/location. Social media is a large source of information. There will be even more data sources in the future. The system cross references this information with what it already knows of people, priorities, work in progress, location or of its own assignment/mission and understand what they are interested in.

Information from Dialogue (See e.g., FIG. H)

The system uses a universal language, dialogue structures, protocols and common grounds allowing all objects and systems in the world to communicate with each other.

For example, the system may communicate with:
Other intelligent buildings (e.g., FIG. S)
Large regulation systems: urban regulation, networks regulation, institutional systems, security systems, etc.
Systems of internal regulation: elevators, traffic, energy, parking, maintenance, etc.
Mobile, communicating robots and machines: cars and other vehicles, robots (domestic robots, utilitarian robots, robots for personal assistance, maintenance robots etc.), personal assistants of all kinds (e.g., telephones, active glasses, future systems of all kinds etc.)
Communicating objects: many commercial objects will be equipped with communication functions, for example the food we buy, the water bottle, the tube of pills, the toothbrush, the clothes, and almost every device or everyday objects.
Lastly, almost all objects, structures, systems, people or external actors (not physically attached to the building), whether they are in the building or not, near or far, and whatever their nature, are intended to become sources of information and/or dialogue. Since we have established that most of the components of the building and what is attached to it are also sources of information and dialogue, it derives that almost everything falls into the system's scope of knowledge and communication.

### Intelligence and Interactivity

We have just shown how a building, a structure, a city, an outdoor space, or any kind of system can become a system of data and parameters. We have also pointed out that some of these components may become active and act. The logic described here for a building, a constructed element or a city is applicable to any other object or environment that can be made interactive: a train, a car, a domestic appliance, a road, a robot, etc.

In order for the building to go beyond being a mere shelter or even a machine and become an active partner, it must understand what is expected of it and understand what is going on.

The issue at stake is understanding how and why it works, how it makes itself useful, how it increases the global efficiency, multiplies the global creativity, the overall quality of life and the interactions, both at the local, micro level and on an urban scale.

There are to two fundamental issues:

What information is made available to the entity that decides and controls the actions?

What are the rules and objectives governing or justifying these actions? (e.g., FIG. K)

There also technical issues such as how do we manage all the functions of a building to work together in harmony? This may be achieved by using a Building Operating System than enables all the players (sensors, active devices, regular construction equipment, third party systems, external systems such as city management systems, etc.) the dialog together, starting with using common languages, protocols, rues, etc. The building Operating System also allows for sharing the devices: instead of having a set of sensors or a set of active devices for fire detection systems, another one for safety, another one for productivity or comfort, etc. the Building Operating Systems allows for sharing many components and making them multi task multi-functional.

To govern itself, the system carries out numerous operations including operations of information, modeling, and execution.

The system transforms raw data into usable information (e.g., FIG. R), compares them to models and draws conclusions, proposes or decides actions, implements them and monitors their execution.

The system's most basic source of information is the information one gives out formally. Its secondary source is that which the system understands itself through its observations and the information it gathers from external sources (e.g., FIG. E).

In addition, in order to turn the building into creative machine, an active partner of mankind, it is necessary to master qualitative criteria and produce meaningful elements. Design and management of the system is much more complex.

Thus, the system may be a stratified system that operates on several levels, from the simplest to the most complex, and often in parallel and interacting.

### Objectives of Qualitative Management

### Qualitative Structuration

It is described below how the basic components are used to elaborate complex themes, and how meaning may be constructed. (e.g., FIG. A)

### Intelligent Building (IB) Players

Let us first identify the fundamental technical systems, some of which we have previously called active elements, and referred to herein as intelligent building players “IB Players”. These are e.g. air-conditioning, lighting systems, sound systems, acoustics, moveable walls, glazing, rotating roofs, automatic doors, automatic shutters, etc. Each of them may be made of many basic active components. (e.g., FIG. G).

Each of these “IB Players” may play/act in simple or complex ways, referred to herein as “levels”.

### Levels

Let us take the example of how the “IB Player” “heating system” works. It is:
on level 1 when it regulates itself in a closed circuit. This level includes the given command, execution control, correction of the parameters according to the results and the learning (model correction). (e.g., FIG. L)
on level 2 when it integrates external parameters such as the cost of energy in real time: it can integrate more parameters and make more informed decisions. (e.g., FIG. M)
on level 3 when it includes; for example, information on the use of the building (e.g., FIG. N) at a given time (does this activity or project require heat or cold etc.).
on level 4 when it includes an added layer of information (for example user preferences). (e.g., FIG. O)

And so on, up to tens of levels, especially when systems interact with each other and with the environment, activities, people, etc.

### IB Notes

The IB Players are interesting in the role they play, and in what they make possible to achieve. Beyond technical engineering, comes the qualitative work. Quality, or rather the qualities, is to become digital values, fine tunings that are expressed in numerical values and rules of action.

There are a number of simple phenomena such as heating, lighting, space and volume, etc., but the more effective portion is in the interaction of all these basic systems e.g., when the heating issue meets with the natural light issue, or the issue of configuration of the volumes at a given time or that of user activity. Thus each system has to be managed independently and then deal with the way of working together.

The system performs complex management that incorporates several levels and coordinates the actions of all the configurable factors, and rely on a variety of external information.

The relevant information is therefore not the same for each topic, each level, or each combination of levels and topics.

We will develop an analogy between an interactive building and a musical instrument. We will use the term of “IB Notes”: such and such lighting atmosphere will be called an “IB Note”, and the same goes for a particular climatic environment, a particular type of volume, etc. An “IB Note” may combine the action of several technical systems. Just about every perceptible element may become an “IB Note”. For example, a circulation logic, a type of quality of space or interaction, a way of moving, etc. may be “IB Notes”. Many technical systems may produce several “IB Notes” simultaneously or successively. “IB Notes” are carefully designed (thereby inventing a new creative profession), calibrated and controlled. IB Notes are also often parameterized and measurable.

### IB Harmony

The embodiments take into consideration the quality of the effects, interactions or atmospheres created. It is understood that the “IB Notes” fine-tune themselves in relation to the others and play together in scales, chords or harmonies. The “IB Notes” that stand out for working well together will take part in “IB Harmonies”.

An “IB Harmony” may combine several “IB Notes”, for example a luminous atmosphere+sound+a type of volume+a range of colors+a thermal atmosphere+a type of spatial qualities+a type of view+a type of interactions+a type of movement, etc. (examples of IB Harmonies—A, B, C, D, E—are given in FIG. A)

### IB Themes

The range of expected developments on the basis of one or more “IB Harmonies” could be called “IB Themes”. The “IB Theme” is not only the development of the harmony over time but also its interactive version. The “IB Theme” has ranges of harmonies, rules, colors, and qualitative guides.

An example of an IB Theme comprising 5 IB Harmonies is schematized in FIG. A

### IB Culture

The collection of topics that the system has stocked up is its culture

### IB Configuration

Lastly, there are the “IB Settings”. The “IB Configuration” is the exact status of the system at a given time. The IB Configuration may derive from an IB theme, or may be completely innovative. The IB Configuration may be saved, reused, improved, evaluated, analyzed, etc. Since the building is active, controlled and recorded, its performance can be reproduced identically, turned into a IB theme and reinterpreted according to the current settings (IB Configuration).

The intelligent building (IB) will improvise on themes, and people—possibly surprised by the proposals—will interact with it. This is a creative system that stimulates everyone involved. The system is free, but guided by some themes. It may make them evolve.

### New Design Work

Every “IB Notes”, “IB Harmony” and “IB Themes” will have been learnt, built, designed, and developed in the system. They include rules, instructions, qualitative measures, etc.

Each one of these qualities, introduced into the system as models or objectives, must first be thought up by the designers of the site, in all specialty areas concerned.

To design IB themes and IB harmonies is a revolution for the architect, who must now think of dynamic, evolving spaces and bundles of spatial possibilities. The architect must tell the software what direction to take, what the software should focus on and how to evaluate the results.

This revolution also concerns the company's manager, the engineer, sociologist, industrialist, energy company, specialist in the organization of labor, the doctor, etc., in short, all areas affected by these settings.

The structure of the software is just as important as the building structure, of which only a few pieces remain inert. These two structures are designed/conceived together. For example, a tree structure, where each element depends on the upper element, or a matrix structure, will give entirely different results.

In some applications, one can play with creative buildings (mixing IB Notes, create live IB Harmonies and IB Themes, etc.) in real time. This is another new profession.

### Construction of Meaning

### Modeling the Meanings

We have seen that the very free parameters applicable to the active elements will gain meaning through “IB Harmony” and “IB Themes”, i.e. the raw and continuous technical data is meaningfully arranged through the application of markers/points of reference, reading grids and models.

The system learns through its achievements, understands their meaning, understands the emotional or stimulating power of a space, an organization, etc. Designers initially provide to the system patterns, rules and basic information. The system learns to understand on its own and modify its own creations by assessing the reactions and feelings of people, or the practical, technical and organizational consequences, or by receiving formal responses and instructions from the human actors involved. Using feedback, the system refines its models and rules, or create new ones.

### Modeling Phenomena, Situations, Behaviors, Characters

Architecture and space are not the only phenomena that can be modeled.

To understand what is going on, the system needs references and models. Models allow the system to recognize cases (models) and measure significant differences (gaps). The system may also recognize a spatial situation made of hundreds of elements and parameters. The system may recognize social, urban, behavioral, industrial situations etc. Most evolving systems can be modeled. These models may be used by the system to understand what surrounds it. Everything is boiled down to figures, that are compared to models or profiles.

The same goes for the random behavior of external actors such as humans, the environment or the users of the city, for example. Their “status”, their attitude and their evolution will be assessed by values reported on grids, and the system will derive that their behavior usually more or less resembles known profiles or models, which ultimately resemble “IB Themes”. The current status of people, events or projects, their behavior, their reactions and interactions are modeled; either measured by their deviations from the model, or new enough in the eyes of the system to justify the creation of new models. These models will improve and refine over time.

For the purpose of clarity, let us compare a person to a theme. It is always the same person, but depending on the time, he behaves in different ways. His attitude, behavior, physical appearance, needs, etc. (which are the IB harmonies) are constantly changing. Yet this person, through each of his instruments (clothing, arms, eyes, hair, etc.), can only play a certain range of IB Notes. We recognize him perfectly because we recognize the notes, the harmonies, and therefore the theme. This example applies to the behavioral ranges, to urban situations, etc.

A soon as a reliable model has been established, it becomes possible to spot the variations. For example, for a one person, one will be made to wonder why he chose this attitude over another, why his color, activity, heart rate, skin temperature or the sound of his voice suddenly changed. It will become possible to predict his reactions to a situation, his level of stress or pleasure, his medical condition, etc.

### Transforming Data

Accurate identity of the men and events are transformed into information for the system to understand, and on the basis of which the system will create efficient configurations.

Technology, nature, people and events are converted into digital data and processed by a mathematical model that uses this data as a raw material for carving/creating original material achievements.

In our example, the module to “analyze a person” will, on the basis of these data, calculate information that it will send to the system. The system will decide whether to propose concrete actions, or not.

These models may benefit at once from the progress in humanities, dating mining or social media, and conversely, they may further enhance their progression through data and a qualitative analysis of feelings, behaviors and reactions that only this type of building as a medium can trigger or collect.

### Learning

Since the system knows how to analyze data and turn it into useful information, the system can also compare the results obtained to what was expected (e.g., FIG. E). The system can either correct its models or create new ones if there is no match. (e.g., FIG. K)

If the system corrects its models, the system will examine the reasons for this gap. Correcting the model will automatically change all the calculations that the system uses.

If the system is to create a new model from a small body of information, the system will gather the missing information elsewhere.

### Technical Interactivity

For the purpose of clarity, let us take a technical example: the heating of a space with a solar system combining electricity and heating (e.g., FIG. L).

The system permanently reads the continuous flow of information concerning the air flow and power solar panels. The system cross-references this data with records of weather condition and information about the state of the network (grid). The system calculates its production and profitability.

The system calculates its needs. For example, the system may detect that 12 people are in the room, and the system knows which “IB Harmony” the people like, and that the group is working on a project that requires such and such “IB Note” heat. The system may also discover that a cold wave is expected and that electricity will be expensive.

The system notices (e.g., by deciphering the physical reactions of individuals) that the atmosphere is not optimal. The system may propose different settings, or automated maintenance operations, etc.

Then the system orders the active devices necessary to perform these actions and oversees their execution. The system measures the results and draws conclusions in order to correct the model or create new cases, etc. The system takes in and records the reactions of these specific materials, the technical effectiveness of the actions taken, the reactions of users, the benefits to the project, etc.

In this example, it is clear that the system uses multiple sources of information. The process can include:

Records of tens of sensors are filtered and turned into data (e.g., FIG. R).

Amongst the Internet flow of information, the system picks up that the details of the grid load and price are relevant at this particular time.

The system examines the models and experiment feedbacks that relate to these activities, and finds out whether these activities require special conditions.

The system studies the profiles of each participant and of groups to figure out their preferences.

The system enters these parameters into the calculation program

The system determines which active elements need to be used to achieve these objectives and analyses the advantages and disadvantages

The system offers a solution to the manager, or takes an independent decision (if this is part of automated decisions field)

The system gives the necessary instructions to every component involved

The system oversees their implementation and results

In case of discrepancy, the system slightly correct the settings and the models, or create new ones, and carries on, in real-time.

### Space Interactivity

It is understood that what has been described about IB Players becomes more complex when they become “IB Notes”, and IB Notes combine into “IB harmonies” to create “IB themes” which are changing and interactive.

### Example of an Application of the System

Let us imagine an office building equipped with active elements, and a group of people that work on a specific project (of which the system has a good knowledge)
The building has a culture: the system knows a wide range of IB themes, IB harmonies and IB notes, rules of action, its inhabitants and their activities, which the system has learned and refined over time, and the system knows the effects of its actions and interactions.
Let us state (this is a simple case) that the active elements, the IB Players, are the air conditioning, lighting, mobile roofs and facades, and a few movable partitions.

Each of the “IB Players” acts according to environmental interaction logic described above, and necessarily interacts with other IB Players, which will require rulings.

Scenario:

The space is configured according to one of the “IB Themes” (e.g., FIG. A) recommended by the model to improve the work conditions of this group on this topic, which include a closed/shut roof and views, although these might change depending on the rain and the cold. The space has also been amended to accommodate the personal preferences of several members of the group (e.g., FIG. I).

The rain has stopped and it makes sense to rotate the roof and bring natural light into the room. In addition, the “Energy” module is asking to optimize the solar roofs. The system has picked up that the group is not currently using the screens and that they could do with some encouragement.

This will change every heat and light parameter, which are already affected by the rising temperatures and instantaneous fall in electricity prices caused by the change in weather conditions.

In addition, that it has stopped raining will accelerate the traffic and visitors will arrive sooner than expected to charge their electric cars (e.g., FIG. I).

Furthermore, the rotation of the roof will open new views and a new type of space: the model will then recommend several partitions movements, changes in lighting and air conditioning, etc. to balance the space and reach the “IB Harmonies” corresponding to the “IB Theme” in progress, etc.

In parallel, the analysis of human activities will cause the system to choose a slightly subversive IB theme, which will add a series of qualitative parameters to the calculation of each IB note and ruling mentioned above.

Yet, perhaps as a consequence of the change in weather, the group dynamics or the change in space, the humans are back on track and divide new tasks, leading to a change in “IB Theme”.

However since the time, the weather and the dynamics and composition of the group have changed again, the system will compose its IB theme differently in the evening than in the morning.

After a time, the system will detect that people are not reacting the same way they did last time. The system will modify its settings in increments until it obtains the desired mood/atmosphere. The system will revise its models in order to find the cause of this discrepancy.

Assume that the system, which knows where the people's work/task is going, suddenly finds information on the Internet that changes everything.

The system hesitates. Should the system wake up the group with a spectacular space mutation.

The system may decide, because the system has the experience of their reactions, because the late afternoon sun is beautiful and because the humans look like they could use some fresh air, to display this information on the walls, or even to start with turning the hall configured Abc8 into a garden created on the basis of the dfrx54 configuration (because it has rained), and play music by the fountain, and to project the information on the wall when the entire group has arrived.

### Intelligence

### Software

### Principle

The system is responsible for the overall management of an interactive complex. It controls the sensors and active elements, and uses information sources. (e.g., FIG. J)

It can be used to manage buildings, facilities, cities, and also all kinds of interactive systems. (e.g., FIG. K)

In some cases, the system has full control of the buildings, sites, or systems. The system can then control all the sensors, all active elements, all site settings and overall manage the relationships with the environment, people and robots, as well as maintenance.

The system is based on a modular architecture that allows it to be installed individually in many sites or different cases of application, according to certain embodiments. There could be thousands of buildings and urban ensembles or other systems that use the same family/type of systems and that could interact.

Its structure allows the system in some cases to be updated regularly by the publisher, and to benefit from the latest improvements and experiment results.

According to certain embodiments, the system works by using a software system that includes (e.g., FIG. J):
A common core
Communication interfaces
Compulsory and optional modules.
Optional bases of knowledge, concepts and instructions

Bases of Settings, Instructions and Local Knowledge

### Common Core

According to certain embodiments, the common core is a module of technical control: on the basis of the data received, the common core controls active elements with reference to their instructions, the calculation of which depends on knowledge, concepts and settings.

Data and common elements have been described above.

Calculations can be handled locally or outsourced.

The instructions are described below.

According to certain embodiments, the common core is designed to manage a vast number of parameters, data and active elements of all kind; to be fully configurable, and to work with a wide variety of additional elements (modules, interfaces, knowledge, etc.).

### Communication Interface

### Technical Elements and Universal Language

Communicating objects exist, but they sometimes use different languages. When the system is installed on a site, it include every language that is necessary to control these devices.

But it is desirable to be able to communicate easily with any new party, including moving objects (cars, robots, personal effects, mobile sensors etc.).

For this reason, the system will also offer a universal language of secure communication on which manufacturers could join, and allow all of these objects to easily interact and chat in real time.

Communication with Other Systems (e.g., FIG. H)

The system can gain a lot from communicating with other systems, such as:
identical systems installed on other sites (e.g., FIG. S)
institutional systems (e.g., urban management, transportation system or energy companies, etc.)

According to certain embodiments, the system may offer a common language and common communication protocols that enable all of these systems to converse securely in real time.

When many sites use the system, they may interact with each other or with the outside world, exchange information or coordinate actions and improve their management and the environment, according to certain embodiments.

### Users

The user, whether it is the “system manager” (e.g., FIGS. L, M, N, O), an authorized user (FIGS. H, I), or simply the public, can interact with the system through formalized procedures that grant each category of users specific rights and privileges.

If a universal language and procedures are in place, the mobile user will easily find his marks upon arriving at a new site.

The system includes an intelligent interface to assist the “system manager” in the setting of the site, the software, the modules and the active elements.

### Compulsory and Optional Modules

According to certain embodiments, the system is partially modular. (e.g., FIG. J)

Software components may be added like bricks to bring in simple or complex functions, or entire sets/complexes.

Some modules may be compulsory, such as security modules.

These modules may be updated.

The modular system enables one to add features as if they were bricks, and thus to achieve on each site the customized required system.

The number of modules can be very large. Some modules may be third-party applications developed by independent companies, subject to validation by the system editor. It derives that software, technical, scientific ecosystems etc. will spring from this basis.

Each module can be configured according to the needs of the site and the user. To make the process easier, a system of assisted configuration is developed. It is part of the intelligent interface for the “System manager.”

There are basic modules, simple modules and complex modules, relating to other modules, as described below:

### Basic Modules

Management of materials modules
Elementary techniques modules

### Simple Modules:

energy management, solar management, climate control, resource management, flows management, all specialized technical managements (e.g. plumbing, rotating roofs, lighting, etc.), etc. . . .
Maintenance Management
Speech Recognition (with different languages)
Recognition of people
Recognition of activities
Analysis of behavior
Analysis of health/medical analysis
Management of spatial qualities
Communications Management
Monitoring of plantations
Inventory Management
Etc.

### Complex Modules

Agricultural Management
Hospital
Offices
Housing
Agriculture
Industry
Transportation
City management
Etc.

### Optional Bases of Knowledge, Concepts and Directions

The system comes with a number of preinstalled knowledge bases. The user may in some cases create or buy complementary knowledge bases.
More importantly, these knowledge bases can evolve: they can be enriched with acquired learning, experiment feedback or theoretical works carried out by the system and the user.
In some cases, if the user wishes, some elements may be exchanged with the publisher, with other systems, or for example with the scientific community in order to improve the common capital.
Complex cases may be subjected to the publisher's scientific teams
New content or new knowledge bases may be proposed or updated
The number of databases is virtually unlimited. Some knowledge bases may be developed by independent companies, subject to validation by the system vendor. It derives once more that software, technical, scientific, ecosystems etc. will spring from this basis.

We will discuss later on how the information in the knowledge bases is structured.

The system may, in some cases, come with some knowledge bases that not only provide certain information but also propose a way of structuring this information. Based on this structure, the system gradually enhances the information, edits it etc. The original information and its structure remain accessible. The changes made while the system was in use, the original information, and even it structure may be modified on the side through updates or when third-party knowledge bases are brought in.

The information contained in these knowledge bases comes mainly from a few sources (e.g., FIG. J):
Information originally provided by the publisher
Information provided by the user
Information deriving from the system's learning
Information from external sources (e.g. obtained on the internet, provided by third parties, etc.)

### Bases of Knowledge

Examples of knowledge bases include:

About the nature of the site
The building, the technical equipment installed, the possible spatial configurations, the instructions, etc.
Energy, production, consumption, markets, etc.
Activities performed, requirements of these activities, knowledge of these activities
Objectives of the user: economic, qualitative, quantitative, energy, image, etc.
Etc.
On trades/jobs
Health: medical knowledge, medical profiles, procedures, etc.
Agriculture: botanical knowledge, treatment, cares. Etc.
Industry/production/offices: knowledge specific to businesses, customers, products, conditions, activities, regulations, etc.
etc.
On people
Theoretical models, typologies, attitudes, behaviors
Specific knowledge of the persons known or present on the site
Etc.

On the environment
Close and far natural environment, management, rules, objectives, procedures, regulations, etc.
Socio-economic environment: the city, services, connections, needs, etc.
Etc.

The number of knowledge bases is vast.

### Bases of Concepts

Concepts are the theoretical models that decode the information or situations, or conceive/think up actions.

### Examples of Concepts:

Architectural concepts, evaluation of the qualities of a space
Psychological concepts: behavioral logics of profiles
Social Concepts: behavior logics of groups
Economic Concepts: productivity logics, efficiency concept, creativity, etc.
Medical Concepts
Concepts of communication
Etc.

### Bases of Instructions

These instructions are the source to which the system will refer in order to make decisions.

Examples of bases of instruction
Rules for use of technical equipment
Safety Procedures
Validation Procedures
Economic rulings
Procedures for health
Energy Strategies
Spatial and architectural strategies, rules for modification
Image strategies
Social strategies
Maintenance strategies
Etc.

### How its Intelligence Works

### Profiles

The system is equipped with a series of optional intelligent modules that add intelligent functions, knowledge bases, models, know-how, profiles, etc.

These generic profiles are a starting point for the analysis, but it is useful to refine them and gather the most accurate knowledge of every individual, every situation, every project, etc.

Let us take the example of the construction of the profile of a person (we could also have taken any other subject of study such as a situation, a plant, a technical phenomenon, etc., which may have involved other criteria and observations). (See e.g., FIG. D, FIG. E)

### Data

Whether at work, at home, or elsewhere, one often spends very long hours in a single building or space. The system therefore has unparalleled observation opportunities.

The system will work on building a very deep knowledge of each person, situation, activity, etc. It starts with the knowledge of people.

Here are some examples (this example is on a person, but it may be applied to activities, situations, etc.):

Let us imagine that a place like in FIG. C, equipped with the necessary intelligence, is equipped with:

General sensors: visual sensors, motion sensors, heat, sound sensors, etc.
Local sensors: furniture (e.g. chairs sensor, table, glass sensors, etc.), devices (screens, domestic appliances, etc.), etc.
Personal sensors (sensors worn by the person)
As the system analyses the images, sounds, movements, etc. the system will be able, depending on the equipment available:
to recognize each person
to recognize a person already in the knowledge base and refine its knowledge of him (e.g., FIG. D)
His physical description
Size, build, face, hand, iris, prints, etc.
Learn to identify him in different situations
How is he dressed?
Recognize his various clothing styles
How does it behave?
Learn to describe/characterize his gestures, movements, rhythms, attitudes, looks, etc.
Characterize his approaches to various situations
etc.
What is his physical posture?
Know his various favorite postures
What is his social attitude?
Is he solitary, gregarious, etc.
Characterize his social interactions

### Frequency of Contact

Type of contacts and types of interactions (professional, friendly, etc.)

Number of people (e.g. one to one, groups, etc.) Attitude in contacts (distance, gestures, voice tone)

Discover an unknown person, begin to know him and searching information about him
Is he known to the system?
Is there information to be found about him?
Learning to know him as described here
etc.
Understand what he is doing
   is he eating, sleeping, working?
   Characterize his profile for each of his activities
Listening to him

Knowing the sounds he makes

Listening to his voice
Understanding what he says (perhaps he is talking about the system?)
Relate what he says specific activities and topics?
Characterize his vocabulary in each situation
Characterize the types of conversations
Know and analyze his speech
The tone of his voice, rhythm, loudness
observing him
Appearance of his skin, body temperature, movements, heart rate, etc.

### Knowledge of People and Analysis of Situations

On the basis of this knowledge (observations+number of models or profiles stocked up), the system establishes a personalized profile for each person (e.g., FIG. D), and a profile of each situation or activity (e.g., FIG. E) (people have different attitudes depending on the situation). The combination of attitude and situation is therefore closely observed.

The system may take a known profile as a starting point and customize it gradually until the system has a very precise knowledge of each individual, business, etc. The system may therefore learn, create new profiles, new categories, etc. and develop/improve the profile over time.

The system may also understand situations, behaviors or new people by:
comparing its observations to models or profiles in its database
measuring the differences/gaps or instant changes between the model and its observations
trying to explain these differences.

This will also allow the system to understand and analyze people's reactions to situations, taking for example: a sudden change in attitude, an abnormal posture (e.g., FIG. E), a parameter change, etc. A difference from the profile may suggest that it needs to be refined, or it reveals a malfunctioning, an inconvenience.

This assessment is one of the means to evaluate:
The validity of the models
Situations (e.g. is there a medical emergency or a security problem?)
The results of its settings (e.g., is the spatial configuration proposed it well received? Then try to improve it)

### Other Uses of Profiles and Models

These profiles and models are very interesting since a building, for example, offer an unmatched platform for long-term observation of people, social behaviors, situations, energy technical conditions, etc.

Subject to privacy policies or other limitations, these intellectual constructions, repeated thousands of times in many different places and circumstances, provide a knowledge base that may be shared e.g. between the systems and the editor, the systems themselves, or with the scientific community or other institutions, etc.

In some cases, the raw data may be exchanged to allow for other forms of analysis.

It is also conceivable that these profiles could be used by companies or individuals e.g. to have better knowledge of themselves or their evolution.

In the case of e.g., industrial or intellectual production locations, the development of these models and concepts based on overtime observations may also enable entirely new analysis.

### Maintenance Management.

The system is in some cases able to manage its own maintenance e.g. by detecting problems, directing interventions, ensuring the correct implementation and monitoring results.

### Ethics and Values

### Ethical Code, Rules not to Cross

Because the system collects a lot of data, including data on individuals, the system may be subject to ethical codes, which will be part of the basic program of the system, and which may possibly be customized.

The system may also have qualitative, social or ethical objectives proper to the way in which the system affects the world, situations and people; the messages the system puts across, or the values the system conveys.

### Understand the Meaning and Value of Spaces/Semiotics

It may be an option to analyze the meaning of a space and the values the system puts across e.g., by taking the models or profiles provided by designers as a starting point and comparing them to the observations and reactions of the users (e.g., FIG. I). This would be a first step in developing a proper, verifiable science.

### EXAMPLES

The examples given below are only meant to illustrate the nature and extent of the possibilities of the embodiments described above, and provide examples of how the logic operates.

In the examples below, the system performs the described functions to achieve the desired results as described in each example.

They do not in any way cover all the possible cases. On the contrary, the possibilities are too numerous to describe.

They are only a way of presenting the information. What is described in a particular case can most of the time be applied to any other case.

All of these buildings that were once passive shells are to become active partners or stimulants.

5.1. Simple Technical Management

To explain the logic, let us describe a basic technical element: energy management (we could have chosen lighting, parking management or mobile walls, elevators or any other active system). (e.g., FIG. L, M)

### Example

### Energy Management of a Solar-Powered Building

One could mention the basic case in which a centralized energy management system, capable of regulating e.g. heating and air blowing, lighting, the speed of elevators or the electrical power for large industrial machinery, would be able to communicate with the grid, to temporarily reduce the consumption in response to an indication from the grid that the network load is high (reduce power consumption when the system is already loaded) or vice versa. But to clarify the demonstration of this example, we chose to restrain ourselves to a simple system with a single adjustable function (the airflow, legended Hardware/systems in FIG. L, FIG. M). Other examples described in this document make perfectly clear/foreseeable the endless possibilities of interaction management.

Let us take the case of a building equipped with a solar system that can also recover heat from the cooling panels. We could also play on other parameters such as orientation, shading, reflections, etc., but it is not the purpose of this example.

It has been shown above that one will be able to modify the parameters, either through fixed settings, or dynamically, or in real-time under computer control, to achieve the desired result. It is therefore necessary to describe the principles of the regulatory system.

### Ventilation and Production

To increase the efficiency of photovoltaic panels (which are most effective when they cold, but naturally warm up when turned on) one may wish to ventilate the panels in order to cool them, and extract the heat for reuse, which requires the air used to be as cold as possible. But because the air warms up rapidly as it cools the panels, it gradually loses its cooling qualities, except in cases of particular convection.

This heat may be used e.g., to participate in the heating or cooling of a building.

It derives that one has to arbitrarily choose between electrical performance and thermal performance, since their logic/principles largely diverge, and technical considerations also have to be taken into account.

One could also have described how to improve the ventilation of the panels through their underside, especially by seeking to increase all contact and convection coefficients by changing the materials, height or shape of the sheath etc.

The system performs the described functions to achieve the desired results as described in the example.

If We want to Enhance the Electrical Performance

To cool the solar panels, in our example:
One may then wish to reduce the length of the air duct, or, if one does not intend to reuse the air, the air can be removed before it has circulated along the panels for too long (before it is too hot), either by having short ducts or air circuits, or by pumping cold air in more often.
One may also change the amount of cold air pumped in by increasing either the volume or the velocity.
One may obviously control the flow by mechanizing the air blowing and extraction.
etc.

One may also reflect in real-time on the relevance of the air blowing by comparing the energy consumption of the air blowing to the gain in electrical production of the cooling process e.g. by comparing costs/instant value each energy, and making the appropriate adjustments.

The system performs the described functions to achieve the desired results as described in the example.

If We want to Enhance the Thermal Performance

In this case, one will attempt to raise the air temperature, e.g. by:
Making it circulate in contact with the hot surface on the longest possible distance (i.e. having long ducts)
By making its circulation very slow and calculating accurately the convections
Possibly, by modifying the materials and internal aerodynamics of the sheath.
etc.

The system performs the described functions to achieve the desired results as described in the example.

### Regulation

One may then program a computer system that will modify some or all of the above parameters in real time. (e.g., FIG. K)

One may also wish to arbitrate/decide between several interests:
more heat
more electricity
more profitability
   other parameters.

The regulating tools of the system are:
technical assets (in this context, the wind, possibly valves or shutters)
technical elements that can be activated (e.g. a valve to be shut manually)
calculation means
means for measurement and control (sensors)
Information
mathematical models

The system will therefore regulate itself in real time, according to its objectives, the conditions and circumstances encountered, and technical possibilities.

### Information

A number of parameters need to be taken into account and managed in real-time by the system.

The information given by the sensors (legended sensors in e.g., FIGS. L, M, N, O & J), such as:
the outside temperature (legended “environment in e.g., FIGS. L, M, N, O),
the wind
sunshine,
etc.

External information (e.g., FIG. J) received by the system (legended “world” in e.g., FIGS. L, M, N, O), such as:
e.g. the cost of energy depending on the time [time of use]
the network load
weather forecast
etc.
Data provided by the user or extracted from operational records, such as:
the electricity, heat and cold requirements of the site

to ensure the technical functioning of the building

to satisfy the needs of users (e.g. industrial activity)

### Calculation and Models

The system may calculate by:
using a computer modeling of a phenomena (common core and building models in e.g., FIG. J, energy model e.g., in FIGS. L, M, N, O)
comparing the results obtained with the expected ones
correcting the settings, or even correcting its models (learning function)

### Action

After having calculated the possible optimizations, the system may propose or decide automatically:
to modify some parameters using active elements (legended “active devices” in e.g., FIGS. L, M, N, O) (e.g. in this case, active shutters, ventilation systems or orientation of the panels, etc.) (e.g., FIG. J)
to request manual interventions (including robotized one)

### Example of a Case of Application

Let us start off with the simple example of a building that uses both heat and electricity but that cannot regulate the speed of the airflow (it is nevertheless understood that, given the multiple parameters considered, the applications can become extremely complex, which makes the real time management system described here more appealing).

### E.g. in the Winter

Let us consider a sunny winter's day. The system considers the following:

### Information

The system considers external information (e.g., FIG. J):
Electricity in winter is cheap in the morning, but gets more expensive during the day,
heating fuel has become expensive.
User data:
The industrial building consumes a lot of energy when operating
Employees are more efficient when they are warm: the demand is thus to ensure a good temperature.

### Models

The system performs/uses mathematical models: (e.g., FIGS. J, L, M, N, O)
all equipment and systems used are modeled
all weather parameters are modeled
the theoretical results of each material and climatic configurations are prepared in the model.
scenarios (cases of use) are prepared in advance to help the regulator in his decisions, and they are regularly revised on the basis of the results/conclusions of the system in real conditions (learning)

### Strategy

The system (e.g., FIGS. L, M, N, O), having tested several scenarios in the energy model on the basis of the available data, can then assess the advantages, assess the flaws and make a decision, or propose for example the strategy described below in the “successive actions” section, and have it carried out by the “active devices”.

### Successive Actions

Use warm air to heat the building before the employees get there.

Circulate the air slowly over long distances to heat it as much as possible

The first few hours of sunshine will be dedicated to circulating the air very slowly in order to heat it and possibly reuse it in the building, e.g. for heating or cooling (even if it means temporarily foregoing the optimization of electrical performance)

It is understood that, had there been other variables, objectives or pilotable devices such as mobile parts or other systems, they would have been integrated into the regulation process in the same way.

One hour after the employees' arrival, the sensors (e.g., FIGS. L, M, N, J) indicate the building has reached its ideal temperature and it now consumes a lot of electricity for machines: it will then be regulated (e.g., FIGS. L, M) so as to produce less heat and more power (thus ensuring that the air is cooler).

For the sake of the example, let us suppose that, during the day, for any reason (lunch, delivery, site visit, etc.), the domestic activity decreases (thus the need for power), or the power is more expensive [power rate/time of use]: the settings will then be changed to favor the production of electricity sold to the outside.

At some point, however, the system calculates, using external information (e.g., FIG. J) and model (legended “world” in e.g., FIGS. L, M, N, O) that the additional energy cost (e.g., FIGS. L, M, N, O “assess costs”) needed to increase the ventilation of the ducts (which depends on many factors, including temperature and humidity of the inlet air, the effectiveness of fans, the cleanness of ducts, the cost of instant energy, etc.) is not offset by the value of the additional electricity (see “assess advantages” e.g., in FIGS. L, M, N, O) that is produced (it is winter, and KWh is not worth much in this region) (legended “external information” in e.g., FIG. J). Rather the opposite; the system calculates that producing heat would be more profitable because fuel is very expensive on this particular year (or because the temperature suddenly drops, which also means there is less need to cool the panels): the system will therefore choose a setting more favorable to heat.

Yet at 3 pm, when work restarts, there is a power outage in the entire region: since losing 2 hours of work for lack of electricity would cost a fortune, it is decided to focus on power to 100% (besides, the building is warm).

### E.g. in the Summer

### Information

External data:
Due to the outdoor temperature, no heating required
Electricity is very expensive (Peak hour+high season) and the network is demanding extra power.
In peak hour, the network asks of all its consumers to reduce their demand (NB: this is not part of the example, but in such cases, the system may also reduce the consumption of the building by changing the parameters, reprogramming actions, etc. and interact with its users to further reduce)
User data (e.g., FIG. J):
30% of employees are on leave (which reduces consumption) (e.g., FIGS. L, M, N, O)

### Model

The models are similar to what has been discussed above, except it si for summer conditions.

It should however be noted that the system can in some cases measure its performance in real time and learn (e.g., FIGS. L, M, N, O) how to improve its models and calibrate its actions.

### Strategy

The system will, for example, calculate that it is more profitable at this time to produce the greatest possible amount of power, in order either to sell at a high price to the network which is very demanding in this period, or to use it internally.
However, it may need to cool down: Does its air conditioning require much power, or will it reuse the heat to make it cold air? In one of these cases, it will need electricity; in the other it will need heat . . . .
Etc, etc, etc.

### Action

The system will calculate the speed at which the air should blow in order to optimize economic performance (in this example, this is the only configurable element, but it is understood that more complex cases may be developed)
The system will order the active devices to carry it out and verify the implementation using the sensors (e.g., FIGS. L, M, N, O)

### Real-Time Management

### Principle

The idea is to have a system that:
Regulates in real time all the adjustable parameters of this particular installation in keeping with specific objectives configurable also
Provides continuous monitoring and easy control (the terms may be different on another site, but the logic is similar).

The unit is managed by a mathematical matrix with multiple inputs and outputs.

The user can select the parameters to be included in the calculation (virtually any parameter and local or remote data, of real or virtual origin, can be used. Example: electricity prices in real time, specific needs of a building or of users, local or architectural parameters, Internet data, specific commands entered manually, etc.) and any variable or adjustable element can be controlled.

If the solar system or the building has movable parts, interactive parts or other configurable systems, they and their effects are to be taken into account by the centralized management system since every element may impact others.

### Local Interactions

This regulation system is not always be independent. In some cases, it may work hand in hand with the centralized management computer system of the building. For example:
is the building occupied, what is the level of activity and expected consumption?
specific needs of users, etc.
Does it require heat, power, shade, etc.?
Is the need in heat more important than the need of energy?
etc, etc, etc.

The solar system and the global control system of the building can therefore work in permanent coordination. The solar system plays an active part in the management of the building.

We have deliberately chosen to restrain this example to a simple management form of the energy production system. Yet, by reading the other cases given as examples, it is understood that the interactions with the host building could have been mentioned e.g. when the global management system will recommend specific settings for the building itself (e.g., in this case, to reduce its energy consumption, influence the behavior of users, interact directly with them, etc.).

Remote interactions (e.g., FIG. H)

The system may also exchange data with other local or remote systems and interact with them one-way or reciprocally (with or without local or remote action).

### EXAMPLES

Dialogue with the grid, with the weather, with the centralized management system of the building, with traffic information or information derived from the users, their behavior or their needs, etc.
The automated system may have to choose between answering a request from the outside or prioritizing the strict requirements of the supporting building. One imagines that the grid may need power, or that a user may need heat, or that any other reason would lead to modifying some settings, or the moving parts of the building, etc.
Etc.

The building becomes an intelligent partner of a vast system of collective intelligence.

### Other Applications

To present simply the basic principles, we have offered here an example of solar energy management in a defined context/frame.

Nevertheless, what has been described applies to any basic technical system that takes into account elementary interactions.

It is important to understand that a similar logic may be applied to virtually all the technical systems of a building: all energy, lighting and air-conditioning systems, but also any system concerned with adjustments or management.

The simple interactions described here correspond to what we above called level 1. Management becomes more complex later when other variables and interactions are introduced, which make the transition to the following levels: 1, 2, 3, etc.

By extension, this description covers all systems, solar or not, that include piloting part of a building or a structure in accordance to local or external parameters. Examples include future interactive architectures in which the building, the spaces or some structures will change in real time to interact with the environment, near or far, real or virtual.

Health with Monitoring, Guidance, Path

### Application Case

Let us now take an example from everyday life: health (we could have made a similar case for security, education, or countless other cases of application, but there is limited space here). The basic software is designed to be equipped with specialized modules (e.g., FIG. J) (e.g. home, hospital, school, business, etc.), regularly updated if desired, which will facilitate the declination of a multitude of individual cases.

We will describe here a retirement home, but it is understood that the solution is perfectly applicable to an individual residence (which can ensure the good health of its inhabitants, facilitate the creation of suitable living conditions, call for help if needed and facilitate their intervention, etc.) or a hospital (a hospital is ultimately a similar case though more complex, but it brings in the notion of professional/industrial process because of technical platforms). This example aims only at putting across the scope of the embodiments described above.

One might be afraid of the science fiction nightmare scenario where the house becomes evil. Yet the chances are higher of a human person acting in this environment becoming evil than a house (a software is not evil!). In addition, the models used and all the configurations described herein are available for consultation in case of problems, possibly remotely, and many safeguards are implemented at all levels.

Assume, the residence XX has 100 old patients, some of whom are suffering from various diseases. The house knows each of the inhabitants, both because it has learned to know them individually through observation, and because the managers have provided data, and also because it has access to medical records and knows how to read them.

### Customization and Control

How does this detailed knowledge of people and their preferences work practically?

As we have seen, the system initially comes with its own knowledge and concepts. It knows “model” situations, personalities, issues and topics, etc.

This knowledge and concepts base is improved (through optional updates) with new research and experiment feedback: the system is used in many establishments, and it derives learning from experience (see “feedback” in e.g., FIG. S), which the system can then use to modify its models and enrich its knowledge base, and then share with other institutions/establishments (e.g., FIG. S).

Each institution, each system generates its own knowledge and learning, and may share it.

The “system manager” (legended “user” in e.g., FIGS. L, M, N, O) provides the system with information (user data in FIG. J) in keeping with formalized procedures.

For example, in this case, he may enter data relating to who has joined the establishment, possibly on their tastes, preferences or known issues, on their diseases, medical cases, their relatives, or a specific strategy to apply on a specific person.

On a general level, he may provide information on the technical or human means of the establishment

He may also impress onto the system his own e.g. strategy (owner's strategy e.g., FIG. J), values, know-how or medical choices. Each facility may therefore offer a truly unique service or lifestyle: a single calculation engine works with different parameters for each case. These custom settings may of course be modified at any time. They can also be programmed to change over time.

Establishments are different in their physical arrangements, their human resources and their active elements. The configurations obtained are thus often different.

The person himself will be largely able to organize and configure his own world:

They will be able to formally give their choices, opinions, to react, etc. on every adjustable factor: quality of the space, services, schedules, etc.

The system will then calculate and submit proposals to be tested in the frame of technical, financial, organizational restrictions etc. (e.g., FIGS. L, M, N, O)

They will also be able to operate the system in a much more subtle way: the system is able to read the reactions of people (e.g., FIGS. C, I) (or if the system does not do it well at first, it will learn overtime) and analyze their reactions to the environments proposed/put forward. These reactions may be voluntary (then establishes a dialogue between man and machine, possibly via a play of facial expressions or gestures). The reactions may be more intuitive: the system tries various environments or services (or any other parameter) (e.g., FIG. I) and analyses the person's reactions (e.g., FIGS. C, I) (including by studying a series of meaningful differences (e.g., FIG. E) on qualitative criteria identified by the sensors). Possibly by testing through successive iterations, it manages to figure out what is best fitted to specific circumstances. The system will then try to understand why these reactions came about, and how to learn from them before the next case arises. The system will particularly have to work on the perception of space and its meaning (e.g., FIG. I) (to be compared with the proposed configuration), interpersonal relationships, activities, etc., in short, the whole context which may participate in triggering an attitude or a mood).

The person can always regain control. (e.g., FIG. P)

This will allow everyone to develop a personalized world, including in very specialized areas e.g. specific qualities of spaces, some relationships, some sequences of tasks, some foods, activities, etc.

The level of customization available will depend on the establishment, and on the means used to implement the system. It may be a criterion of differentiation, like the particular service strategy or the quality choices imposed by the system manager are.

This customization is the opposite of what is usually found:

At the moment, an establishment, however effective, is struggling to customize its personal service simultaneously for many clients. The levels of customization are very limited in the prior art. In the prior art, it is not impossible to adjust the qualities of space as described above.

Nevertheless, space is imposing; it communicates values and emotions (e.g., FIG. I), regardless of what the space is and the quality of its content. It is a very powerful media that heavily weights on the minds of people. Currently, it is passively endured and sometimes in a negative way (how common is great architecture?).

How many of us had a chance to choose the volumes and atmospheres of our hospital room, nursing home or office?

Do these atmospheres change and evolve with time, weather or activities?

The ability to customize is a very big step. The ability to voluntarily control our universe is too. However, in many cases, it will appear that the system's “autopilot” gets better results than manual control, which is too coarse.

In addition, the system will be able to stimulate or even provoke. It may deliberately step away from well-established parameters (at times) in order to stimulate people's thoughts and offer them new worlds/possibilities. This may, for example, be part of an anti-aging strategy or a strategy for business productivity.

### Monitoring and Service

It is just as good if not better to have 24/24 observations by a host of sensors (e.g., FIG. C) managed by an intelligent system capable of analyzing and recording a huge continuous stream of data, and knowing how to refer to a human expect when necessary, than to have a doctor dedicated to each person day and night. This is a huge progress in all service-related areas.

An intelligent system that can analyze flows of medical records stored in the knowledge bases (e.g., FIG. J) and extract the relevant information to submit it to the doctor, which can even think up hypotheses, diagnosis or scenarios, which knows how to weight the information against a huge database of comparable cases, and which can guarantee the proper implementation of requirements/prescriptions, and can watch over the patient's health, is a huge medical advance. This type of building is what enables it.

The IB also benefits from the learning and experience it has acquired over 10 years of operation and stored in the knowledge bases (e.g., FIG. I), as well as from the feedback from other homes that share the same system. Their essential/central software is regularly updated.

### Examples of Functional Aspects

The intelligent house (IB) knows that Mrs. X needs to take specific pills at specific times.
The house will therefore see to it that the pill is delivered (and hence ordered, controlled, and delivered) and taken by the patient (sensors control), and will control its medical effects. Otherwise, it will call for help.
In addition, the analysis of some physical or mental reactions allows the house to develop some hypotheses and submit them to the medical profession. If it appears, for example (thanks to constant monitoring and analysis of the data) that the combination of some drugs with some foods and some lifestyles or settings have a particular impact on their health, one may try to remedy it or take advantage of it by carrying out calibrated experiments and analyzing their results.
The house will independently manage the ideal conditions for each patient (e.g., FIG. E) AND each member of staff and try to reconcile the different needs of 100 residents and arbitrate in real time depending on the events. (e.g., FIG. I)
If robots are involved (visiting robots or domestic robots), the house, thanks to its communicating structures (e.g., FIG. H) and its sensors, will ensure that everything goes smoothly and that the mood remains positive.
The house learns that Mrs. X expects a visit from her children:
The house will rearrange her schedule and modify the setup of her room e.g. because her son is sensitive to light and enjoys large sofas. It makes sure to order adapted meals and to free up a parking space with sufficient energy to recharge her electric car, etc.
If an accident occurs, the house senses e.g. a person falling registers her cries or studies her heart rate:
The calls for help, makes sure that the nurse is there, turns on the lights, turns off the television, prepares the equipment, prepares the medical file and offers a pre-diagnosis; may open the front gate and light the way for ambulance, free a parking space, open corridors, preheat the operating room, prepare elevators, etc.

### Examples of Qualitative Aspects

### Customized Control

The intelligent house (IB), after having observed, learned (e.g., FIG. C) and received information (e.g., FIG. J), has good profiles and knows that Mrs. X requires a particular temperature, specific exercises; it knows that a view on the outside lifts up her spirits but that rain depresses her, that she loves pink in the morning and a very white light around noon, that she likes this or that quality of space or social life, that she is not happy when the light is too dim and the room too silent, that she such and such treatment, that going out for lunch in public at noon lifts up her spirits, that she needs to take long naps in the darkness and silence, or surrounded by a scent of lilacs, that she does not sleep well after watching a certain type of television shows, or eating certain types of food, etc. . . . .
The i intelligent house will thus create all these conditions (e.g., FIG. I) within the volume of her private room. It will regulate temperature, humidity, smells, etc., lights, the color of the walls and views to the outside, propose TV programs, etc. Mrs. X can always regain control of the machine and impose her own choice in keeping with certain rules.

More subtly, the intelligent house has understood or learned Mrs. X's perception of space: she loves large volumes bathed in sunlight, but she fears the heat and overly bright light. She loves to feel part of a whole that lives in harmony with nature. She grows more worried at night.
The intelligent house will be able to work on spatial configurations. For example:

it will be able to open views of the garden, but never unlimited views: it will generate closed gardens patios for Mrs. X. (e.g., FIG. I)

If the premises have rotating roofs (e.g., FIG. I)? The intelligent house will move the roof to offer high volumes, oriented so as to invite the morning sun in winter, and keep the roof morning so as to follow the course of the sun throughout the day, which make one feel connected with the course of the planets. In the summer, the orientation will be reversed, so as to always be facing opposite the sun, block direct sunlight and bring in indirect light.

Finally, at night, a low ceiling will unfold and provide a protective sensation of comfort.

### Ability to Learn and Make Proposals

The intelligent house has understood that Mrs. X is sensitive to such and such moral values. She resembles a type of personality previously identified by the model, and she has shown to be responsive to a particular environment.
In case of an event, a relevant outside information, or a simple reaction to a specific mood or to the weather, the intelligent house will know how to offer surprising and original spatial solutions, create surprises, or propose new pictures on the walls, new video programs, new connections, new activities, or different interactions. (e.g., FIG. I)
The intelligent house will have an accurate enough knowledge of the qualities of space, experience, relationships or services it can achieve/provide, to enable it to make “projects” and suggest styles (what we above called IB themes), to configure custom-made experiences for Mrs. X.
The intelligent house will test its proposals, analyze the reactions or feelings of Mrs. X, and refine its analysis and proposals. It may also refer to/interact with humans and other similar systems. (e.g., FIGS. M, N, O)
It should be noted that cultural models carefully prepared by offsite specialists are often superior to what local actors can improvise (often they are non-professionals of the field, e.g. a nurse is not a specialist in semiotics of space). A limit should be set to manual local interventions.
   Management with Multiple Topics (e.g., FIG. O)

The intelligent house knows that Mrs. X enjoys the company of Ms. Y and Z in the morning, and card games in the evening.
By organizing her travels/movements (amending corridors plans by controlling the doors and walls, the illuminated signs, the visual incentives, etc.), coordinating the schedules of medical appointments or other obligations of everyone, the intelligent house will make it easy for her to meet her friends. The intelligent house will free up meeting places and create conditions that make the three of them happy (which implies that the spatial preferences of each have been reconciled or managed at the best).
Profiles (e.g., FIG. E) built through experience (observation history (e.g., FIG. C) and overlaps with the conditions created or encountered at each time) shows that the three friends blossom when they have tea at a specific time, at a specific temperature, while staying warm but overlooking a garden. (e.g., FIG. I)
The intelligent house will therefore remind the nurse (or a robot) to prepare and bring tea. And prepare places the way they like them.
The intelligent house will either choose a room overlooking the garden or rearrange the area by opening walls or views, by shifting furniture or organizing gardens (e.g., FIG. I) according to the season. It has active elements necessary information on the climate, season and plants, she knows the tastes of people, allergies, etc., And is able to pass commands necessary to initiate maintenance if necessary, etc. (e.g., FIG. H)

If these three people stop being friends, the intelligent house will take it into account and propose other scenarios, other encounters, other activities to each of them. (e.g., FIG. I)

### Transport Pole

### Application Cases

Let us take the example of an urban interaction.

Once again, this example only aims at illustrating an infinite range of possibilities, and countless other cases or models could be described here.

Imagine a bus stop, a train platform, a tram or taxi stop station, or any public or private space.

Imagine that this platform is technically equipped with a series of active elements: lighting, sound, possibly heating, convertible walls, mobile barriers, possibly (e.g., FIG. G) convertible floors, configurable accesses, possibly parking lots, etc. possibly energy production systems, such as solar, wind or through the recovery of the energy of the passages. Possibly also major architectural elements: imagine that is equipped with a flexible mobile coverage, e.g. deployable wings of stretched canvas on an articulated and active metal structure.

The platform is equipped with all kinds of sensors (e.g., FIG. F), it is connected (thanks to its universal protocol of communication) to all the systems of the city and to those of the transport company, it knows the social events of the city, knows climate, times and schedules, people's habits, any changes, etc. It may also be connected to the Internet and have access to a lot of information on the people who walk by, for example via social networks.

It also benefits from the experience gained from 10 years of operation stored in knowledge bases (e.g., FIG. J) as well as all the feedback from other transport hubs that have the same system (e.g., FIG. S). Their central software is regularly updated.

It has a universal module of communication that allows it to interact with most internal and external systems as well as most robots.

### Examples of Basic Functions

The station is of course connected to every transport system in the city. It knows the times and exact locations of trains, but of also buses, taxis and private cars that go there. The system can therefore manage itself and manage its environment. (e.g., FIG. H)

For example, the system may, for the arrival of the train, shut its gates, protect its platforms, light and heat them, emit signals, guide the visually impaired, etc. The system may also actively manage the seating arrangements: do we need more seats or more walking areas? These elements can be active and configured. (e.g., FIG. O)

The system may also perhaps (since it knows train schedules but also their actual attendance (or who are the passengers) and real time road traffic) expand or reduce its perimeter, move its walls, enlarge or reduce the neighboring roads or walkways, prepare specialized receptions, etc.

Perhaps the system also has energy production means, for example to power itself, to supply the railway, the town or equipment. Examples of energy logics have already been described and may here affect its configurations.

Is it necessary to manage flows, change the routes or the circulations, the connections, accesses, etc.?

Should the operations of cleaning or maintenance also be regulated?

Examples of Interactions with the Outside

The system can also manage the area:
dialogue with the Urban Management (e.g., FIG. H)
activate crosswalks
change the traffic lights to red,
open cycling tracks,
etc.

Perhaps The system can also:
Check that the connections are made, i.e. that the buses or taxis connections happen on time, or otherwise manipulate the program traffic lights to enable them to arrive on time, or delay the train.
bring the necessary services to the passengers expected

### Example of Vigilance

The system can detect security problems (detect abnormal behavior) (e.g., FIG. C)
can the emergencies
possibly e.g. change the management of traffic lights or train passages, or take direct preventive measures. (e.g., FIG. H)
The system may also suspect a potential problem is a child or a teenage girl being followed, by whom? Since when? To where?
communicate the information to other services of the city that will then be on their guard or take action (e.g. a suspicious behavior, but not proven).
The system can do the same for health problems. For example,
detect someone falling or fainting (e.g., FIG. C)
call for help
possibly identify the person, access its medical records and inform caregivers, make a pre-diagnosis,
create a safe space around the person, (e.g., FIG. I)
modify the climatic conditions (heat the floor/ground, close the doors, protect from the rain), etc.

Examples of social role:

The system may also know its users.

The system may be able to recognize people through specific characteristics (learning, it know their habits) (e.g., FIG. D) or through identification (e.g. through their transport tickets, their badge, their mobile phone or other) (e.g., FIG. H)

The system may also be connected to their social media, (e.g., FIG. H)

The people may also have chosen to travel anonymously and this will be protected.

They may be welcomed individually (it may greet them or align itself with their preferences) or by providing the specific s

The system may also seek, by analyzing their behavior and reactions (e.g., FIG. E), and correlating this data to the circumstances of the day (e.g., FIG. H), to make their journey more pleasant or efficient:

How many newspapers, coffee, flowers do they require?

Is the number of rental cars or bikes or taxis available sufficient?

Should the connecting bus or train be made to wait?

Should the electric car in the parking lot be pre-loaded?

Should it inform the school if children have missed their train?

Should it call a porter to help the elderly person that is expected to arrive by the next train?

Should we inform a person waiting for their son that he is on the next train? etc.

### Examples of Active Architecture

Now let us use the active elements. Depending on the architectural settings, there may be an infinite number of different cases. Active parts can be of any kind, floors, walls, roofs, sounds, lights, radiation, etc.

Let us imagine there are deployable wings. Let us imagine that these wings can unfold and take a wide range of positions and movements with well studied forms.

Let us imagine the following scenarios:
The wings will be able to deploy as a roof to protect the platform from rain, or to run water to a specific place (making a nice fountain sound. Pouring on someone. Protecting some places and not others).
The wings will open in the morning to welcome the first rays of the spring sun, shut in the afternoon to shelter from the summer sun at 2 PM, then open again in the evening. As such, they both fulfill a utilitarian function and stand out as a sculpture celebrating the passing of time.
Maybe did the system understand (e.g., FIG. C) that Mr. X is sitting on the bench to avoid the sun while Miss Y is again enjoying it. Maybe, depending on the position of the sun or the energy index is it possible to imagine a configuration that satisfies both. The software's aesthetic/architectural settings may allow this configuration, which can be coupled with an arrangement of floors, walls, lighting, access, etc.

Perhaps, at specific times and under certain circumstances, the wings may rise into a specific configuration/shape, and become an architectural signpost

Perhaps the wings are lit at night. Perhaps they strike on the hour. Perhaps the canvas or its lights pound with the minutes, the rising excitation or the newcomers in town.

Perhaps the wings spectacularly unfold to celebrate Christmas or a team winning the Superbowl.

Perhaps the wings freeze in a particular pose when a 10 pm, during Lent, all the active sculptures in town come alive like a synchronized wave moving over each large avenue.

Perhaps this has been previously agreed with the city counsel and other buildings that also use the invention. (e.g., FIG. H)

The streets light up like a single wave

All the buildings bow down in turns

The fountains light up

The advertisements, and all active and interactive decorations

Etc

Perhaps they bow down at the passage of the parading bus bringing the Olympic champions home

Perhaps the wings salute when the senator passes by.

And as two lovers meet in a tender embrace, does the building not give them its blessing with a friendly wave. Does it not wrap its wings around them.

If it is Mrs. Z birthday, be it her 8th or 100th, it joins the celebrate as they pass by.

### Productivity, Factory, Offices

The invention also has significant implications in the professional field. The building or the neighborhood or the city will become key players in the performance, productivity or creativity of a company or any form of activity.

All these buildings, which have always been always passive shells, will become partners, robots or stimulants.

Consider a company that has to build new premises. If this is a production facility, we may usefully refer to the example of greenhouses which describes the use of the interactive tool in a production activity. If it is offices, or campus, the company may wonder: should it

build rigid structures, which means dead-still and passive, and try to upgrade them with some simple automation equipment,

or increase its adaptability and its employees' flourishment and productivity through creating an entirely interactive tool of an entirely new kind (e.g., FIG. I)

### Factory, Warehouse, Etc.

### Factory

Plants are now equipped with many robots. Let us imagine now that the building that houses them is itself a gigantic robot, equipped with a memory and a massive computing power, that it can not only vary its spaces and indoor conditions based on needs, and adapt to external conditions or events, but thanks to all the sensors, it can take at the same time many management tasks (e.g. counting, analysis, audits) or production while fighting against accidents, health risks, defects, etc. while producing its own energy, recycling waste, managing flows, including delivery/production flows and work force flows

### Offices

### Creative Machine

An office is a place where intellectual work is produced, usually in collaboration with others.

Companies have forever been looking for ways to make their premises more prone to focus and efficiency, comfort, well being and safety; a place of interaction between people, etc. They invest into tools to assist their workers (computers, software, various tools), and activities with the purpose of e.g. enhancing motivation or solidarity.

But they will now be able to leverage the productivity of these workers as well as their pleasure, their well-being and the company's opportunities, transforming the dead-still body they used to shelter in, into an active and stimulating partner. This may represent an investment, but still very inferior to what a significant increase in productivity will bring.

In addition, activities and jobs are changing while the modern economy requires a high reaction speed and constant changes, repositioning, restructuring, work in multiple successive, informal or variable geometry groups, etc. The computer has multiplied the productivity of everyone, the jobs have been individualized and specialized while becoming ephemeral and performed within changing organizations. Now one must at the same time be aware of everything, be mobile and anchored, flexible and uncompromising, welded to the group and connected to the world, all in the same buildings.

The building, now supercomputer and active collaborator, will help set the conditions of space, the feelings of everyone, empower organizations and trigger sensations, mixing and ideas.

### Active Devices

Consider that now, almost every component of an office building is customizable, editable or active. and with sensors. (e.g., FIG. I)

Of course this is true of all furniture, equipment and machinery or consumables, etc.

This is also true of technical equipment traditionally active or adjustable, like all electrical systems, air conditioning systems, lighting, transportation, etc.

This is also true of most plants, soil, outdoor spaces, etc.

Let us imagine also that this is true of individuals, which can be equipped with sensors. And let us add all kinds of robots, which will play a significant role, especially when they are coordinated with the buildings as we propose here.

### Active Campus

According to certain embodiments, the process of design is completely changed: instead of designing walls and fixed volumes, the designer can use the system to conceive an evolving system (the tools, means, methods and rules of this evolution), the intellectual and technical framework of this evolution, and the range of spatial qualities provided by this new found freedom.

Because the volumes themselves vary, the outdoor areas may be found indoors and vice versa; new elements can be created when needed (for example, through the revolution of 3D printers, which will allow the manufacture of custom-made walls, furniture or else), and the light sources, supporting points, and entrances are modifiable, architecture becomes a wholly different job. In many respects, this job is described here: the campus becomes a data system (e.g., FIG. Q), the physical output and the software are inextricably linked, and the fundamental work of the designer now resides in conceiving logical rules, logical sequences (e.g., FIG. B) and predict the qualities of spaces to be designed (no one knows what will come out of the countless possible configurations) (e.g., FIG. I)

Among all the examples described here, the campus is perhaps the one that best illustrates this evolution.

Indeed, it is easy to design simple systems such as the one described in Example 1, and to apply these principles to any known element such as lighting and heating; even to think up multiple levels of interaction with the environment. And it is relatively easy to add services or interactions to it such as those described in other examples.

Finally, this is about disrupting the conventional conception of buildings (or campus, site, or even city).

Let us consider it. Since almost everything is modifiable, one may wonder what remains constant, what must remain a fundamental frame (e.g., FIG. Q, FIG. B): the fire safety (for example) must fit in with each new configuration and be validated (online would be great) by the authorities. The software is thus the founding structure of the campus since it determines the spaces. The architect and the design team should therefore focus on the software first. The architect's aim will no longer be to produce a practical solution, but to generate sequences of compositions according to formal or informal rules, like in a jazz improvisation. (e.g., FIG. A)

Let us consider a simple example: suppose that, in order to meet changing business needs, the entire campus is transformable (e.g., FIG. Q). (In some cases, only certain parts are fully convertible. For others, we will only set certain parameters). Instead of having a campus made of a collection of frozen buildings surrounded by frozen gardens or frozen parking, let us imagine that the gardens can turn into offices, and built in volumes can turn into outdoor spaces, and therefore that inbuilt volumes can become built and vice versa. Instead of having frozen built volumes in the middle of a vacuum, we now have a three dimensional matrix in which each cubic foot can be alternately filled and empty, allowing almost any organization, any space quality, any light, any view, etc. The main asset is no longer the “filled up volume”, but rather the unfilled volume, or rather the 3D frame (e.g., FIG. B). This matrix, modeled by the designer with a never before known freedom, may also include non-convertible parts: for some projects he may need fixed parts, transformable technical elements or reference points, fixed points, absolute values which men can rely on.

Technically, this is quite simple to achieve: the campus finally turns into a giant Lego game. One can:
set a 3D frame (e.g., FIG. B), which finally is used as a framework for designing the 3D volumes. This frame is the base structure of the project, as is the structure of the software.
standardize as many components as possible to make them interchangeable: almost every component becomes a basic “brick”, then these bricks may be assembled to create sophisticated ensembles.
design them technically for facilitate the assembly, the connections, etc., and robotized assembly/disassembly (each wall, window, beam, etc., and is re-imagined and built as a modular element that is removable, reusable or replaceable).

Let us not forget that each constructive element is now active or capable of being activated and filled with sensors. (e.g., FIG. F)

Let us add that this system is very environmentally friendly: instead of demolishing the building every 30 years and throw all the components, we now have a set of modules (possibly packed with technologies, sensors, active components, etc.), constantly renewed and updated, easy to disassemble and recycle. One does not throw almost anything anymore. The fact that the components are replaceable also ensures that the building remains at the forefront of technology.

### Let Us Take a Simple Example

### Scenario

Let us imagine that in a situation A, the campus buildings are arranged in a regular (or not) pattern of built and inbuilt volumes, that is to say buildings and gardens, for example. Suppose the occupant company launches a project that requires larger spaces or to have building 1 and building 2 work together, although they are currently separated by a garden. Thanks to a set of standardized components, perhaps stored on site, such as bridges, roofs, exterior walls of modular size, etc, and of active components the company can suddenly decide to create a link between the two buildings, or transform the inbuilt volume between the two buildings (gardens) into office space, meeting rooms, etc., or to do a partial junction only on the second floor, etc. The building managing intelligent software, or the teams, can then design the new arrangement in accordance with a series of quality and design rules. It can also find out that doing so, it might deprive of light the interiors of both buildings (since new full volumes now replace the previous voids where the light came from). It may therefore decide or propose to create a new void or a skylight or a new garden where some offices previously were, and are now useless after the reorganization. We are now in situation B. (e.g., FIG. I).

It may also propose to reorganize the teams or propose new spatial stimuli.

Note that the redevelopment could also have been motivated by the arrival of a new technology or new needs, a regulatory change, the acquisition of another company, the detection of a feeling of fatigue or personal anything else.

### Process

The system will create spaces with a series of space, technical and organizational qualities, applying what he was taught and what he learned himself (or what he has exchanged with other similar sites). The system will have technical changes made either by human crews or by robotic teams. The system will then analyze what was actually performed and analyze the reactions and attitudes of people (e.g., FIG. E) and things to see if its psychological hypotheses are confirmed: The system can then learn and improve its mathematical models.

So we come to a situation B, may be totally unexpected: (e.g., FIG. B)

The intelligent software generated space itself, because he understood the need. If the physical frame+software frame was well designed, it should even generate a succession of spaces endowed with fascinating and calibrated space qualities: a succession of high quality positive emotions.

Then the system evaluates its own production (e.g., FIG. E) and corrects it if necessary (e.g., FIG. L).

### Creative Stimulation

One can easily understand the technical or organizational interest, but let us also have a look at the “intellectual simulation.” Employees, researchers, inventors who work are not the only ones struggling to make things happen against a world desperately immobile: they are now mobile members of an ensemble that is intelligent and connected to the world, which can assist them, surprise them, or even to challenge them, in short stimulate them like a partner.

Even if we deliberately described here an extreme example which does not apply every day, one understands that a lot of minor changes may occur continuously in each space and that the building will be able to respond by itself to requests (e.g., FIG. H) or to what he understands of the situations, and that it will be able to offer ideas by himself, thus seconding the researcher.

Indeed, in our example, we saw the intelligent building create spaces to connect teams. Maybe the system understood that it had to offer it (in this case, the system has analyzed the activities and situations, calculated in real time how the system could be more useful, evaluated several technical possibilities, and made one or more proposals), or maybe the system was asked to do so.

The system could also (or maybe has it done it at the same time) have taken action on a smaller scale, at the individual level, at the level of a team (e.g., FIG. B), etc., to rotate a roof to bring sun or shade (perhaps because the rain has stopped and the teams were depressed), or give new views on the outside, or change the color of the walls or create a small spring breeze, the sound change, or to connect spaces or people, or display on the wall a provocative idea he found on the internet which is relevant is that these teams are looking, etc.

Moreover, these intelligent buildings could have a foot print near zero, consuming if possible no external energy, emitting no rejection and recycling everything. For example, if solar panels are used to form the skin of the building, or its roof or if they are placed in front of the facades, or elsewhere, it is advantageous to increase their performance, making them mobile to follow the sun. Suppose there are sensors on roofs or facades that turn to follow the sun (at the same time creating natural light intakes, also rotating) or movable panels used as technical architectural components of the facade or of exterior spaces, we understand that the activation of these mobile systems, either to follow the sun or for other reasons (to greet the passage, or to reflect what is happening, or otherwise), has an impact on everything else, which contributes to the sense of the occupant to be connected: his environment is changing, which tells about what is happening in the world, for example the fact that he is it is part of a world of planets revolving around the sun.

The inside and outside the buildings, these campuses, these cities may be transformed into mobile sculptures, which at every moment, tell us a state of the world.

So we′re talking about a creative machine, which will multiply the productivity of staff (e.g., FIG. I) and create a strong common identity, thanks to:
very fine adjustment of the optimum conditions for each person and each activity
constant technical optimizations,
adaptation of the local real-time tasks that are running,
intellectual stimulation,
a sense of being part of a living organism and have a great influence on him,
a sense of spatial quality or wonder if all was well designed.

### Examples of Functions

### Basic Functions

This intelligent system will of course ensure basic functional functions. While capturing and analyzing all, it will automatically be able to ensure the management of:
Physical security of the premises, data security and people
Health, stress, performance of those
The maintenance and servicing
The energy performance
The supplies, recycling, waste management
All flow managements, including access, transport, parking (including charging electric vehicles)
Monitoring equipment and materials
Monitoring of individual persons and the study of their behavior
etc.

### Ultra Specific Technical Management

Such a comprehensive system can cut very precise management of all factors, which includes a quantitative and a qualitative aspect.

In quantitative terms, we understand that each parameter will be optimized very precisely (e.g., FIG. A), e.g. the management of lighting, heating, energy, or water resources item by item, minute by minute, person by person, group by group (e.g., FIG. I), activity by activity, and this will generate significant savings through providing exactly what is needed while improving the comfort widely. Parameters managed this way may also include areas (usage of square footage), outdoor areas, volumes, services, supplies, etc. it is also very useful for maintenance.

A quality management can be achieved not only for each space but often for each workstation.

We will be able to configure exactly all the components (e.g., FIG. A) of natural and artificial light, all components of air (flow, temperature, humidity, speed, direction), all sound elements (sounds, acoustic, reverb, etc.) the views to the inside and outside, but also the visibility of persons, volumes and sensations of spaces, colors or materials and subtle components such as furniture, relations (individual between people and objects or spaces, between inside and outside, etc.), qualitative sensations of space (subtle and complex concepts discussed above), etc.

This quality management is described herein with respect to “IB themes” and “IB Notes”.

In addition, the system can also involve robots (e.g. service robots) for a particular need or service.

The conditions created for each person may be measured continuously to monitor the proper implementation but also relevance. They may be modified during learning. But these conditions are not necessarily consistent: they can change during the day depending on the season or react to climatic conditions (sun, rain, temperature, humidity, light, views, etc. . . . ) (e.g., FIGS. N, O), other people, etc. . . . They can also occur if the system believes it should fight against such a situation of stress or fatigue or discomfort (e.g., FIG. I), etc.

The system may take the same approach with groups: the group is comprised of individuals with their own sensibilities, but also group dynamics and needs.

The system may take the same approach with the topics. Some topics being worked on call different conditions.

Finally, if a person changes of location, its personal settings (e.g., FIG. C) can move with it. But if it moves to change activity, then it is a new setting that applies, corresponding to person+activity.

The same space or the same person will change of atmosphere almost continuously (e.g., FIGS. N, O).

People will be able to manually change settings or to give their opinion, and the system can take them into account in the future.

### Wellness, Custom Spatial Qualities

Everything that has been described here shows that the intelligent system, using information and observation, knows perfectly each person, its sensitivity to all parameters, and its ways of reacting. It thus becomes possible to calibrate atmospheres and custom environments, possibly updated continuously to reflect changes in time or season (e.g., IG N, O), mood, internal and external conditions, etc. The issue of compatibility between people is also taken into account. (e.g., FIG. I)

Ideally, we can manage individualized space or relational conditions. But people often work in shared areas. The system will then seek to find common conditions acceptable to different people present, or suggest different people grouping.

The system also knows the subjects or projects on which the people or groups are working. This can lead to develop specific atmospheres, arrangements or conditions, but also to provide information to these groups or to targeted stimuli.

Configurable fields, as we have already described, can go very far: we can give meaning to all physical conditions: (e.g., FIG. A)

Basic conditions include:
Light, air, temperature, technical services, surfaces, furniture, distances, etc.
Advanced spatial conditions
Volume, quality of space, views, relationships, open/closed, independent/collective, still/moving, etc.
Conditions of “being part of”
Being part of groups, being part of the world (e.g. sensation of weather, feeling the movement of the planets, virtual network connection, etc.)
Etc.

### Stimulating Creativity

Understanding what men are working (e.g., FIG. I), being able to connect this data with information collected is outside (or even inside) (e.g., FIG. J), knowing individually each person, each project and each topic (e.g., FIG. E), ability to analyze in real time mood of the people and to compare this information to the data about the progress of projects, knowing the reactions of everyone and the psychological impact of organizational or spatial qualities that may be proposed, the intelligent system (or intelligent building) can help. Of course, the system can do a lot to create the ideal conditions (as described above) and arrange everything for a perfect service, but it can go further: the system can stimulate (e.g., FIG. I).

Imagine a few examples among others:
The system can detect that it is the right moment to further add to the excitement and publish on the walls and the individual screens a great news found on the internet, or a flow of interactions related to the subject or treated previously or that seem have a relationship, or which seem likely to stimulate the imagination (e.g., FIG. I) of everyone
The system can detect a discouragement, loss of form, and respond with a sunbeam, a new view or a flow of oxygen, sound, aperture, etc. . . . NB: it may be wrong, but he will learn measuring the reactions of people. (e.g., FIG. E)
The system can detect a need for concentration or a positive studious atmosphere and align conditions of full and perfect harmony
The system can create a chaotic space intentionally or create spaces inciting to conquest, risk-taking, or otherwise
The system can anticipate the desires of users and prepare the next step to which they have not yet thought of, but which it can reasonably foresee as imminent, thus causing its realization
The system can promote connections or meetings to avoid inappropriate conflicts
The system may surprise and disconcert, tease, in short stimulate and push to life.
Etc.

### Management Tool

This deep understanding of people and their feelings (towards spaces, situations, topics, people, etc.) may also be useful in the formation of teams (e.g., FIG. I) or projects: better bring together compatible people or sharing the same feelings or aspirations, as the reaction space translates very well and as most psychological test fail to identify.

An entire field of intimate knowledge of individuals is added here for the benefit of their own development and for the benefit of company management. The system can help the match-making and enable significant productivity gains.

The space can also convey hierarchy or customization values. It can communicate feelings of equality, feelings of privilege or hierarchy, possibly mobile (that is to say that can move with the recipient), that the company may choose to use in one way or another. To give an extreme example, Mr. X, whose profile (FIG. D) shows he only likes yellow, can move a yellow halo around him (to be decided by the halo of another person?, or is there a hierarchy?). Maybe when some individuals with special status or condition (e.g., a head of state visit) move, the atmosphere moves with them? Maybe the volumes change on their way? All this comes down to settings specific to the company, organization, city, event, etc.).

The system also detects diseases, ailments, productivity, form increase or decrease and, by correlating with other data, the system may find the cause and solution. Overall, the extremely advanced knowledge about people that the system will have, allows to make a big step forward in the management customization and the relevance of organizational decisions, thanks to the ability to measure impact.

Note also that the unique experience of living in this living ship (e.g., FIG. I) will bring staff to develop a strong sense of belonging and solidarity with the common adventure. Let us remind that firms make considerable efforts to motivate teams and give them a sense of belonging.

### Agricultural Greenhouse

Here we describe an example of agricultural greenhouse because it describes what may be the application of intelligent buildings to a production system and the logic of this example are, in various forms, declinable in countless cases, including related to production.

This is a simple case insofar as there is no human interaction. Actors are external conditions and plants (e.g., FIG. C).

### Example of Technical Case

The greenhouse is a technical system designed to create a climate within different from those prevailing outside, in order to allow the cultivation of out of climate plants and to protect plantations against attacks. It is designed to promote agricultural production.

### Climatic Conditions, Agriculture and Energy

### Technical Data

As it is currently designed, the greenhouse seeks to take advantage of the sunlight through translucent walls, but as the sun gains strength, it gets too hot, and to protect plants must the windows have to be covered. Very often, the greenhouses are now built with the southern part opaque (in the northern hemisphere, and north in the southern hemisphere). In winter, the sun is insufficient to heat the greenhouse and must be heated artificially and therefore consume a lot of energy (the greenhouses are generally very poorly insulated). Energy and labor are often times, with water, the major expenses of a farm in a greenhouse.

We can develop a new principle of greenhouse and use these southern parts to produce solar energy or heat. One can also go further and equip the greenhouse with a double-sided rotating roof (one side equipped with opaque solar panels and the other face translucent), which allows it to follow the sun's path. One side is facing the sun while the rear lights in the greenhouse with non hazardous indirect light. This solar energy unit may, depending on its design, produce only photovoltaic electricity (that can be used for the greenhouse, or to desalinate water or anything else), produce hot water (which can also be used for the greenhouse or outdoor), or can extract hot air from the ventilation of photovoltaic panels for reuse, or a combination of all three.

Hot air can be reused to help heat or cool the greenhouse.

Let us see how this could be managed by the system:

### Agricultural Requirements

### Light and Volume

In this example, the greenhouse is protected from direct sunlight and therefore from excessive temperature rises, and it enjoys indirect light coming from the rear and the sides of the rotating roof and from side walls. Indirect light will turn with the roof and the amount of light received by each parcel of the soil will also vary.

In addition, depending on the particular design of the project, the rotating roof may generate high heights in some places, also subject to rotation.

Finally, some cultures may need more light than others, or more constant light, or whatever.

Agricultural necessities may therefore require a particular usage of this rotation.

### Climate Management

If the greenhouse is designed as described above, it will be a very different thermal behavior of the classical case, especially if its translucent walls are thermally insulating. However, it may need heating or cooling, and can, in some cases, use energy coming from the roof.

The humidity must also be taken into account

Finally, some cultures may require different climatic conditions

### Energy Management

We described in Example #1 the management of the energy conflict between two solar energy productions: electricity and heat, with only one adjustable parameter: the flow of air.

We now have a system that also uses a rotation parameter.

Ideally, solar panels will follow the sun's path.

### Technical Management Level 2 and 3

Level 1: management limited to the energy system without interaction.

Level 2: adding management of the greenhouse needs (e.g., FIGS. L, M)

The heat demand of the greenhouse can be extremely variable from one hour to another or from one culture to another. The system will respond to any questions or arbitrate, for example:
Can the solar system produce all the heat requested by the greenhouse at this time?
If yes, does it cause a reduction in the production of electricity?
Should it be done? what priority apply then?
The most cost-effective in the short term? long-term?
The need for agricultural priority it?
does depriving plants of heat for x hours cause the loss of the crop? evaluate the consequences
etc.
etc.
Level 3 is added to the rotation parameter/lighting. For example (e.g., FIG. N):
rotation program is based on the sun's path. Every day and hour of the year, the position of the planets dictates an ideal angle. The system directs the rotation and verifies its performance
rotation that consumes energy. It is energetically profitable?
it is profitable on the farm?
is there any reason to change the program? e.g. inside lighting, user demand, height need, energy result, architectural choice, specific agricultural need, etc.
Is changing the rotation of the solar system to get more light on an area or at a certain time, or having more height possible or profitable?
Perhaps certain combinations of these techniques can provide more heat and light and less electricity, should it be done?
Does an exceptional technical reason (wind, light, sand, etc.) justify changing the program?
If the greenhouse is part of a building (e.g. roof or facade of a tower), has the building reasons to affect the rotation?
Etc.

We will see that there are other levels . . . (e.g., FIG. O)

### The Greenhouse as a Partner

Plants are probably easier to observe than men.

### Example of System Management

The system is equipped with an agricultural module (e.g., FIG. J), which like others could benefit from the expertise built initially and then updated as an option. It could thus benefit from scientific advances and of the findings of other sites and of the new models created (e.g., FIG. S).

The system could be based on a multitude of sensors: usual internal and external conditions sensors (e.g., FIG. F), visual and movements sensors, but also agricultural sensors allowing to know exactly the status of each plant, to observe analyze, analyze their soil, their water, their nutrients, gaseous atmosphere, etc. . . . .

Active elements (e.g., FIG. G): the system might have a particular control on for example:
all weather systems, energy systems and lighting, ventilation, access, sunscreen, etc. . . . .
Safety and protection
agricultural systems: irrigation, treatment, care, etc.

### Information

The system would have:
its knowledge base (e.g., FIG. J) and its updated modules or knowledge available to outside
the information given by the operator:
its own agricultural strategy (e.g., FIG. J) (possibly a variant from the model)
the nature of the current crop, objectives, parameters to be taken into account, etc.
information from its sensors (e.g., FIG. G)
relevant external information (weather, energy prices, agricultural markets and during transport and forecasts, etc.) (e.g., FIG. J)

### Actions

Intelligent greenhouse is not a backup system: it can become the main actor of the operation.

It can handle all simple actions:
Ensure the ideal conditions of temperature, humidity, light, etc.
Ensure a supply of water, nutrients, etc.
Ensure the maintenance of technical systems
Ensure the maintenance plants and farmland

But it can do much more! As the system with its sensors, can observe and understand men (e.g., FIG. C)(this is also the case with animals in other projects), it is able to observe plants, analyze, compare its theoretical model and determine, possibly with the assistance of the operator:
Their health or “form”
Their level of maturity and time to harvest
Their need for treatment
etc.

The system can also be programmed, order and monitor crops or care, especially if it uses robots, measuring the quantities produced, etc.

The system can also, in some cases, propose optimizations, experiments (e.g., FIG. I), etc., and learn from the results to improve its models, especially in the case of using hydroponic agriculture, highly customizable.

It may also propose combining agricultural performance, optimization of space and resources, economic optimization (e.g., FIG. O), etc., a crop planning and activities to come.

In addition, as the system is connected to the outside (e.g., FIG. H), it may for example:
Manage supplies
Manage the delivery or the whole crop cycle, packaging, delivery
Being connected to markets, carriers and suppliers, weather forecast, it will also help the operator to define and implement an economic strategy. For example:
What is the best time to sell?
So when will it should harvest
So what conditions must be created to speed up or slow growth, or for this or that product quality is dating?
What product should it sell, at what season, to whom?
What are the technical and economic implications?
Can a better use of the greenhouse be done?
produce only energy and abandon agriculture? or the opposite? Use the greenhouse only part of the year?
Imagine different activities: using the greenhouse as storage, show room, point of sale, educational activities, etc.? when?

The system will gradually learn and will improve to become more autonomous and efficient.

By adding these criteria levels 4, 5, 6, etc. the system will also manage the energy system described in the previous paragraph.

### Network Operation

If a majority of greenhouses of the world use the system (e.g., FIG. S), significant advances are possible:
Learning and knowledge sharing.
As in the case of medicine, science will make rapid progress in exploiting the huge databases produced by observing 24/24 million of plants (e.g., FIG. C), observations correlated with the measured data of all environmental parameters, genetics, farming conditions and treatments
The models will be able to move quickly and tests can be used somewhere other (Note: conditions of confidentiality or secrecy may be imposed by the operator)
Management of Food and energy, water and transport
The network of greenhouses, it reports, can work to balance supply and demand of agricultural products, manage traffic flows.
Developed over large areas, it can also impact energy important. It can be useful to coordinate the actions of greenhouses and local communities
The same applies to water

### Collective Building

### Cultural Interaction

We understand that we can decline the benefits of the system to be present at major public facilities.

More importantly, it can invent a new kind of equipment.

One can imagine interactive configurable buildings (e.g., FIG. Q) for public events, which completely transform according to their successive uses, and even in some cases may foresee the spontaneous demonstrations coming, who can feel the public mood and propose to the city messages or temptations.

Thanks to its active facades, they could, for example, be by turns introverts or extroverts, they could express outward what is happening on the inside (either literal expression or artistic translation) or vice versa.

Thanks to flexible volumes, possibly on a frame in 3 dimensions (e.g., FIG. B), they could offer each in turn volumes or spaces, full or empty, large or small areas, paths and changing emotions, expressions and architectural living social leveraging these fleeting configurations.

They could provide a living environment or frame to any kind of demonstration, organized or not. Since a virtual life grows e.g. on social media, this new type of building, which functions as a tactile 3D media provides the ability to embody physically, emotionally or locally viral or global movements and re-express their messages in a concrete form, vibrant or even poetic.

### Technical Interaction (e.g., FIG. H)

Let us imagine a football match

Before the match, the system has checked with the city the necessary electricity that would be available, made traffic lights, warned hospitals, etc.

During the match, if its electricity needs are too great, because of the show, but also because many electric car are charging in the car park, it has dialogued with the city to reduce the demand for other large consumers, then dialogued with each electric car to reduce their load depending on the distance to travel to get home. Then calculating the consumption of alcohol, it warned taxis and organized special buses. Etc.

When the game, the show, the event is finished, the system warns the city that hundreds of cars will come out, and thousands of pedestrians heading to the train station, etc.

### City and Boosted Augmented Reality

We talk about augmented reality. Now imagine that the city itself reacts to its visitors (e.g., FIG. P), make them surprises, anticipates their desires or challenge their creativity, or comfort them, or manage the masses and the collective phenomena, the phenomena of crowd, reacts or causes cultural phenomena, etc.

We no longer speak of an information layer that increases the amount of information extracted from reality, but of the reality itself being increased because the passive elements become active.

Building design (architecture, engineering) is essentially about 3 things: it is dealing with natural background (natural facts and realities) to provide functionalities, compliance with regulations and meaning.

Functionalities: a building is built for providing useful spaces or for fulfilling functions such as providing shelter for habitation, for business, providing relevant systems for a factory or a hospital, etc. Each of these uses require a great number of specific qualities.

Regulations: a building has to comply with a number of rules such as implementation rules (volume, height, distance to the neighbor, etc.), safety rules such a fire code, seismic or engineering rules, or other rules such as privacy, security, hygiene, etc. The architect's job is to create meaningful spaces and volumes by dealing both with this complexity and with the client's or other stake holders' (such as city council's) needs or desires. Meaningful spaces means that the volumes or the space organization (such as hierarchies, paths, contrasts, functions, etc.) are not only technical features, but that they carry many meanings, cultural references or signs: is it nice, grand, cozy, comfortable, provide privacy, cold, impressive, sad, young, modern, traditional, do I feel energetic or tired, do I feel powerful or privileged or the reverse, etc. Basically, architecture is a system of signs (signifiers) installed in a 3 dimensional space to cast meanings towards an audience that reads these meanings using the respective cultural background of the audience.

Designing a building is a difficult process. Therefore, the building is built in hard material and the final design is “set in stone”. The same is true for a city or many complex systems. Typically, the designers have set in stone temporary signs or organization schemes that continue to have an effect long after their original relevance has gone. Space, with all its meaning, content, with all the organization impositions that it carries, has a very powerful (and underestimated) impact on society, on businesses' efficiency, our way of life, our mindsets, our feelings, our mood, or on the idea that we have of life and our relationship to the world. What structures our world is a set of choices that the designer has made at a certain moment for certain reasons: for example, the designer may have chosen to put a wall here, and to have this kind of volume to which the access is this way, with this kind of connection with the outside, with this kind of color, of material. These are choices. The designer chose between hundreds of possible choices and combinations because he and the other stakeholders felt comfortable with these choices in a certain context, basically, what they have solidified this way are settings. The wall is red but it could have been yellow, etc., so, the way we modify world is entirely by applying settings.

Thus, the user experience of space has often endured without much customization.

The result is that most people consider architecture, or a building's current state as an immutable fact. Moreover, the organization of spaces the architect comes with is often efficient for a given time and activity, but is difficult to adapt to different occupants, or business or needs, or times. This is easy to understand when considering the difficult contemporary use of renaissance palaces for example: the palaces have been designed for a certain way of life and are very difficult to use in nowadays life. Some of the meaning the renaissance buildings cast still makes sense today but a part of it is unreadable by modern audiences. The same is true for the reconversion of many old buildings. The problem derives from the fact that the renaissance buildings have been built in immutable stone and their design is set in this stone. The result is that most people feel they have little or no control on space nor on cities and they simply are subjected to spaces, organizations or meanings they are not necessary happy or comfortable with. When engineers consider automation or intelligence, they only consider a few superficial improvements in the management of systems, such as energy efficiency systems.

Since we know some, or all of the construction components such as windows, internal or external walls, lighting, climate control, roofs, doors, etc., may soon, thanks to technology, shift from being inert to being actively controlled, which means they may become parametric objects whose status can be changed by changing settings with a computer, the whole architecture/engineering status quo is put into question. Active systems make it possible to change a space configuration in a few seconds, and perhaps by only changing a few settings, according to certain embodiments.

To clarify, consider the following example. A room or an office is defined by its envelope, which means its volume (its walls, floor and ceiling), its materials, its colors, it light ambiance, its climate, its sounds, and also its relationship with the outside: its views, its connections, as well as some memories of the occupant—how was the occupant's experience last time she was in the room; what did the occupant experience going into the room, etc. Everyone knows how effective it is to repaint a room. If the wall that cuts off the occupant's views to the outside, can be made transparent, or translucent, or disappear, or move, then such a change would have an impact on the occupant. Let us imagine that what was inside is now outside, or that what was dark now becomes bright or what was disconnected becomes connected, etc. we understand all the changes in the meaning. What was sad may become joyful, what was demonstrate as second ranking may now mean 1^{st} ranking, what felt protective may now feel exposed, etc. or the reverse. This can be achieved in a short period of time as disclosed by certain embodiments herein. The active components (or actuators) in buildings allows not only for energy consumption savings but also allows for the ability to take control over complex systems. The settings that the designer used to set in stone previously can now be changed within the limits of the available technology.

What is needed are tools to deal with this complexity as described above.

Since a computer system can be in charge of instructing active components of the building to change status, this computer system might also be allowed to propose settings in order to respond more efficiently to situations at hand (e.g., activity of the occupants, number and type of occupants, etc). If the system is able to understand situation at hand, the people or circumstances and to understand the meaning and the efficiency of the new settings that are created, then very interesting interactive buildings can be achieved. The results can range from a simple energy management application to a complete reset in real time of a building's architecture, organization or functionalities for any number of purposes: personal feelings, business goals, society changes, etc.

To be able to do this, we need new tools. Buildings are fundamentally complicated matters, they result from many complex requirements working together and the human brain's complexity acceptance is what limits the field of creation in that matter and explains why buildings are so much the same in every country. An intelligent system could open brand new configurations if it is able to comply with all the requirements in the same time. There are several key issues to be taken care of: engineering (workable new settings are needed), complex systems (e.g., fire systems, workable elevators or workable climate control systems), the organization schemes (e.g., a room should be a room, or business goals that need to be achieved), meaning (we want the meanings created by the computer to be in a certain range of acceptability), etc.

Therefore, automation and/or tuning in buildings can be either very limited or very broad, depending on the circumstances: one can have control on the color of light in a bedroom in a detached house, it does not matter much. But if it comes to turning the walls into windows or moving the walls and changing the temperature in a larger building, then there are a larger number of issues to be dealt with. The computer system as a building can include logical mise-en-scene analysis tools to create in real time a mise-en-scene design for the building based on the analyzed information. Issues include: privacy, views over the neighbor, was the wall a structural one, was it a fire barrier, was it protection against falling (as part of an anti-fall system), how far is the door from the next exit, how does rearrangement of walls and windows change climate control or the electrical network, does rearrangement of walls and windows and the other changes require the use of t elevators, do the changes require permits, do the changes change the aspect of the building from the outside, and very importantly, what is the set of signs and what meaning does the set of new settings/configuration carry? The transformable building needs to have several key abilities, according to certain embodiments:
The transformable building needs an intelligent computerized brain to perform design according to a set of rules and cultural backgrounds as designers do. The computerized brain is like an automated designer (the initial designer's role changes to that of a system designer).
The transformable building needs the ability for the main technical systems of a building to work together.
The transformable building needs to be able to tune finely the space qualities the transformable building provides and to have intellectual tools to assess the qualities and meaning that the space qualities are creating.
The transformable building needs a number of sensors and connections to collect information about what is going on and to inform the system using the collected information.
The transformable building needs a computer system to be able to understand situations (e.g., activity of the occupants, number and type of occupants, etc, business goals, privacy considerations, comfort, structural objectives and constraints, resources, availability of various subsystems such as security systems, fire systems, climate control systems, etc.)

The control of the system can be either manual or automated.

Intelligent computerized brain to perform design:

Computer systems are good at sorting complex situations with many factors. Computer systems may even be better than humans. Humans, because they understand the relevant context or background, they are sometimes able to make daring choices that are reasonable at the same time. But a computer system with a good set of rules can also perform good design, if it understands the cultural background. Thus, we enter the realm of meaning. See below. Human supervision may be required in some cases. The computer can analyze situations in real time and assess if changes in settings changes can help. Changes may go as far as a complete architectural or technical rethink of a building.

Ability for the main technical systems of a building to work together:

Large buildings use several complex technical systems, such as fire prevention systems, electrical systems, climate control systems, elevator systems, information systems, security systems, etc. Each of these systems may use its own sensors, active devices (automatic sprinkler systems, elevators, light bulbs, automatic doors, etc.), its own computer controls, its own wiring, and often its own communications with the outside (such as connection with the firemen, or energy grid, etc.), according to certain embodiment. These systems are often autonomous and proprietary: the makers of such systems want to be sure the systems work properly, as so the controlling authorities. Therefore, for example, a wall will not be moved if it involves changing a fire zone or adversely affects a fire detection system (which is connected to the fire department) since the fire system has been approved by a building permit, etc. Changing such a wall may also affect electrical networks, air conditioning, business organization, elevator flows, etc. In another example, changing the climate setting of a room may change the balance of a whole floor's energy system. At the same time, we understand the current method of building is extremely inefficient: each system has its own sensors systems, its own wiring, its own computation systems, its own actuators, its own communication systems, etc. the system's efficiency is limited by the number of its sensors it has limited information), very often its own language, (and by the fact it has no control over other systems). Therefore, the only solution is status quo and once a configuration has been accepted, it is very difficult to change it. However, a fire system would be much more efficient if the system knew how many people are in the building, who they are and what they are doing, etc. Efficiency can be achieved, if the system could manage doors, corridors, elevators, air conditioning and lighting, and if the system could give this information to the firemen, etc. Instead, today, the system knows very little, the firemen lack information and the fire system has to include its own door locking system, its own staircases, its own air extractors, its own safety lighting, etc.

The problem described herein can be solved by creating a Building Operating System (BOS) that enables all the systems to work together in a coherent and efficient manner. It is much more efficient to have:
Many sensors collecting important information that will be shared with the systems that need it.
A common communication network, referred to as the “data spine of the building, that carries all the information needed by the relevant players in the building.
Data processing systems that analyze the information coming from the sensors, the sub systems and the outside world
A computerized central intelligence that manages all the subsystems (fire safety, elevators, doors, electricity, etc.,) and creates new configurations according to its goals, logical schemes, knowledge, and authorizations.
Many actuators (the active components) acting under control of the central intelligence in the interest of all the systems (for example a door or a light bulb can be an actuator for many systems running various logical schemes).

The computerized intelligent brain arbitrates between the systems' requests, weighs priorities (for example between vital functions, important functions, entertainment functions levels or internally at each level), shares information as needed or authorized for each subsystem, manages communications with the outside and arbitrates between the technical subsystems' requests and the overarching goal of providing meaningful or efficient spaces for the user.

The computerized intelligent brain also manages the overall quality of the proposed/implemented solutions and ensures that the solutions work properly. For example, The computerized intelligent brain may need to ensure that the relevant authorizations and permits are obtained. An ever evolving building could have a building permit that not only covers a “set in stone” setting but also an evolution scheme process. The inspection, instead of requiring a systematic site visit could more and more involve a remote computer control process, comprising a sensor based assessment of the current status. A real time negotiation with the relevant authorities could even be performed in order to make sure each configuration is accepted.

A large number of modules, databases or applications can be plugged into the BOS software platform. There can be a market for 3d party applications related to buildings. Such applications would have to be compatible with the BOS. The BOS and the computerized intelligent brain would manage the applications' rights, control and limit their ability to intervene on the building's settings in accordance with a set of rules they are enforcing, and arbiter conflicting choices with other applications.

The range of 3d party applications for intelligent buildings is potentially vast, and can range from professional applications (medical, industrial, agricultural, domestic, transportation, etc.) to any add on feature such as behavior recognition, speech recognition, energy management, artistic skills, city planning interconnection, etc.

Further, existing 3^{rd} party applications such lighting control, energy management, office productivity applications or many other ones can be implemented on this software platform and increase their reach and efficiency.

This system does is not limited to buildings, it can be used for a number of different systems, according to certain embodiments.

Fine tuning of space qualities:

The system needs tools to control how space qualities are designed and built. If the quality of the space is defined by choices, for example, color of a wall or the quality of light, then such choices involve settings that need to be controllable. Control is at the level of each actuator and the settings are broken down into controllable parameters. For example, a light may be defined by its color, its intensity, its direction, etc. . . . (e.g., see FIG. A). Control can be achieved by decomposing every actuator into a series of variables that can be described numerically and controlled. By fine tuning of each component of a space's quality, sets of qualified settings can be created (similar to that of a violin, which is able to create a continuous range of sounds, and for which has been defined a series of selected sounds called notes). Thus, “notes” can be created for every component: for example light IB Note 21, wall color IB Note 55, volume IB Note146, etc. It is the architect's job to define these values as a starting point. Once IB Notes are created for each component then harmonies can be defined (See FIG. A): this light goes well with this color and this volume, because altogether, they create this space quality (or IB Harmony). The same area/space can take on various configurations and provides alternatively various space qualities or IB Harmonies. Several compatible IB Harmonies can be played successively in a longer melody: it becomes an IB Theme. The above description is only as an example of a way to make sense and control the kind of space quality that the system can create. For example an active wall can be in turn opaque or translucent of transparent, it can have various colors, or aspects, it can be mat or reflecting, be sound reflecting or sound absorbing, flat, curved or bumpy, vertical or sloped, it can full height or partial height, it can be in such or such position or location, etc. and everything in between.

Need a number of sensors and connections to collect information:

Buildings may comprise many sensors collecting lots of information about the status of the technical systems or components, the people, the situations, etc. . . . the building can also take advantage of many forms of outside information such as internet data, connection to exterior systems or many possible forms of public expression or public participation providing some form of direct interaction or democracy. Some or all this information may be used and processed by the computerized intelligent brain and distributed to the relevant sub-systems.

Need a computer system that can understand situations:

If the system understands situations, it can interact with events and people. One easy way to understand situations is by using models that the system can recognize and compare. The system will be provided with a set of models at the start and it can then build its own models based on its own experience (a learning machine).

The building, which once was defined by its concrete structure, can now be defined by a data spine, the computerized intelligent brain and actuators. The aspect of the building at each time is the result of settings. These settings are the result of a calculation that takes into account a number of rules, technical data, an understanding of a situation (using sensors and information), of input goals and of additional modules that bring additional knowledge or skills. The building would gain a lot if it is connected to other buildings, cities or organizations using the same or similar systems: the systems can share updated information, models, knowledge and feedback, or have centralized or cloud based calculation, storage, modules, knowledge bases etc.

The nature of buildings, which once was a stack of stones and hard materials put together in a certain way becomes that of logical scheme that allows various components to take multiple embodiments. The material nature of buildings becomes hardware plus software, both of which provide structure, context and organization for data interplay. The result of each iteration is the product of calculation using many factors as input.

According to certain embodiments, the building system achieves the capability of creating user experiences by its own calculation, using relevant settings. Thus, the buildings become thinking buildings: buildings that not only reproduce pre-defined configurations (which would already be an extraordinary achievement), but can create, in real-time, their own configuration proposals after intelligently assessing situations. Thus, the building becomes a computer in 3 dimensions. Its role is to provide functions (shelter, services, etc.) and to install signs in a 3 dimensional space. The building is defined as the sum of a location, a set of actuators and sensors, a BOS and a computerized intelligent brain, the programs that run it and the applications and modules that have been implemented. All this makes the building upgradable.

Retail Store:

The services an intelligent or a thinking building can provide are potentially very numerous, and the system proposed here may find unexpected applications. A sample embodiment associated with a retail store, such as a large grocery store, is described herein but this can be applied to many cases that are not stores, such as urban or public environments.

Marketing architects usually try to organize the client's itinerary and to add meaning to the products by many means: advertising, appeal of products, persons, position of the shelves and passage ways, hierarchy between the areas, lighting, etc. Space is a powerful communication media and its settings influences the store visitor's perception, feelings and comprehension of facts, and even mood. In the case of a store where signs, communications, value/image building are so important, it is crucial to remember that space is an array of signs in 3 dimensions. The building's ambiance or settings are thus a key part of the selling process. Many supermarkets are closed boxes with artificial lighting partly because the marketing teams want the client captive in an environment that marketing teams control.

Unfortunately, the mise-en-scene cannot be changed easily in the case of a classical building. It is difficult to test a new configuration and store designers have to trust old recipes instead of experimenting. The extent to which a classical building can be configured is also very limited. A reconfigurable or programmable building would be much better tool.

Marketing people are also eager for data: they keep trying new things, new products, new pricing, new communication, new approaches but they are like blind since it is very difficult for them to measure their results except by the sales figures. An Intelligent Building can change this too, and provide tools for building a completely new, interactive relation to the customers at the individual level and at the community level. Working on the building's setting may also change deeply the relation to the product.

An intelligent building can become a major productivity tool. Using active components (actuators). This example relates to a typical suburban supermarket. Such a retail store is often a large metal box sitting on a large parking lot. Very little can be done to change its space or communication settings. On the contrary, an Intelligent configurable Building may be reconfigured as much as its technical features allow. Using an active roof allows the store to be at one time a closed box with neon lighting, at another time or an open air area with no roof, at another time it can be closed but naturally lit by a transparent roof, or it can have darker areas while other areas are flooded with sun in order to attract attention, etc.

Using active walls is another way for the store to provide a different user experience: the store may be at one time a closed box, but opening some of its walls he store can extend to the outside or provide different views or a different light or relationship to other areas. For example, it may allow to completely rethinking the area that once was a boring parking lot into a more friendly area like a Mediterranean farmer's market that would continue outside the building. Using active shelves that can be moved, the store manager can create various settings, put forth various departments or promote various itineraries and change completely the hierarchy between product or the client's perception of the store. Using artificial lighting as a meaning creation tool is part of the ambiance setting too. Using air-conditioning not only for temperature regulation but in a more meaningful way may help to create an ambiance. With the right air settings, such as composition of the air, speed of the air, odor, moisture, etc., it is possible to create a meaningful message, and even more so if it is used in synergy with one or several of the above. Sound may be used for purposes other than only voice messages or for noise covering music. Sound can help create or recreate an atmosphere, create hierarchies, differential perceptions, etc. These tools may be used independently or together. Once the store has been turned into a communication tool, many strategies, programs or applications can be developed to use it and renew the client's experience.

The ease of reconfiguring the building allows the store to test many configurations or settings. With such a tool, every store chain can craft a personal ambiance that becomes its identity, and may evolve in real time, or per periods. To do this, IB Players, IB Notes, IB Harmonies, IB Themes are used. A brand's identity can be defined by an IB Theme, which means the building could play all the IB Harmonies corresponding (which includes a set of IB Notes) to this IB Theme without ever loosing its identity although being always different. Since the stores may differ in size or equipment, they may have different IB Players and IB Notes, but the IB Harmony can still be tuned, exactly like with an orchestra.

Using sensors: The store may be equipped with sensors and information analysis tools as described above. Clients are recognized, welcomed and tracked (clients may opt out of this tracking), either nominally or anonymously, with respect to their wanderings in the store and also about how they feel, how they react to the that stimuli the store sends out continuously, how they choose the products they buy, what they are attracted by, or how they react to the personalized advertising they have received. The settings can be updated in real time depending on the clients, the products, the weather, etc. The information collected also allows the store to adjust its messaging, pricing, shelving, etc. The building's sensors system can also closely monitor the products, such as fresh products, for example. The products can be tracked too, using for example RFID chips or other systems, so the inventory, the clients' itinerary, marketing policies result match. The sensors allow for the products to be tracked as far as the buyer's home and refrigerator are concerned in order to provide many services such as preemption or freshness tracking, energy consumption, spending optimization, automated reordering through the store's website, etc. It then becomes possible to try to understand if the client buys again the same product or not, and why, and to try to analyze why, what factors are at play, etc. Real-time customization system allows for providing the client with a personalized ambiance anywhere, with a preferred lighting or a sound environment, with a spot on preferred products, or with even more finely personalized staging that for example provides him an ambiance the client has good memories with, or other personalized solutions. The client may ride like a wave of his own cultural world comfortably moving with him. Since the sensors inform the building about what is going on, the intelligent unit may define different settings in real time. For example if it is sunny or if it just rained, if the store is crowed or almost empty, or if there are more children or elderly, etc., or any other interaction with the environment, the people or the activities.

Intercommunication:

This interactivity and the ability to understand clients' activity may also allow for a new form of customer involvement or even customer democracy.

The client may feel more connected to his favorite store if the store adapts to him. The store may also allow the customers to interact with it on a voluntary basis for example by voting online or on smartphone and thus choosing the product to be put promoted, or by asking for various things, or by influencing the building's exceptional settings for a day.

The store may allow to be personalized in some way like a collective creation many people may want to be part of. In the same way, some forms of voluntary interactions may be possible in the store, such as letting the client know he can change the settings by acting in such or such way, etc. The clients might feel they are shaping the store according to their choices, either at the individual level or at the collective level, thus creating this sense of community the retailers and brands are so much looking for. The overarching result is that every store could differ from the others, that they could differ from day to day or from hour to hour, depending on the weather, on the customers, on the marketing strategy, etc. The system allows for a brand new user experience and customer interaction. It allows for a new relationship to the client. The store is now a tool a retailer can shape in many ways.

The following non-limiting examples are illustrative.

A store might be:
On a cold winter day, a closed, warm, reassuring place with party lighting, wood fire smell and a focus on gravy. The turkey selling area would be the center of the building, the focus point because of lighting, volumes, paths organized by shelves positioning, etc. But if the weather suddenly changes to sun, the roof may start to let some sunlight in, and the artificial lighting may reinforce this happiness with a warm powerful lighting, and every one feels better and more optimistic. The sales may rise.
On a freezing and sunny spring day, the store may have texted all its clients about its special fish day due to a fresh arrival from Alaska. The clients would find the store's plan completely changed, with a dark atmosphere and, in contrast, a wide open roof in one point that lets the sun fall directly on the fish area, thus making it very attractive in the store. When here, the client would feel may be the sea side, may be a fresh iodic breeze, may be an adapted sound atmosphere, may be a different floor, may be some tables for eating on the beach, as well, may be, as a close monitoring of the fish stock or freshness, or a reminder of every person's tastes, etc. May be, if the weather changes or if the fish stock is gone, or if there are too many people, or for another reason, does the setting change again to attract customers to another area. May be do the clients choose to modify the settings or act in a way that changes them, or perhaps, they simply express their satisfaction, which attracts more clients.
On a nice summer day, the store becomes a Mediterranean outdoor market. The roof is widely open, the air-conditioning if off, and parasols are in the store to protect form the sun. Or, may be, the roof is not completely open, but it only lets sunrays in, and some air cooling is still slowly going on. No wall separates the store from the parking lot, half of which is now an outdoor farmers market. The store's identity is expressed from the bottom of the store to the entrance of the parking lot, thus visible from the street.
Another day, sad and drizzling, the store is almost empty and no one feels like going out. May be does the store create a special event, or a party to attract the kids and text all it customers, or may be does it change its facades for them to be more attractive in the grey and more visible form a distance.

FIG. A illustrates how basic components are used to elaborate complex IB themes and how meaning can be constructed, according to certain embodiments. In this example, a set of constructive elements are active and can be set very precisely to tune the qualities of a given space or system.

In this example, a set of five fundamental technical systems (non-limiting examples include light, climate, volume, views, sounds) has been chosen to be adjustable in order to obtain a qualitative structuration of space. The set of five fundamental technical systems are called intelligent building (IB) players or IB Players (100). Each IB Player is tuned using a set of parameters in order to create IB Notes (103). Examples of IB notes are illustrated as IB Note 142 (131), IB Note 100 (132), IB Note 44 (133), IB Note 1 (134), etc.

In this non-limiting example, the IB Players (100) (non-limiting examples include light, climate, volume, views, sounds) to be adjusted are the following (it could be any other set of any number of constituents). In some cases, all the constituents of a space or a system can be adjusted to control the qualities of this space or system):
The light (104) is, in this example, adjusted by setting a value to the following parameters as non-limiting examples (it could be any other set of any number of parameters):
   Color (105)
   Intensity (106)
   Direction (107)
The Climate (108) is, in this example, adjusted by setting a value to the following parameters as non-limiting examples (it could be any other set of any number of parameters):
   Temperature (109)
   Hygrometry (110)
   Speed (111)
The Volume (112) is, in this example, adjusted by setting a value to the following parameters as non-limiting examples (it could be any other set of any number of parameters):
   Height (113)
   Space (114)
   Connection (115)
   Situation (116)
   Position (117)
The Views (118), for example view on a landscape through a window), are, in this example, adjusted by setting a value to the following parameters as non-limiting examples (it could be any other set of any number of parameters):
   Horizon (119)
   Width (120)
   Nature (121)
The Sounds (122) are, in this example, adjusted by setting a value to the following parameters as non-limiting examples (it could be any other set of any number of parameters):
   Intensity (123)
   Reference (124)
   Tone (125)

In this example, in order to make it simpler to understand, we imagine that the parameters named above are represented by simple numeric values, but the tuning can be much more complex. When the basic parameters are set to a value, this creates a IB Note (103), which in the interest of simplification, has been here described by number (131, 132, 133, 134) but obviously the coding may be much more specific or rich.

When several IB Players (100) are tuned with relevant values, this creates a harmony (101). This figure shows 5 non-limiting examples of IB harmonies (101):
IB Harmony A (126) with a certain set of IB notes (103)
IB Harmony B (127) with a certain set of IB notes (103)
IB Harmony C (128) with a certain set of IB notes (103)
IB Harmony D (129) with a certain set of IB notes (103)
IB Harmony E (130) with a certain set of IB notes (103)

A set of one or more IB Harmonies (101) is an IB Theme (102).

FIG. B illustrates the impact of two different organization principles/schemes by showing both logical schemes at play and their associated results, according to certain embodiments. Due to the nature of the design process described herein and to the fact that in some cases physical embodiment and software architecture are intimately linked, FIG. B illustrates either a physical embodiment (for example the layout of physical elements such as volumes, devices or functions) or a software design. The units (203) can be either real world things such as walls or rooms, sensors, or software logic.

FIG. B illustrates 2 examples of organization: organized as a matrix (200) or as a tree (202), and the corresponding examples of results. Each organizational scheme can have different logical sequences and results.

In Building model type 1 (201), there are structures or frames (204) organized as a matrix in which each point is connected to several other points. The decision process can take several paths and the resulting units may have an independent relationship with other elements. Rules (213), links (207) between elements, intents (214), physical requirements (215), etc., can play independently or simultaneously and generate a wide range of various units (203) or organizational schemes.

In Building model type 2 (220), there are structures of frames (206) organized hierarchically like in a tree structure. The end of the branches are the units (203) that do not communicate with the others. In this example of arrangement (205), the decision (217), or requirement (212), or it could be an intent or any other input (216), or it could be the building's ground floor, directly drives what happens in the upper levels via several series of links (208, 209, 210, 211), each of them controlling the next one.

FIG. B also shows how these kinds of structures are different and how they produce different results.

The organization scheme is valid for a building's plan (the units there are the rooms), for a technical plan (the units are the devices), or for the software architecture.

FIG. C illustrates data collection and processing for a space, according to certain embodiments.

FIG. C shows an example of a situation.

A person (300) is in a space with another person (309). Behind them is a view (301), that can be real or artificial, showing a landscape (302) in this example. This view is analysed and labeled (303) by the system. Around these two people are a desk (306), a device (328), another device (307), a chair (305). In this example, the room also comprises an air conditioning pipe (311), a light (315) and an active sun roof (313). The air conditioning or climate control (312) is an active device set on parameters (312). The light (315) is an active device adjusted using parameters (316). The sun roof (313) is an active device adjusted using parameters (314).

There are sensors (310) in various places or on various devices such as in the ceiling, in the device (307), in the chair (305). The sensors collect flows of data (327, 304, 308) that are put together as sensor data (326). The sensors measure the physical environment, such as the light, climate, volumes, views, etc. In some cases, it can assess or even understand the people such as their presence, their attitude, their activity, their mood, etc.

In this example, the space configuration has been set after some calculation and can have different implementations. The active devices are figures controlled (317) by orders given to parametric devices (318).

The system measures the results of this configuration, using the sensor data (326) and possibly calculating people's feelings (325). In this example, the configuration implemented was based on a model (321), taken from a library of models (322). It has an expected result (323). The system compares the obtained results (326, 325) with to the expected results (323) and calculates (320) if the result is the same as the expected result or if it is different (324). It can then calculate (320) an updated configuration and modify the settings (319) and give new orders to the active parametric devices (318). It may also learn (329) from its experience and calculate an update to the model (321) itself and start exchanging with the libraries (322).

FIG. C shows people in a room but there are many other cases of interaction, such as plants or animals in other configurations, or cities or work environments, etc.

FIG. D illustrates how a model is created and how it is used, according to certain embodiments.

For simplicity purpose, this figure describes a model of a human person, but it could any other kind of model such as a situation, a behavior, an event, a plant, an animal, a technical issue or anything else.

FIG. D shows how Mr. X's model (401) is created, according to certain embodiments. It all starts with information. The system makes a real world observation (409) of Mr. X, for example using sensors, or information about him has been obtained from another source. Based on this information, the system compares the information it has with the models (404, 405, 406, 407, 408) found in a library of models (403). In this case, it recognizes similarities with model (408) and selects it as the closest basis.

FIG. D shows how to make a personal model (402, 433) out of this library model:

The system uses a comparison grid made of a number of items (412, 414, 416, 418, 420) and measures significant differences (gaps) between the observed person (411) and the library model (410). The difference on each comparison line is described (413, 415, 417, 419, 421). In this example, the differences have been described by a figure only for simplicity reasons but it could be described in any other way. A personalized model (433) is characterized this way. It may happen that this new knowledge leads to creating a new model (434) that may be put in the library, since this analysis and comparison between the model and the observed person reveals differences that can be translated into sense and learning (435). This learning (422) can be fed to a knowledge base (423) which might include any type of information useful to describe a model. In this example, there are segments such as rules (424), specifics (425), values (426), attitudes (427), tastes (428), reactions (429), body (430), voice (431), vocabulary (432). Other segments would exist for other cases.

FIG. E illustrates how a model is used, according to certain embodiments.

For simplicity purpose, FIG. E shows a model of a human person, but it could be any other kind of model such as a situation, a behaviour, an event, a plant, an animal, a technical issue or anything else.

FIG. E shows Mr. X's initial model (500) that has been created previously. The initial model (500) is used to analyse Mr X's real time behaviour. The system uses the information it has from its sensors or from other sources and compares the real Mr. X (524) to his model on a number of items using a comparison grid. The system knows the model's values (501) on a number of criteria. For example, it compares this value (503) with real world measured value (504) and calculates the difference. The system can make this comparison for on each criteria: in this example, the system compares (503) to (504) to find a difference (502); the system compares (506) to (507) to find a difference (505); the system compares (509) to (510) to find a difference (508); the system compares (512) to (513) to find a difference (511); the system compares (515) to (516) to find a difference (514); the system compares (518) to (519) to find a difference (517); the system compares (521) to (522) to find a difference (520), etc. The system makes sense (523) of the differences between the measured set of values and the model's ones, and learns from them. This may help to improve the model.

But more often, a real time observation (525) allows for understanding what Mr. X is doing or feeling. For example, is he joking (526)? Is he uncomfortable (527)? Is he having an unknown attitude (528)? In this case, the system can create a new profile (529) on the model.

The model may have profiles corresponding to various circumstances or embodiments. For example Mr. X's model (535) may include mood or attitude profiles: the profiles correspond to what the sensors or information sources allow the system to know or observe in Mr. X's attitude. The system may have noticed that Mr. X regularly behaves in a certain manner that differs from the necessarily broad general values of its model. Thus, the system will build sub-models or profiles that correspond to situations or attitudes or any other type of frequently observed phenomenon. In this sample case, the system has a Profile A (530) which describes Mr. X when he is sad (536), a Profile B (531) which describes Mr. X when he is working (537), a Profile 3 (532) which describes Mr. X when he is happy (538), a Profile 4 (533) which describes Mr. X when he is tired (539), a Profile 5 (534) which describes Mr. X when he is socializing (540), etc.

In this example, Mr. X is a man, but it could be a tree, a space, a situation, a technical element, etc.

Since Mr. X's model now includes a set of profiles that better describes him, it becomes possible for the system to recognize Mr. X's moods (he is sad), activities (he is working) or feelings (he is tired). Further, the system can also analyse Mr. X's behavior on a more granular level: since the system knows that Mr. X is working and he is sad, why is there still a difference between what the system measures and the model? This where the value is really added: in some cases, the model is improved, in some cases, the system can understand subtleties in situations and circumstances.

FIG. F illustrates some non-limiting examples of sensors such as:

Power production (601), Outside air pressure (602), Outside hygrometry (603), Outside temperature (604), Rain/Snow/Sand/Dust sensors (605), Outside wind (speed, angle, temperature, altitude) (606), Outside light (including albedo) (607), Outside sunlight (angle, color, power, etc.) (608), Skin of a building status (temperature, hygrometry, cleanness, failures, etc.) (609), Solar panels temperature (610), Air flows (Speed, hygrometry, temperature, angle, altitude, etc.) (611), Outside visibility (612), Presence/movement detectors (613), Cameras (614), Microphones (615), Other outside sensors/detectors (616), Inside pressure (617), Energy consumption sensors (618), Water/Air/Sewage/Space/Other resources usage sensors (619), Magnetic field, infra-red or other sensors (620), Active elements control sensors (621), Inside hygrometry sensors (622), Inside temperature sensors (623), Inside light sensors (natural/artificial, color temperature, power, angle reflections, etc.) (624), Digital/electrical/radio/activity sensors (625), View sensors (626), Noise sensors (627), Space quality sensors (628), Mood sensors (629), GPS/location sensors (630), Odour sensors (631), 3D volume sensors/scanner (632), Human digital activity sensors (633), Identified elements status/position/temperature, lighting, sensors, etc. (634), Any other sensors depending on the project and the available technology (635).

FIG. G illustrates some examples of active devices or active elements such as:

Fans (701), Active grids (702), Active valves (703), Inverters (704), Energy systems (705), Power management systems (706), Air conditioning/Heating/Cooling/Hygro control/Pressure control systems (707), Lighting systems (708), Sound systems (709), Active windows (710), Active odor diffuser (711), Active doors (712), Active shutters (713), Active shaders for providing shade (714), Active solar systems (715), Active wind systems (716), Natural air flow management systems (717), Maintenance systems/Maintenance robots (718), Projection/display systems (719), Water/Watering/Sewage systems (720), Communication devices (721), Active walls (external and internal), active flooring (722), Active roofs/ceilings/staircases (723), Active view/lighting management (724), Active façade or active glazing (725), Active outdoor devices (726), Active city planning element (727), Active landscaping elements (728), Active fences, barriers, carports (729), Active vegetal façade, roof, green houses (730), Active mobile devices (731), Active architectural element/System/Configuration (732), Existing or future connected or manageable device or element (733), Any available active or controlled element (734), etc. (735),

FIG. H illustrates an example of how the system communicates and interacts with the outside world, according to certain embodiments.

The System (821) drives the building or site's (808) settings or transformations or the activity's (809) settings or transformations, by driving the system active devices (819) and using information from the system sensors (820) to influence a target environment (827).

The system can be autonomous or it can run a lot of interactions with many outside players, possibly using a Universal language (818) to overcome the language and protocols barrier.

The system can exchange information with persons, institutions, users, internet, etc.

FIG. H shows, as an example, that the system receives or sends information to/from people either inside the building or outside the building. FIG. H shows Person 1 (801), person 2 (802), person 3 (803), person 4 (804), person 5 (805), person 6 (806), and person 7 (807).

The system also exchanges information with outside institutions such as:
communicating objects (810) (e.g., devices, robots, etc. inside or outside the site)
Other Intelligent Building systems such as systems that are part of the site but not controlled by the system as described herein, or other buildings, other systems, or other buildings using the same system (811)
The associated city, other cities or organized communities (812)
Train or transportation systems (813)
Power grid (814) or other utility networks or vital networks
Highway patrol (815), and/or security forces
Hospitals (816) or other service infrastructure
Markets (817),
Etc (828)

The system may also exchange information, receive instructions, exchange data or dialog with its user (822), for example its manager.

The system may also exchange information with the internet (826), with the Social media (824), exchange RSS flows or other communication protocols (825), or other exchanges (823).

FIG. I illustrates the interactions between people or activities and buildings or sites, according to certain embodiments.

FIG. I shows, as an example, a room (947) that is using space settings defined by a project configuration (900), active devices such as an active roof (914), active volumes (915), active windows (909) generating a specific view (911) for view 910, active lighting (912) and other active or passive devices or components that have created a determined environment. Other players are active too, such as a Window (933), another Window (934), another Window (935), a Door (936), another Door (937), another Door (938), a Light (939), another Light (940), another Light (941), another light (942), a Fan (943), another Fan (944), a Roof (945), another Roof (946), etc. Each player is playing a note (IB Note) defined by parameters, and all together (932) they compose an IB Harmony (931) that may be described by a reference or a set of values. These IB Harmonies compose an IB Theme (930).

The building knows about what is going on, reacts to it and creates specific environmental or space qualities for this.

The system may know what activity (901) is being performed on the table (902) of the room (947). The system may know some or all of the people present in the room, and the system may already have a model or a profile for the people present, or it may be creating profiles dynamically. In this example, several people (903) are not yet identified. Other people (904, 905, 906, 907, 908) are already known by the system, which is reading their mood based on the knowledge it draws from their profiles. The system may be able to adapt the space to every person, but when there are several people, it reacts also to the group (916) as a whole and creates a specific atmosphere and configuration for the group. It creates the group configuration because, depending on its programs, on the instructions it received or its own considerations, it has defined a target mood (expected mood) (917) for the group.

The system compares the observed mood (918) of the people to the expected mood (917) and in case of a difference, the system may send a warning or notification (919), in order for an action (920) to be taken. For example, the system understands that it has an objective (948) to search (921) for an idea for a configuration change (928) in order to activate the active devices listed above so that the room meets the quality requirements expected (929). Searching for this idea (921) uses the system's intelligence (922), which may use resources from the internet (923), from databases (924), from Social media (925), or from other sources to come with an idea (927), hopefully a creative and relevant idea.

FIG. J illustrates, according to certain embodiments, the manner in which the system works by using a software and/or hardware system that may include at least a subset of the following:
A common Core and building's model (1004)
Communication interfaces (1030)
Compulsory and optional modules or applications programs (1000), such as Speech recognition (1001), Human behavior (1002), Agriculture (1003), or other modules
Optional bases such as:
   Knowledge bases (1009): knowledge the system has or has been provided with such as knowledge base 1: markets (1010), knowledge base 2: environment (1011), knowledge base 3: models and profits (1012), or any other knowledge base.
   Concept bases (1005) such as Communication concepts (1006), or other concept bases (1007, 1008)
   Instruction bases (1013) such as Owner's strategy (1014), Safety instructions (1015), Selling processes (1016), or other instruction bases.
Information sources (1017) such as
   Sensors (1020)
   User Data (1019)
   Outside sources or external information (1018)
Any number or type of active devices such as (1021, 1022, 1023, 1024, 1025, 1026, 1027, 1028, 1029)

FIG. K illustrates an example of building intelligence process and its learning process, according to certain embodiments.

A building's model (1100) is processed and, using rules, generates (1104) efficiency, space quality, meaning, poetry, etc. as an output (1106), by creating material settings to be implemented, as well as their expected results (1105).

The processing uses knowledge (1101) such as known IB themes, scenes, combinations as well as previous evaluation of results, system's current status, etc.

The processing also uses rules and scores (1107) such as active elements' rules of use, space's qualities operating principles and technical rules, creation rules and use of information.

According to certain embodiments, the work flow is as follows: a set of data and/or intents (1102) is input (1103) in the system. The model is processed (1100) using rules/scores (1107) and knowledge (1101), it generates models and the output (1106) is a set of instructions and expected results (1105) that are put in action and assessed (1108). The result of this action, or the achieved setting, combines with the set of data and intents (1102) as the input (1103) of a new adjustment cycle (feedback loop 1110) through processing the model.

But the model may have a learning capacity (1109). Assessing the results of the previous actions, it may either modify the instructions or modify the model itself.

FIG. L illustrates an example of a simple Level 1 management system, according to certain embodiments. This example is about energy management, but the same kind of interaction process could be applied to many other fields.

FIG. I shows, as an example, a Level 1 autonomous energy management only system (1200), the environment (1201), combined with the hardware and systems (1223) determine an output setting (1202). The output is modified by factors such as efficiency (1203). The resulting output is measured using sensors (1204). The resulting information both becomes an observed production (1205) and an information (1211). The observed production (1205) is compared to the theoretical production (1210) expected by the energy model (1215). If the observed production differs from the expected production as in (1209), the system calculates a possible action (1206) that may achieve the expected result.

At the same time, user's requests (1222) and world news (1221) are combined with sensors result into an information that helps the system calculate its possible actions (1206), to assess the advantages (1207) of this imagined action and calculate the costs and flaws (1208) of this action. The energy model (1215) can help calculate the costs and flaws (1208).

The energy model learns (1212) from the differences (1209) between the theoretical production (1210) and the observed production (1205) and may trigger an alarm if there is a dysfunction (1220).

Once the advantages and costs/flaws of the possible action have been balanced, a proposal (1216) is made and a decision (1217) is made, possibly taking into account a user's indication or input (1219). This decision is sent to the active devices (1214) may be under executive control (1213) and is carried out by the Hardware and the systems (1223).

FIG. M illustrates an example of a Level 2 management system, according to certain embodiments. This example is about energy management, but the same kind of interaction process could be applied to many other fields.

FIG. M shows, as an example, a Level 2 network connection energy management system (1300), the environment (1301), combined with the hardware and systems (1322) determine an output setting (1302). The output is also determined by factors such as efficiency (1303) and connection (1304) to external systems such as energy grid, city infrastructure systems, other building systems, information systems, etc. The resulting output is measured using sensors (1305). The resulting information both becomes an observed production (1306) and an information (1312). The observed production (1306) is compared to the theoretical production (1311) expected by the energy model (1314). If the observed production differs from the expected production as in (1310), the system calculates a possible action (1307) that may achieve the expected result.

At the same time, events (1326), and world news (1324) have been processed by an intelligence (1325) that extracts the relevant information, which, combined with user's requests (1323) and sensors result (1305) become the information (1312) that helps the system calculate its possible actions (1307), to assess the advantages (1308) of this imagined action and the costs and flaws (1309) of this action. The energy model (1314) may be used in the calculation of the costs and flaws (1309). The energy model (1314) can help calculate the costs and flaws (1309).

The energy model (1314) learns (1313) from the differences (1310) between the theoretical production (1311) and the observed production (1306) and may trigger an alarm if there is a dysfunction (1317).

Once the advantages and costs/flaws of the possible action have been balanced, a proposal (1320) is made and a decision (1319) is made, possibly taking into account a user's indication (1318). This decision is sent to the actives devices (1316) may be under executive control (1315) and is carried out by the Hardware and the systems (1322).

FIG. N illustrates an example of Level 3 management system, according to certain embodiments. This example is about energy and spaces management (1400), but the same kind of interaction process could be applied to many other fields.

In this example, two management systems are run in parallel and interact; the energy management system is driven by an energy model (1416) and the space management is driven by a building's model (1431).

In this example, the outside parameters such as Environment, city, society (1401), hardware and systems (1444), User's request (1439), world news (1440), Projects and events going on (1441), groups or actions (1442), people (1443), output and life (1402) have in impact both on the energy management and on the space management. Their influence is corrected by mood (1403), efficiency (1404), connection (1405) to external systems such as energy grid, city infrastructure systems, other building systems, information systems, etc or other factors, before being measured by sensors (1406, 1428) or processed by intelligence (1414, 1438).

The energy process and the space process may be run in parallel.

On the energy side, the output (1402) is measured using sensors (1406). The resulting information both becomes an observed production (1407) and an information (1413) and is also sent to intelligence module (1414). The observed production (1407) is compared to the theoretical production (1412) expected by the energy model (1416). If the observed production differs from the expected production as in (1411), the system calculates a possible action (1408) that may achieve the expected result.

At the same time, Environment, city, society (1401), hardware and systems (1444), User's request (1439), world news (1440), Projects and events going on (1441), groups or actions (1442), people (1443), output and life (1402) have been processed by an intelligence (1414) that extracts the relevant information, which, combined with user's requests (1439) and sensors result (1406) become the information (1413) that helps the system calculate its possible actions (1408), to assess the advantages (1409) of this imagined action and calculate the costs and flaws (1410) of this action. The energy model (1416) can help calculate the costs and flaws (1410).

The energy model (1416) learns (1415) from the differences (1411) between the theoretical production (1412) and the observed production (1407) and may trigger an alarm if there is a dysfunction (1420). The energy model (1416) communicates with the building's model (1431).

Once the advantages and costs/flaws of the possible action have been balanced, a proposal (1419) is made but before a decision (1418) is made, a negotiation (1423) about new scenarios is conducted with the space side, possibly (1422) taking into account a user's indication or input (1421). This decision (1418) is sent to the active energy devices (1417) that may be under executive control (1445) and is carried out by the Hardware and the systems (1444).

On the space side, Environment, city, society (1401), hardware and systems (1444), Projects and events going on (1441), groups or actions (1442), people (1443), output and life (1402) are measured using sensors (1428). The resulting information both becomes an observed production (1427) and an information (1433) and is sent to intelligence (1438). The observed production (1427) is compared to the requested/possible status (1430) expected by the building model (1431). If the observed production differs (1427) from the requested/possible status (1430) as in (1429), the system calculates a possible action (1426) that may achieve the expected result.

At the same time, the output (1402), Environment, city, society (1401), User's request (1439), world news (1440), Projects and events going on (1441), groups or actions (1442), people (1442), output and life (1402) have been processed by an intelligence (1438) that extracts the relevant information, which, combined with user's requests (1439) and sensors result (1428) become the information (1433) that helps the system calculate its possible actions (1426), to assess the advantages (1425) of this imagined action and calculate the costs and flaws (1424) of this action. The building model (1431) can help calculate the costs and flaws (1424).

The building model (1431) learns (1432) from the differences (1429) between the requested/possible status (1430) and the observed production (1427) and may trigger an alarm if there is a dysfunction (1420). The energy model (1416) communicates with the building's model (1431).

Once the advantages and costs/flaws of the possible action have been balanced, a proposal (1437) is made but before a decision (1436) is made, a negotiation (1423) about new scenarios is conducted with the space side, possibly (1422) taking into account a user's indication or input (1421). This decision (1436) is sent to the active building devices (1435) may be under executive control (1434) and is carried out by the Hardware and the systems (1443). Further, there can be cross learning (1446) between energy model (1416) and building model (1431).

FIG. O illustrates an example of a Level 4 management system, according to certain embodiments. This example is about several spaces management (1500) systems, but the same kind of interaction process could be applied to many other fields.

The difference between Level 3 (FIG. N) and Level 4 (FIG. O) is that in Level 4, the system has a common intelligence that manages several systems and manages the conflicts and interactions. This allows then for numerous Levels, or in other words for numerous systems to be managed simultaneously and interacting. To make this clear, FIG. O illustrates, two different space management systems at the same time, possibly each of them acting on the same spaces but with different goals or devices, or acting on different parts of a building, for example.

In this example, two management systems are run in parallel and interact; the space management system 1 is driven by a building's model 1 (1515) and the space management system 2 is driven by the building's model 2 (1533).

In this example, Hardware and the systems (1544) and the outside parameters such as Environment, city, society (1501), User's request (1539), world news (1540), Projects and events going on (1541), groups or actions (1542), people (1543), output and life (1502) have in impact both on the space management 1 and on the space management 2. Their influence is corrected by mood (1503), efficiency (1504), connection (1505) to external systems such as energy grid, city infrastructure systems, other building systems, information systems, etc or other factors, before being measured by sensors (1506, 1530) and processed by the common intelligence (1538).

The Building's model 1 process (1515) and the Building's model 2 process (1533) may be run in parallel.

On the Building's model 1 side, Hardware and the systems (1544) and the outside parameters such as Environment, city, society (1501), Projects and events going on (1541), groups or actions (1542), people (1543), and the output (1502) are measured using sensors (1506). The resulting information both becomes an observed production (1507) and an information (1513) and is also sent back to intelligence module (1538). The observed production (1507) is compared to the requested/possible status (1522) expected by the Building's model 1 (1515). If the observed production (1507) differs from the requested/possible status (1522) as in (1511), the system calculates a possible action (1508) that may achieve the expected result.

At the same time, Environment, city, society (1501), output and life (1502), User's request (1539), world news (1540), Projects and events going on (1541), groups or actions (1542), people (1543), have been processed by a common intelligence (1538) that extracts the relevant information for each management system, which, combined with user's requests (1539) and sensors result (1506) become the information (1513) that helps the system calculate its possible actions (1508), to assess the advantages (1509) of this imagined action and the costs and flaws (1510) of this action. The Building's model 1 (1515) may be used in the calculation of the costs and flaws (1510). The Building's model 1 (1515) can help calculate the costs and flaws (1510).

The Building's model 1 (1515) learns (1514) from the differences (1511) between the requested/possible status (1522) and the observed production (1507) and may trigger an alarm if there is a dysfunction (1518).

The Building's model 1 (1515) communicates with the building's model 2 (1533).

Once the advantages and costs/flaws of the possible action have been balanced, a proposal (1521) is made but before a decision (1520) is made, a negotiation (1523) about new scenarios is conducted with the Building's model 2 (1533) side, possibly taking (1522) into account a user's indication or input (1515). This decision (1520) is sent to the active building's devices (1517) may be under executive control (1516) and is carried out by the Hardware and the systems (1544).

On the Building's model 2 (1533) side, Hardware and the systems (1544) and the outside parameters such as Environment, city, society (1501), Projects and events going on (1541), groups or actions (1542), people (1543), and the output (1502) are measured using sensors (1530). The resulting information both becomes an observed production (1527) and an information (1531) and is also sent back to intelligence module (1538). The observed production (1527) is compared to the requested/possible status (1529) expected by the Building's model 2 (1533). If the observed production (1527) differs from the requested/possible status (1529) as in (1528), the system calculates a possible action (1526) that may achieve the expected result.

At the same time, Environment, city, society (1501), output and life (1502), User's request (1539), world news (1540), Projects and events going on (1541), groups or actions (1542), people (1543), have been processed by a common intelligence (1538) that extracts the relevant information for each management system, which, combined with user's requests (1539) and sensors result (1530) become the information (1531) that helps the system calculate its possible actions (1526), to assess the advantages (1525) of this imagined action and the costs and flaws (1524) of this action. The Building's model 1 (1533) may be used in the calculation of the costs and flaws (1524). The Building's model 1 (1533) can help calculate the costs and flaws (1524).

Some of the sensors may be common to several models run in parallel. In this case, they are managed directly by the intelligence (1538), may be using a Building's Operating System. The resulting information both becomes an observed production (1527) and an information (1531). The observed production (1527) is compared to the requested/possible status (1529) expected by the building model (1533). If the observed production differs (1528) from the requested/possible status (1529) as in (1429), the system calculates a possible action (1526) that may achieve the expected result.

The building model 2 (1533) learns (1532) from the differences (1528) between the requested/possible status (1529) and the observed production (1527) and may trigger an alarm if there is a dysfunction (1518). The building model 1 (1515) communicates with the building's model 2 (1533). It is to be noted that since we have now a common intelligence all or part of the learning may be escalated to the level of the common intelligence, as well as the negotiation process.

Once the advantages and costs/flaws of the possible action have been balanced, a proposal (1537) is made but before a decision (1536) is made, a negotiation (1523) about new scenarios is conducted with the building model 1 side, possibly (1522) taking into account a user's indication or input (1519). This decision (1536) is sent to the active building devices (1535) may be under executive control (1534) and is carried out by the Hardware and the systems (1544). Further, there can be cross learning (1545) between building model 1 (1519) and building model 2 (1533).

FIG. P illustrates an example of communication channels between the system and several categories of players, according to certain embodiments.

The system (1600) deals with several categories of relationships.
There is a system manager, or user (1602), which can give instructions to the system.
There are external contributors (1607) that appear to the system as a mass (1606). They may provide feed back, contributions or actions referred to as information (1603) fed to the system (1600). These external contributors (1607) may receive information from the system, either general or personalized, referred to as General Public Expression (1604).
There are Non managerial users (1608) include inhabitants, employees (1614), etc. such as inhabitants and/or employees (1610, 1611, 1612, 1613). The Non managerial users (1608) have a direct relationship with the system (1600) or for example a building, but they have no managerial power. The system may create for them personal settings (1605) or personal profiles (1609, 1615). They may communicate with the system using specific procedures (1616).
Their personal profile or the information gathered from their observation may be collected in knowledge bases (1601) that provide information to the system (1600).

FIG. Q illustrates the difference between an example of traditional buildings or campus and a building designed as a set of data, according to certain embodiments. When the building is a set of data, it may be described as “building as a software”.

The figure shows two examples:
Before (1704), a building or a campus could be described as a “A stack of masses forming volumes” (1706). FIG. Q shows a group of buildings, or it could be a campus, where the buildings are fixed masses (1705) surrounded by fixed outdoor areas (1709). Such buildings are static and enert.
Now (1703) the group of buildings or the campus (1710) could be described as “a data system” (1700) and a “set of active elements” (1701). FIG. Q illustrates an example of an architecture of a software program, not necessarily the structure of a building although it is possible too. It is designed as a matrix based on a 3 dimensional frame (1707), virtual or real, in which each point of the 3 dimensional space is defined by a set of data (1708). This data may represent, for example, parameters that are applied to active devices. The configuration may be fixed or it may be active or changing over time so the campus may be, totally or partly, redefined in real time by the game of data, may be generated by a software system.
   FIG. R illustrates an example of the ways information may be transmitted to the system's core, according to certain embodiments.
   The common core (1801) processes information (1802). This information comes from various sources:
Users (1817). Users include:
   Collaborative users (1814)
   Employees, inhabitants (1815)
   System manager (1816)
System's data bases (1813)
Data that needs to be processed by intelligence (1803) in order to become usable information (1802)
   Data from sensors (1812)
   Data from outside sources (1811) such as external information (1810)
      News feeds (1809)
      Internet (1808)
      Other (1807)
   This data may comprise:
      Utilitarian information (1806)
      Absolute information (1805)
      Contextual information (1804)

FIG. S illustrates a network of systems, according to certain embodiments.

For the concept of “building as a software”, such software may have an editor/publisher (1900). If the system is, for example, a Building Operating Software, or if it manages many functions or settings of a building or an organization, it is a complex program that may use updates.

In this example, we imagine that these systems are used in buildings (1902), structures, cities or other types of institutions, structures or organization (1901).

These systems may be connected to their environment by local network connections (1903). This environment they are connected to may be the natural environment, the city or community, the people, corporations, various types of organizations (1909), the internet, etc.

The systems or buildings may have direct connection between them ((1908). They may share information or computing for example.

The systems, or buildings, or organizations, may have a connection (1906) with the editor (1900) that, for example, may send updates (1905) to buildings (1902), propose online services or perform tele-maintenance on buildings (1902). In another way, the systems may use a connection (1907) to send feedback (1904), information or knowledge to the editor who may build databases, knowledge bases or improve its product using feedback (1904) for a multitude of different cases of application.

This enables using big data to improve knowledge and methods. It enables the buildings to be upgraded from time to time or in real time through their software system. They may get new functions or use new data bases or new knowledge, or new options, etc.

FIG. S also shows how powerful such a network of buildings is when it comes to collecting information or improving knowledge or sciences. The editor (1900) may wish to collect, process and analyze large amounts of data. It is also possible that the systems or the buildings need more computing power than they have. In this case, since the network exists, they may have exterior systems (centralized or decentralized) perform the calculations for them, or they can work in network and share or put in common their computing power.

FIG. T illustrates a Building Operating System that enables a computer data system to control a building environment or any type of environment, according to certain embodiments.

A central intelligent unit (2000) is in communication via a data spine (2006) with an actuator controller (2004) and to a data analysis unit (2012). The central intelligent unit (2000) is also in communication with any number of modules (2001) and databases (2002). The central intelligent unit (2000) is also in communication with a 3^{rd} party applications interface (2007). The central intelligent unit (2000) is also in communication with a managerial user (2003) (primarily for receiving inputs or giving specific information), and in communication with external systems (2014) via a connection (2011). The central intelligent unit (2000) may also be in communication with a robotic life unit (2021) that manages the robots present in the building's environment and the robotic features coming with the people such as their smartphones, their personal health sensors or many other devices in the future, which can augment reality, monitor life or provide intelligent help at the individual or collective level.

Such an intelligent unit, using powerful science and powerful space actuators (2005), can completely change what a building is. It becomes a live structure that interacts with the world and with people. The intelligent unit not only performs many tasks to facilitate or improve its users' lives, to improve the city or the general productivity the world, but also creates new settings or new ideas and stimulates human creativity by challenges and unexpected interactions or unexpected configurations. The central intelligent unit can also be seen as a new kind of life partner or as a very powerful productivity tool for businesses and more generally for our civilization.

The central intelligent unit (2000) may develop overtime and become more and more capable, especially if its software is upgraded or if components are added or upgraded. The central intelligent unit (2000) makes sense of the context, people and situations. The central intelligent unit (2000) knows its components, especially if many of the components are registered in a database which at the same time provides for maintenance management. The central intelligent unit (2000) has instructions from its manager. The central intelligent unit (2000) has skills for building planning or engineering. The central intelligent unit (2000) has a number of specific programs or rules, and it is able to propose relevant interactions with the environment (for example the weather, or the city's life), the people or the situations by using some or all of its means such as active components, for example to develop or implement relevant space configuration settings. This intelligent unit may be able to learn using information and feedback. The central intelligent unit (2000) may be enriched with additional modules, bases or applications.

The data analysis unit (2012) is in communication with any number and type of sensors (2013) such as the ones illustrated in FIG. F or others. The data analysis unit (2012) is associated with one or more data analysis tools to analyze information. These sensors (2013) are collecting information on potentially everything going on inside and outside the building such as activities (2019), people (2018), events and situations (2017), space configuration (2016), and any other relevant information. The sensors may also verify what the actuators are doing or what their current status is (2020). The data analysis unit is also in communication with the outside world, including to the internet (2015) and to external systems (2014) such as external institutions (for example the energy grid, the city, a transportation system, suppliers, security forces, etc.).

The data analysis unit (2012) processes the data before sending it to the central intelligence unit (2000). The data analysis unit (2012) can also drive the sensors (2013) or external connections in order to obtain a certain type of information as requested by the central intelligent unit (2000).

The actuator controller (2004) may include any number of specific controllers such as movement, orientation, energy or space controllers. The actuator controller (2004) drives and controls the active components or active devices or actuators such as the ones shown in FIG. G or other ones.

As much as possible, the data spine (2006) is used as the main communication channel between the elements of the system, instead of having one channel or one wiring network per function. The data may need to be coded specifically to perform this task efficiently. Strong safety measures will be implemented at every possible level to prevent any error or any unwanted intrusion into the system.

The modules (2001) may be any type of module to be plugged in the system such as professional modules (for example medical, agricultural, health care, retail store, business, offices, security, etc.), skills modules (for example speech recognition, people's behavior analysis, energy management, transportation, mood analysis, etc.) or any type of module the system may need. Some of the modules are optional, which allows the system to be configured for every user. The modules may take advantage of upgrades, manually or automatically if the system is connected to a network, which is not always the case since some organizations may choose the function in a non-connected mode, for example for safety or confidentiality reasons.

The databases (2002) may be any kind of database such as general information, knowledge bases, models bases, etc. New bases can be created or acquired. Bases can function with the system in a closed circuit or can be connected to a network that allows for upgrades or information exchanges.

The editor of the system may provide new information or collect information if the parties agree. This exchange of information may allow for improving the systems.

The 3^{rd} party applications interface (2007) allows the system to work with other applications. There are three main categories of 3^{rd} party applications.
The vital building systems such as fire prevention systems (2008),
The non vital building systems such as elevator management (2009),
3^{rd} party applications (2010)

One of the problems is that 3^{rd} party applications often use proprietary languages and protocols. The 3^{rd} party application interface (2007) makes communications possible and safe.

Vital building systems: such systems (for example Siemens) are responsible for fire safety. Vital building systems work under strict conditions. Vital building systems have a fire department agreement, for example. Vital building systems are regularly inspected. Vital building systems also use special communication protocols, dedicated sensors (for example smoke detectors), dedicated actuators (for example sprinkler systems) and special computing and data networks (for example, fireproof wires).

Vital building systems are expensive but their reach is limited by the fact that the information they process is limited. Vital building systems only know what their sensors tell them. Vital building systems are also limited in their means of action in case of problem (for example, the fire system can do little more than closing fire doors). Vital building systems would be much more efficient if they could use the whole wealth of information that a mutualized sensor system can provide. Vital building systems could be much more efficient in their tasks, for example protecting people, if they could act on more actuators.

Vital building systems have so far remained independent because the buildings were not computerized and because the vital building systems do not want any interference in their tasks. This can be solved by using a data spine (2006), an intelligent unit (2000) and a 3^{rd} party application interface (2007) so that the system understands the priorities (for example fire is probably of high priority against every thing else). The Vital building systems can ensure that the relevant measures are put in action without troubling other fields under proposition by the specific application.

Non vital building systems: the functioning of non vital building systems is often similar to what we find in vital systems. Non vital building systems would also take advantage of more information and more means of actions but as they are not vital, they may have simpler protocols and they may not have the same ranking in priority order.

3^{rd} party applications: Since the building is primarily a computer (many of its physical components such as sensors or actuators are components of a computer system), one can imagine an infinite number of applications or specific programs for such and such task or function. Since the Building Operating System provides a well-known platform (like Windows or Android do for computers or telephones), and that some or all of the sensors and actuators are well-known or work with well known protocols, it is possible for 3^{rd} party developers to develop any number of applications, which after validation by the editor of the Building Operating System or the building's manager, may be implemented in the building and provide specific services. Thus, the building operating system is creating an application market place for buildings and turning a building into a platform for users to personalize.

The robotic life unit (2021) also anticipates two facts: these intelligent buildings may perform many tasks automatically in order to facilitate users' life or to improve productivity. Non-limiting examples include automated factories or automated agricultural facilities. One can also anticipate the massive arrival of robots that will perform many functions. Such robots can be expected to interact with the building, for example, due to the building's bigger computing power or for the building's organizational skills or for its connection skills.

New applications using both the robots and the buildings systems can deliver services, for example, in health care situations where we expect intelligent buildings and robots to perform a large part of the tasks currently performed by human nurses or crews. Thus, the human crews can attend to more important tasks while the services provided to the patients become much better (for example personalized spaces for patients or nursed people, or spaces evolving to facilitate the tasks being performed). The same is true for businesses or for retail stores.

The possible updates of all these systems allow a building to transform over time even without changing its physical components, and even more if some of the components are upgraded.

Since the building becomes a platform for applications to perform services, and since these applications may have a high commercial value, clients may be willing to pay for using such services. This service may be the most important feature of a building due to the services the applications it provide akin to the way the smartphone has become so popular due to the applications available for smartphones. The value of these services may largely exceed the value of the building, for example, the building rent. Therefore, a new business model appears for buildings: the building may become a type of device to be used by a Building Operating System and applications. In such a case, it can be imagined that the building's occupation or usage is billed not according to a number of square meters rented but according to the services one has contracted for. The square meters may come for free (or as a limited cost) in a package dominated by services which may include, for example, energy, security, monitoring (for example in health care agriculture) and professional services. The building is really a “building as a service.” For example, in health care, the facility could be part of a package that primarily comprises care services performed. In the case of agriculture, it could be robotized crop management. In the case of an office, it could be a fraction of the additional productivity, etc, in the same way as a telephonic device may be offered for free if one subscribes to a long term service contract.

FIG. U illustrates an example of a retail store or a supermarket that is an intelligent building. The shelves (2200) can be moved when it is safe. They are rolling on wheels or suspended to a rail (2206). They bear sensors (2205) that can track the people (2201,2202, 2203, 2204, 2206, 2207, 2208, 2210), the carts (2204), the products (2211, 2223) or the environment. The shelves may also bear screens or interactive tablets (2217) to provide information or to allow for information search. This device may also collect information. The cart (2204) may be equipped with sensors (2222) that can track the products, the people and the environment. A crew member (2210) can request settings changes using its own console (2209).

Since people are recognized, they may have known profiles, the system can prepare special settings for them, recommend the preferred products or create the right atmosphere. If the people are not known yet, the system may study their behavior using its sensors, its available information and its analysis ability. When there are several people, the system searches the best compatible solution or goes for a group solution.

The system may also dialog with personal monitoring systems, such as a health monitoring bracelet (2221) and search for the best solution, or even call for help if needed. The system may also allow for direct interaction using personal devices such as a smartphone (2220).

The roof (2224) may take various states such as closed, partially open, completely open, glazed, translucent, shaded, etc. In this example, there is a mobile roof (2213) that is open so it lets the sun light (2212) in, at a time when this light hits directly a focal point of the store. There is one or several artificial lighting systems (2218) that can be used to create various light settings. There may be sound systems (2225) and climate control systems (2226) too.

The walls (2214) may be active. Some of them may be movable, or they can turn into windows (2215) or screens showing pictures (2216).

The floor may be used too, for example with special paths to be taken for expressing something or with active slab (2219) that can be programmed for example to allow people to express something.

FIG. V1-10 show several examples of architectural settings in section view or in plan view.

FIG. V1 is a schematic section that illustrates a classical retail store made of a metal box (2300) with a closed roof (2304), regular shelves (2301) and regular uniform lighting (2302). All the walls (2311) are closed.

FIG. V2 is a schematic section that illustrates an example of an intelligent building in which the active roof (2305) has been set in such a way that it blocks the direct sun rays (2303) but lets in the indirect natural light (2306). All the walls (2311) are closed.

FIG. V3 is a schematic section that illustrates an example of an intelligent building in which the active roof (2305) has been set in such a way that it lets in the direct sun rays (2303). The roof may be closed by windows or open. The interior setting may comprise parasols (2307). All the walls (2311) are closed.

FIG. V4 is a schematic section that illustrates an example of an intelligent building in which the active roof (2305) has been set in such a way that it lets in the direct sun rays (2303) in certain spots while other parts of the roof are closed like for a classical roof (2304). The interior setting may comprise parasols (2307) and active shelves (2313). All the walls (2311) are closed.

FIG. V5 is a schematic section that illustrates an example of an intelligent building in which the roof (2304) is closed. The inside focus, or differentiation between areas, is created using various kinds of artificial lightings (2308, 2309). All the walls (2311) are closed. There may be active shelves (2313).

FIG. V6 is a schematic section that illustrates an example of an intelligent building in which the active roof (2305) is almost completely open. One of the walls (2011) has been removed or open, which provides continuity between the inside and the outside of the building so a Mediterranean style market can express a very natural and traditional way of life. In this example, part of the parking lot (2312) is used as a selling area and some active shelves (2313) are installed outside.

FIG. V7 is a schematic plan that corresponds to section V5 and that illustrates an example of an intelligent building in which the roof (2304) is closed. The inside focus, or differentiation between areas, is created using various kinds of artificial lightings (2308) and the active shelves (2313) orientation. All the walls (2311) are closed. There may be active shelves (2313).

FIG. V8 is a schematic plan that corresponds to section V4 and that illustrates an example of an intelligent building in which the active roof has been set in such a way that it lets in the direct sun rays (2303) in certain spots, while other parts of the roof are closed like for a classical roof, in order to create a differentiation between areas. The interior setting may comprise active shelves (2313). In this case, their position and orientation participates in creating a focus point where the sun rays (2303) hit the store. All the walls (2311) are closed.

FIG. V9 is a schematic plan that corresponds to section V6 and that illustrates an example of an intelligent building in which the active roof is almost completely open. One of the walls (2311) has been removed or open, which provides continuity between the inside and the outside of the building so a Mediterranean style market can express a very natural and traditional way of life. In this example, part of the parking lot (2312) is used as a selling area and some active shelves (2313) are installed outside.

FIG. V10 is a schematic plan that corresponds to the schematic section of FIG. V1. FIG. V10 illustrates an example of a classical retail store made of a metal box with shelf-layout (2313). The walls are mostly closed. There is no or little interaction between the building and the parking lot (2312).

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

We claim:

1. A computer system as a building, the computer system comprising:
a plurality sensors for obtaining information on: characteristics of one or more animate and inanimate occupants of the building, activity in the building and physical and qualitative characteristics of the building;
one or more data analysis tools to analyze the obtained information;
one or more knowledge databases;
one or more models databases;
a plurality of active computerized parametric remote controlled components comprising at least one of the following:
active computerized parametric remotely controlled wall;
active computerized parametric remotely controlled ceiling;
active computerized parametric remotely controlled floor;
active computerized parametric remotely controlled piece of furniture;
active computerized parametric remotely controlled window;
active computerized parametric remotely controlled door;
active computerized parametric remotely controlled sound system;
active computerized parametric remotely controlled lighting system;
active computerized robotic tools;
at least one logical tool to create harmonies between the active components settings;
a data spine for circulating information amongst the plurality of sensors in the building, the plurality of active components in the building, and the data analysis logical tools;
wherein the building interacts and communicates with the one or more animate or inanimate occupants in real-time, and wherein the plurality of active computerized parametric remote controlled components interact with each other in real-time; and
wherein space configuration and space qualities are controlled by settings applied to the plurality of active components.

2. The computer system as a building of claim 1, wherein the building is a programmable entity and wherein the building interacts and communicates in real-time through movement, sound, lighting, visual effects, and environmental effects.

3. The computer system as a building of claim 1, wherein the computer system as a building is upgradable.

4. The computer system as a building of claim 1, further comprising one or more logical geometry controllers for changing in real-time a geometry and a volume of the building by moving one or more active computerized parametric remotely controlled component of the building in response to the mise-en-scene design and the analyzed information.

5. The computer system as a building of claim 1, further comprising one or more logical mise-en-scene analysis tools to create in real time a mise-en-scene design for the building based on the analyzed information.

6. The computer system as a building of claim 1, further comprising tools to allow for communication and coordination of action between the computer system and third party systems of the building.

7. The computer system as a building of claim 1, wherein the computer system learns from experience.

8. The computer system as a building of claim 1, wherein the building interacts with the environment.

9. The computer system as a building of claim 1, wherein the building transforms itself by adjusting its settings to adapt to the user.

10. The computer system as a building of claim 1, wherein the building transforms itself by adjusting its settings to adapt to the circumstances.

11. The computer system as a building of claim 1, wherein the building transforms itself by adjusting its settings to adapt to one or several goals.

12. The computer system as a building of claim 1, wherein the building is connected to other systems and exchanges information.

13. The computer system as a building of claim 1, wherein the computer system is able to create new settings based on the analyzed information, on its programs and on its experience.

14. The computer system as a building of claim 1, wherein the computer system is used for at least one of the following: healthcare facility, residential building, office facility, agricultural facility, industrial facility, store, sport facility, sport facility, commercial facility, public facility, infrastructure facility.

15. The computer system as a building of claim 1, wherein the computer system is used as a productivity tool.
